(19) United States
(12) Patent Application Publication
(10) Pub. No.: US 2026/0055738 A1
(43) Pub. Date: Feb. 26, 2026

(54) ADAPTIVE ARTIFICIAL INTELLIGENCE LED CALIBRATION STRATEGY FOR INTERNAL COMBUSTION ENGINE AND EXHAUST AFTERTREATMENT SYSTEM OPTIMIZATION

(71) Applicant: SAUDI ARABIAN OIL COMPANY, Dhahran (SA)

(72) Inventors: Fethi Khaled, Al-Khobar (SA); Fakhar Mehmood, Dhahran (SA); Balaji Mohan, Dhahran (SA)

(73) Assignee: SAUDI ARABIAN OIL COMPANY, Dhahran (SA)

(21) Appl. No.: 18/809,827

(22) Filed: Aug. 20, 2024

(51) Int. Cl. F02D 41/24; F01N 9/00; F02D 41/14

(52) U.S. Cl. CPC F02D 41/2429; F01N 9/005; F01N 2900/0402; F02D 2041/1433

(57) ABSTRACT

A method for optimizing a motor assembly that includes an engine and an after-treatment system (ATS). The method includes obtaining an artificial intelligence (AI) model configured to receive an operating point for the motor assembly, engine control parameters controlling the engine and independent ATS control parameters controlling the ATS. The method further includes obtaining a performance model configured to return a predicted performance score for the motor assembly based on the AI model. The method further includes obtaining a first operating point, configuring the performance model to return a first predicted performance score based on the AI model receiving the first operating point, and determining optimum engine control parameters and optimum ATS control parameters that optimize the first predicted performance score. The method further includes adjusting the engine control parameters and ATS control parameters based on the optimum engine control parameters and optimum ATS control parameters.

### BACKGROUND

In modern motor vehicles, hazardous tailpipe emissions are reduced by an after-treatment system (ATS) that processes the exhaust from an internal combustion engine (ICE). The effectiveness of after treatment systems depends on various factors, such as engine-out gas composition and temperature, gas flow rate, aging of the vehicle's components and accuracy of sensors over the lifetime of the vehicle.

The performance of a vehicle is generally evaluated as a balance between several factors, such as fuel efficiency and tail pipe emissions. Optimizing the performance requires careful calibration and regular monitoring of the ICE and ATS. Conventionally, engine calibration is performed under ideal conditions on a chassis dynamometer with the intent of maximizing the engine efficiency while minimizing the engine emissions. Then, the ATS is calibrated to minimize hazardous tailpipe emissions by processing the emissions from the optimized engine.

Conventional calibration methods are resources intensive. A large number of experiments, measurements and analysis are required from an expert team using expensive instruments. Ultimately, the ICE and ATS are only optimized in the context of ideal conditions and remains constant throughout the life of the vehicle. Conventional calibration methods do not account for real driving conditions and the evolution of the vehicle during its lifetime.

Accordingly, there exists a need for automated, periodic calibration of ICE and ATS under real driving conditions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for optimizing parameters of a motor assembly. The motor assembly includes an engine, controlled by one or more engine control parameters in response to an operating point, and an after-treatment system (ATS), controlled by one or more ATS control parameters in response to an exhaust from the engine. The one or more ATS control parameters include one or more independent ATS control parameters. The method includes obtaining a first operating point for the motor assembly and an artificial intelligence (AI) model. The AI model is configured to receive, as inputs, an operating point and a set of control parameters that include a set of one or more engine control parameters and a set of one or more independent ATS control parameters. The AI model is configured to return, as output, a predicted performance for the motor assembly. The method further includes obtaining a performance model configured to return a predicted performance score for the motor assembly based on the AI model. The method further includes configuring the performance model to return a first predicted performance score based on the AI model receiving the first operating point. The method further includes determining a first optimum set of one or more engine control parameters and a first optimum set of one or more ATS control parameters that optimize the first predicted performance score over the set of control parameters. The method further includes adjusting the one or more engine control parameters based on the first optimum set of one or more engine control parameters and adjusting the one or more ATS control parameters based on the first optimum set of one or more ATS control parameters.

In one aspect, embodiments disclosed herein relate to a method for detecting and mitigating a fault for a motor vehicle that includes a motor assembly. The motor assembly includes an engine, controlled by one or more engine control parameters in response to an operating point, and an after-treatment system (ATS), controlled by one or more ATS control parameters in response to an exhaust from the engine. The one or more ATS control parameters include one or more independent ATS control parameters. The method includes operating the motor vehicle and obtaining, at an instant while operating the motor vehicle, using one or more sensors disposed on the motor vehicle, an onboard data sample that includes an onboard operating point for the motor assembly, an onboard set of one or more engine control parameters for the engine, an onboard set of one or more independent ATS control parameters for the ATS and an onboard performance for the motor assembly. The method further includes determining, using an artificial intelligence (AI) model, a predicted onboard performance for the motor assembly based on the onboard operating point, the onboard set of one or more engine control parameters and the onboard set of one or more independent ATS control parameters. The method further includes computing a performance mismatch between the onboard performance and the predicted onboard performance, obtaining a fault detection threshold, and making a determination whether the performance mismatch is greater than the fault detection threshold. The method further includes conducting a fault mitigation in response to the determination that the performance mismatch is greater than the fault detection threshold. The fault mitigation includes sending an alert that a fault has been detected.

In one aspect, embodiments disclosed herein relate to a system for optimizing parameters of a motor assembly. The motor assembly includes an engine, controlled by one or more engine control parameters in response to an operating point, and an after-treatment system (ATS), controlled by one or more ATS control parameters in response to an exhaust from the engine. The one or more ATS control parameters include one or more independent ATS control parameters. The system includes the motor assembly and a computer system including one or more computer processors. The computer system is configured to receive an artificial intelligence (AI) model. The AI model is configured to receive, as inputs, an operating point and a set of control parameters that include a set of one or more engine control parameters and a set of one or more independent ATS control parameters. The AI model is configured to return, as output, a predicted performance for the motor assembly. The computer system is further configured to receive a performance model configured to return a predicted performance score for the motor assembly based on the AI model. The computer system is further configured to receive a first operating point for the motor assembly and configure the performance model to return a first predicted performance score based on the AI model receiving the first operating point. The computer system is further configured to determine a first optimum set of one or more engine control parameters and a first optimum set of one or more ATS control parameters that optimize the first predicted performance score over the set of control parameters. The system further includes an electronic control unit configured to adjust the one or more engine control parameters based on the first optimum set of one or more engine control parameters and adjust the one or more ATS control parameters based on the first optimum set of one or more ATS control parameters.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an engine-after-treatment system assembly in accordance with one or more embodiments disclosed herein.

FIG. 2 depicts a configuration of an artificial intelligence model in accordance with one or more embodiments disclosed herein.

FIG. 3 depicts a configuration of an artificial intelligence model in accordance with one or more embodiments disclosed herein.

FIG. 4 depicts a configuration of an artificial intelligence model in accordance with one or more embodiments disclosed herein.

FIG. 5 depicts a fault detection system in accordance with one or more embodiments disclosed herein.

FIG. 6A depicts a performance model in accordance with one or more embodiments disclosed herein.

FIG. 6B depicts a configuration of a performance model in accordance with one or more embodiments disclosed herein.

FIG. 6C depicts a configuration of a performance model in accordance with one or more embodiments disclosed herein.

FIG. 6D depicts a configuration of a performance model in accordance with one or more embodiments disclosed herein.

FIG. 7 depicts a calibration system in accordance with one or more embodiments disclosed herein.

FIG. 8 depicts an optimization system in accordance with one or more embodiments disclosed herein.

FIG. 9 depicts an optimization system in accordance with one or more embodiments disclosed herein.

FIG. 10 depicts a calibration method in accordance with one or more embodiments disclosed herein.

FIG. 11 depicts a fault detection method in accordance with one or more embodiments disclosed herein.

FIG. 12 depicts an example diagram of a gradient boosted tree algorithm in accordance with one or more embodiments disclosed herein.

FIG. 13 depicts an overview of training an artificial intelligence model in accordance with one or more embodiments disclosed herein.

FIG. 14 depicts an example diagram of a neural network in accordance with one or more embodiments disclosed herein.

FIG. 15 depicts an example diagram of a computer in accordance with one or more embodiments disclosed herein.

FIG. 16A depicts a results of assessment metrics for an AI model in accordance with one or more embodiments disclosed herein.

FIG. 16B depicts a results of assessment metrics for an AI model in accordance with one or more embodiments disclosed herein.

FIG. 16C depicts a results of assessment metrics for an AI model in accordance with one or more embodiments disclosed herein.

FIG. 17 depicts a comparison graph in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

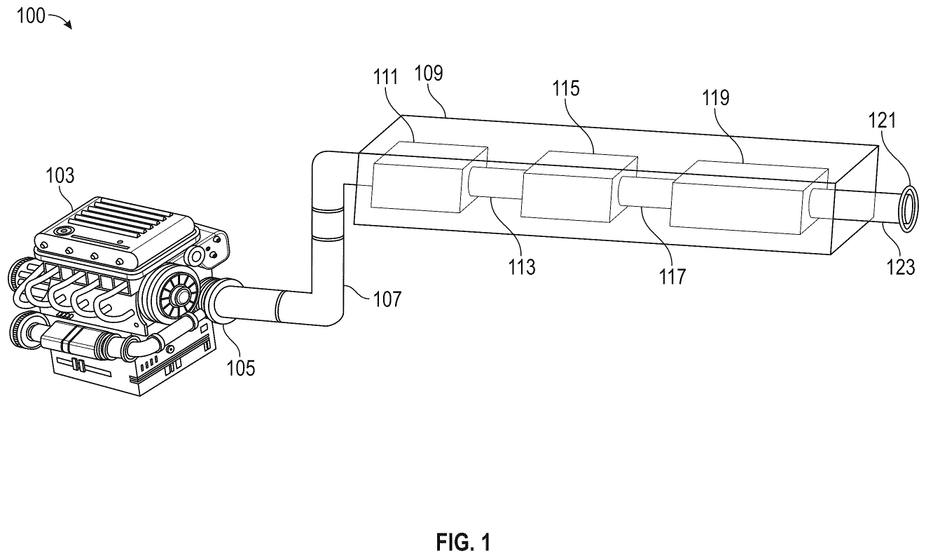

In the following description of FIGS. 1-17, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to automated methods and systems using artificial intelligence (AI) for calibrating engine and after-treatment systems of a motor vehicle. Embodiments disclosed herein relate to a fault detection system using AI for a motor vehicle.

Embodiments of the present disclosure may provide at least one of the following advantages. The calibration systems and methods presented in this disclosure are automated using artificial intelligence (AI), which reduces the need for human and material resources. Advantageously, the calibration is performed periodically to account for real driving conditions and the evolution of the motor vehicle, which limits the degradation of the vehicle's performance during its lifetime. Advantageously, the AI framework is further used as a fault detection system for motor vehicles. Advantageously, the calibration framework may be hosted, run and fine-tuned onboard the vehicle. Advantageously, the calibration framework may be installed on new motor vehicles or retrofitted on existing motor vehicles.

FIG. 1 depicts an example motor assembly (100). The motor assembly includes an engine (103) and an after-treatment system (ATS) (109). The engine (103) consumes fuel to produce mechanical energy. In one or more embodiments, the engine (103) is a diesel engine. The engine (103) releases engine exhaust materials through an engine exhaust (105). Generally, engine exhaust materials include engine exhaust gases, such as nitrogen oxides (NOₓ), carbon monoxide (CO), carbon dioxide (CO₂) and hydrocarbons (HC). In some embodiments, the engine exhaust materials further include particulates, such as soot, transported by the engine exhaust gases upon exiting the engine (103). Some of the engine exhaust gases and particulates, referred to as hazardous exhaust engine materials, present chemical hazards to the environment and populations living therein. Gaseous components of the hazardous exhaust engine materials are called hazardous exhaust engine gases and include engine exhaust NOₓ and engine exhaust HC. To reduce the amount of hazardous exhaust engine materials released into the atmosphere, engine exhaust gases and particulates are transported to the ATS (109) through a first line (107). Inside the ATS (109), some of the hazardous engine exhaust gases are transformed into harmless gases through various chemical reactions. Examples of transformations performed by the ATS (109) include an oxidation of the engine exhaust CO to CO₂. Examples of transformations performed by the ATS (109) further include an oxidation of the engine exhaust HC to water (H₂O) and CO₂. Examples of transformations performed by the ATS (109) further include a reduction of NOₓ to dinitrogen (N₂) and dioxygen (O₂).

Tailpipe gases are released from the ATS (109) into the atmosphere as tailpipe emissions through a tailpipe (121). Tailpipe emissions include various components, including the products of the chemical reactions performed by the ATS (109), such as CO₂, H₂O, O₂ and N₂. The ATS (109) is not always capable of transforming the totality of hazardous exhaust engine gases. Thus, some of the hazardous exhaust engine gases are released into the atmosphere as part of the tailpipe emissions. In that regard, tailpipe emissions include CO₂, NOₓ and HC, called tailpipe exhaust CO₂, tailpipe exhaust NOₓ and tailpipe exhaust HC respectively. In some jurisdictions tailpipe emissions are regulated, for example, by a regulation or law enforced by an agency. Relevant regulations often impose maximum allowed amounts for hazardous components of the tailpipe emissions. For example, at the time of writing this disclosure, the Environmental Protection Agency enforces these regulations in the United States. As such, motor assembly specifications indicate that the amounts of hazardous components of the tailpipe emissions must not exceed the maximum allowed amounts.

In the example in FIG. 1, the motor assembly (100) includes three major components: a diesel oxidation catalyst (DOC) (111), a diesel particulate filter (DPF) (115) and a selective catalytic reduction (SCR) system (119). The DOC (111) oxidizes CO and HC into CO₂ and H₂O. The DPF (115) receives an output from the DOC (111) from a second line (113), captures, and stores the particulates from the engine exhaust gases. The SCR system (119) receives an output from the DPF (115) through a third line (117) and reduces NOₓ into N₂ and H₂O using a reductant and a catalyst. Examples of reductants include a urea solution, anhydrous ammonia and aqueous ammonia. An output from the SCR system (119) is transmitted to a fourth line (123) and exits the motor assembly (100) as a tailpipe emission through the tailpipe (121). It is emphasized that the example reactions, engine exhaust materials, reductants, tailpipe emissions and components of the ATS (109) depicted in FIG. 1 are given only as an example and should be considered non-limiting. One with ordinary skill in the art will recognize that the reactions, engine exhaust materials, reductants, tailpipe emissions and components of the ATS (109) may omit or contain additional components not shown without departing from the scope of this disclosure.

The engine (103) operates by producing mechanical energy in response to an operating point. An operating point includes one or more operating parameters arising from a demand that a user inputs to the engine (103). Examples of operating parameters arising from the demand from the user include at most two of a throttle opening, an engine speed and an engine load. As a first specific example, a user may impose the throttle opening using an accelerator and an engine load using a gear. As a response from the throttle opening, imposed by the user, fuel is injected into the engine (103) at a certain flux in accordance with the throttle opening. The engine (103) combusts the fuel, which creates mechanical energy against the engine load imposed by the user, resulting in an engine speed that is not controlled by the user. As a second specific example, a user may impose the engine load and the engine speed to the engine (103), without imposing the throttle opening. In response, the throttle opening must be adjusted to allow fuel to flow into the engine (103) at an adequate flux to produce the imposed engine speed against the imposed engine load. In one or more embodiments, the operating point further includes an environmental context. The environmental context is imposed on the engine, but not by the user. Examples of components of the environmental context that may be included in the operating point include an outside air temperature, an outside air pressure and an oxygen proportion within the outside air.

The engine (103) is parametrized by one or more engine control parameters. The engine control parameters may be adjusted in response to the operating point received by the engine. The engine control parameters may be adjusted in order for the engine (103) to operate in accordance with the operating point. Examples of engine control parameters include, but are not limited to, an indicated mean effective pressure, an exhaust gas recirculation rate, an average intake air temperature, a fuel rail pressure, a start of first fuel injection, a start of second fuel injection, an average intake manifold pressure, a total mass of fuel injection and a percentage of mass injected in first injection. The indicative mean effective pressure measures the pressure in the combustion chamber without accounting for frictional losses. The exhaust gas recirculation rate is a proportion of engine exhaust gases that are reintroduced into the engine's (103) intake air. The average intake air temperature is an average temperature of an air entering the engine's intake manifold. The fuel rail pressure is the pressure at which fuel is delivered to fuel injectors. The start of the first fuel injection is the timing of the initial injection of fuel into the combustion chamber during the engine's (103) combustion cycle. In some embodiments, the engine (103) operates with a multiple injection strategy and the start of second fuel injection is the timing of a second fuel injection occurring after the first fuel injection. The average intake manifold pressure is an instantaneous mean pressure within the intake manifold. The total mass of fuel injection is the total amount of fuel mass injected into the engine's (103) combustion chambers during one combustion cycle. The percentage of mass injected in the first injection is the mass of fuel injected during the first fuel injection divided by the total mass of fuel injection. It is noted that multiple combinations of the engine control parameters may lead the engine to work at the same operating point. Generally, infinitely many combinations of the engine control parameters may lead the engine to work at the same operating point.

In some embodiments, the engine control parameters are selected using an engine map. An engine map is a multi-dimensional table that associates to each operating point within a set of operating points a unique value for each engine control parameters within the one or more engine control parameters. In other words, even if multiple combinations of the engine control parameters may lead the engine to operate at a given operating point, the engine map returns a single one of these multiple combinations. In some embodiments, each operating point includes two components, and the engine map includes one or more two-dimensional engine maps. In such embodiments, each two-dimensional engine map among the one or more two-dimensional engine maps is associated with one engine control parameter among the one or more engine control parameters. The two-dimensional engine map associated with a given engine control parameter may be stored as a table whose entries have two coordinates. Each coordinate is a distinct component of the operating point within a pre-defined range. Thus, each entry defines an operating point. The value of the two-dimensional table at each entry is the value of the given engine control parameter that should be selected in response to the operating point defined by that entry.

An example of a two-dimensional engine map is given in Table I. In Table I, an operating point is composed of two components: an engine speed ranging from 1000 revolutions per minute (RPM) to 6000 RPM and a percentage of throttle opening ranging from 10% to 100%. Each entry in Table I corresponds to a specific operating point on a discreet grid that partitions the ranges of the components of the operating point. Table I associates, to each operating point, a total mass of fuel injection (mg/cycle). If the operating point matches a specific entry of Table I, the total mass of fuel injection is selected as the value of Table I at that specific entry. For instance, if the operating point is the pair (2000 RPM, 30%), the total mass of fuel injection is selected as 25 mg per cycle according to Table I. In some implementations, if the operating point does not match a specific entry of Table I, the values from neighboring entries are interpolated to determine the total mass of fuel injection to be selected. For instance, if the operating point is (3200 RPM, 53%), four values can be interpolated for the four entries that encompass (3200 RPM, 53%) in in Table I, namely, (3000 RPM, 50%), (4000 RPM, 50%), (3000 RPM, 60%), and (4000 RPM, 40%). Then, the total mass of fuel injection is selected as an interpolation of the four values corresponding to these four entries, namely: 40 mg, 45 mg, 45 mg and 50 mg. Examples of interpolation techniques that may be used to interpolate four values include, but are not limited to, bilinear interpolation.

TABLE I
Example two-dimensional engine map; the entries are
pairs composed of the engine speed (RPM) and the percentage
of throttle opening (%). The values are the total
mass of fuel injection (mg) for each entry.

| Total mass of | | | | | | | |
|---|---|---|---|---|---|---|---|
| fuel injection | | Engine speed (RPM) | | | | | |
| table (mg/cycle) | | 1000 | 2000 | 3000 | 4000 | 5000 | 6000 |
| Pe [symbol] | 10 | 10 | 15 | 20 | 25 | 30 | 35 |
| | 20 | 15 | 20 | 25 | 30 | 35 | 40 |
| | 30 | 20 | 25 | 30 | 35 | 40 | 45 |
| | 40 | 25 | 30 | 35 | 40 | 45 | 50 |
| | 50 | 30 | 35 | 40 | 45 | 50 | 55 |
| | 60 | 35 | 40 | 45 | 50 | 55 | 60 |
| | 70 | 40 | 45 | 50 | 55 | 60 | 65 |
| | 80 | 45 | 50 | 55 | 60 | 65 | 70 |
| | 90 | 50 | 55 | 60 | 65 | 70 | 75 |
| | 100 | 55 | 60 | 65 | 70 | 75 | 80 |

[symbol]

indicates data missing or illegible when filed

In some embodiments, the engine control parameters are selected by an engine control unit (ECU). The ECU is an electronic device that receives an operating point and selects one combination of the one or more engine control parameters so that the engine operates at the operating point. Modern motor vehicles may include multiple ECUs. In this disclosure, multiple ECUs installed in a same motor vehicle are jointly called “the ECU” in the singular form. In some embodiments, the ECU operates using the engine map. Upon receiving an operating point from a user, the ECU looks up the engine map and selects the engine control parameters associated with the operating point by the engine map. If the operating point matches a specific entry of Table I, the ECU commands the engine (103) to inject fuel according to the value of the engine map at that specific entry. In some implementations, if the operating point does not match a specific entry of the engine map, the ECU interpolates the values from neighboring entries.

The engine exhaust materials are processed by the ATS (109). The ATS (109) is controlled by one or more ATS control parameters. The one or more ATS control parameters may be tuned independently from the engine control parameters. Examples of ATS control parameters include, but are not limited to, a reductant injection rate and an intake temperature for each component of the ATS (109) (e.g., the components DOC (111), DPF (115) and SCR system (119)). In some implementations, the temperature of the DOC (111) may be adjusted by a temperature control mechanism in order to optimize the oxidation reactions in the DOC (111). The temperature control mechanism is configured to heat or cool the DOC (111) according to a DOC temperature adjustment rate. In some embodiments, the ATS control parameters include the DOC temperature adjustment rate. As stated, the ATS (109) is not always capable of processing the totality of the hazardous engine exhaust materials. The amount of engine exhaust materials processed by the ATS (109) depends on the ATS control parameters. The ATS control parameters define how much of the engine exhaust materials will be transformed by the ATS (109). The hazardous engine exhaust materials that are not processed by the ATS (109) are released in the tailpipe emissions. As previously mentioned, in some cases, tailpipe emissions are regulated by a regulation, such as a law. As such, the ATS control parameters must be selected such that the amounts of hazardous gases within the tailpipe emission satisfy the regulation. The choice of the ATS control parameters depends on the amounts of hazardous engine exhaust gases. The amounts of engine exhaust gases depend on the engine control parameters. Thus, the choice of the ATS control parameters depends on the operating point. In some embodiments, the ATS control parameters are selected by the ECU in response to the operating point.

In some embodiments, the ATS control parameters are selected using an ATS map. An ATS map is a multi-dimensional table that associates to each operating point within a set of operating points a unique value for each ATS control parameter within the one or more ATS control parameters. In other words, even if multiple combinations of the ATS control parameters may lead the ATS to operate at a given operating point, the ATS map returns a single one of these multiple combinations. In some embodiments, each operating point includes two components and the ATS map includes one or more two-dimensional ATS maps. In such embodiments, each two-dimensional ATS map among the one or more two-dimensional ATS maps is associated with one ATS control parameter among the one or more ATS control parameters. The two-dimensional ATS map associated with a given ATS control parameter is a table whose entries have two coordinates. Each coordinate is a distinct component of the operating point within a pre-defined range. Thus, each entry defines an operating point. The value of the two-dimensional table at each entry is the value of the given ATS control parameter that should be selected in response to the operating point defined by that entry. As a specific example, an operating point may be defined as a pair of two components, namely, a speed ranging from 1000 RPM to 6000 RPM and a percentage of throttle opening ranging from 10% to 100%. A two-dimensional ATS map may be defined as a table, each entry of which corresponds to a specific operating point on a discreet grid that partitions the ranges of the components of the operating point. The two-dimensional ATS map associates, to each operating point, a reductant injection rate (mg/cycle) required to process the engine exhaust gases by the engine (103) operating at the input operation point. In some embodiments, the ATS control parameters are selected by the ECU. Upon receiving an operating point from a user, the ECU looks up the ATS map and selects the ATS control parameters based on the operating point.

In this disclosure, the set composed of the engine map and the ATS map is referred to as an engine-ATS map. A specific example is described herein. An operating point is given by a pair of two components, namely, an engine speed ranging from 1000 RPM to 6000 RPM and a percentage of throttle opening ranging from 10% to 100%. The engine (103) is controlled by three engine control parameters, namely, the exhaust gas recirculation rate, the average intake manifold pressure and the total mass of fuel injection. The ATS is controlled by two ATS control parameters, namely, the reductant injection rate and the SCR system intake air temperature. In such embodiments, the engine-ATS map has two-dimensional entries. Each entry is composed of components of an operating point within a discreet set of operating points. The engine-ATS maps associates each entry with five values: a value of the exhaust gas recirculation rate, a value of the average intake manifold pressure, a value of the total mass of fuel injection, a value of the reductant injection rate and a value of the SCR system intake air temperature. Therefore, in this specific example, the engine-ATS map is a three-dimensional table. A first dimension is a value of the engine speed; a second dimension is a value of the throttle opening and a third dimension is an identification of one of the exhaust gas recirculation rate, the average intake manifold pressure, the total mass of fuel injection, the reductant injection rate and the SCR system intake air temperature. The engine-ATS map includes five two-dimensional engine-ATS maps, each two-dimensional engine-ATS map receiving an operating point as entry. A first two-dimensional engine-ATS map returns a value of the exhaust gas recirculation rate; a second two-dimensional engine-ATS map returns a value of the average intake manifold pressure; a third two-dimensional engine-ATS map returns a value of the total mass of fuel injection; a fourth two-dimensional engine-ATS map returns a value of the reductant injection rate; a fifth two-dimensional engine-ATS map returns a value of the SCR system intake air temperature.

As stated, an operating point may be satisfied by multiple combinations of engine control parameters and ATS control parameters. Yet, a unique combination of the engine control parameters and ATS control parameters is needed to operate the motor assembly. Therefore, the engine control parameters and ATS control parameters must be selected according to a rule that, given an operating point, a unique combination of the engine control parameters and ATS control parameters is selected among the multiple possible combinations. In this disclosure, the engine control parameters and ATS control parameters are selected as optimizing a predicted performance score for the motor assembly. For any operating point, engine control parameters and ATS control parameters, a performance may be evaluated for the motor assembly. In some embodiments, the performance includes one or more components in the set composed of: a brake specific fuel consumption, an engine exhaust NOₓ rate, an engine exhaust HC rate, a volume of engine smoke, an engine noise level, an engine exhaust gas temperature, an engine exhaust flow rate, an engine efficiency, a reductant injection rate, a tailpipe exhaust NOₓ rate and a tailpipe exhaust HC rate.

It is noted that in some embodiments, some components of the performance, such as the reductant injection rate, are both an ATS control parameter and a component of the performance. The ATS control parameters that are also components of the performance depend on other engine or ATS control parameters. The ATS control parameters that are also components of the performance are called dependent ATS control parameters. By contrast, the ATS control parameters that are not components of the performance are called independent ATS control parameters. The dependent ATS control parameters and independent ATS control parameters form the ATS control parameters. Yet, some embodiments do not include any dependent ATS control parameters. In such embodiments, the ATS control parameters are composed of the independent ATS control parameters alone.

In one or more embodiments, the performance includes an engine performance and an ATS performance. For instance, in some embodiments, the engine performance includes one or more components from the set composed of: a brake specific fuel consumption, an engine exhaust NOₓ rate, an engine exhaust HC rate, a volume of engine smoke, an engine noise level, an engine exhaust gas temperature, an engine exhaust flow rate, an engine efficiency and a reductant injection rate. Furthermore, in some embodiments, the ATS performance includes one or more components from the set composed of: a tailpipe exhaust NOₓ rate, a tailpipe exhaust HC rate and a tailpipe exhaust CO₂ rate.

It is noted that different components of the performance may work concurrently. For instance, a first motor assembly with a first efficiency and a first tailpipe NOₓ emission may be considered more performant than a second motor assembly with a second efficiency and a second NOₓ emission if the first efficiency is greater than the second efficiency. Conversely, the first motor assembly may be considered less performant than a second motor assembly if the first tailpipe NOₓ emission is greater than the second tailpipe NOₓ emission. In other words, to optimize a motor assembly, it may be preferable to increase some components of the performance and reduce other components of the performance. Thus, there is a need for a performance metric for comparing two performances and determine whether a first motor assembly is more performant or less performant than a second motor assembly. The performance metric may depend on a specific purpose for which the motor assembly is designed. For instance, if fuel economy is a concern, it may be advantageous to have the engine to deliver with high efficiency, even at the price of an increased tailpipe NOₓ emission. On the other hand, if the motor assembly is installed on a motor vehicle operated in high traffic conditions, it may be advantageous to have the motor assembly deliver a low tailpipe NOₓ emission at the price of a reduced engine efficiency. The performance metric may be defined in many ways. In some embodiments, the performance metric is defined using a merit function, described later in this disclosure.

Generally, components of the performance that are preferable to be increased are called maximizing components of the performance. Components of the performance that are preferable to be reduced are called minimizing components of the performance. Examples of maximizing components of the performance include the engine efficiency. Examples of minimizing components of the performance include the brake specific fuel consumption, engine exhaust NOₓ rate, engine exhaust HC rate, volume of engine smoke, engine noise level, engine exhaust gas temperature, engine exhaust flow rate, reductant injection rate, tailpipe exhaust NOₓ rate and tailpipe exhaust HC rate.

Table II summarizes a first example engine-ATS framework. In Table II, the engine control parameters are the indicated mean effective pressure, exhaust gas recirculation rate, average intake air temperature, fuel rail pressure, start of first fuel injection, start of second fuel injection, average intake manifold pressure, total mass of fuel injection and percentage of mass injected in first injection. The ATS control parameters are the reductant injection rate, the DOC intake temperature and the SCR intake temperature. There are no dependent ATS control parameters. The performance has a unique component: the tailpipe exhaust NOₓ rate.

TABLE II
First example engine-ATS framework.

| | |
|---|---|
| Engine control parameters | indicated mean effective pressure, |
| | exhaust gas recirculation rate, |
| | average intake air temperature, |
| | fuel rail pressure, |
| | start of first fuel injection, |
| | start of second fuel injection, |
| | average intake manifold pressure, |
| | total mass of fuel injection, |
| | percentage of mass injected in first injection |
| ATS control parameters | reductant injection rate, |
| | DOC intake temperature, |
| | SCR intake temperature |
| Performance | tailpipe exhaust NOₓ rate |

Table III summarizes a second example engine-ATS framework. In Table III, the engine control parameters and ATS control parameters are the same as in Table II. However, the performance has five components: volume of smoke, engine efficiency, engine noise, tailpipe exhaust NOₓ rate and a tailpipe exhaust HC rate.

TABLE III
Second example engine-ATS framework.

| | |
|---|---|
| Engine control parameters | indicated mean effective pressure, |
| | exhaust gas recirculation rate, |
| | average intake air temperature, |
| | fuel rail pressure, |
| | start of first fuel injection, |
| | start of second fuel injection, |
| | average intake manifold pressure, |
| | total mass of fuel injection, |
| | percentage of mass injected in first injection |
| ATS control parameters | reductant injection rate, |
| | DOC intake temperature, |
| | SCR intake temperature, |
| Performance | volume of engine smoke, |
| | engine efficiency, |
| | engine noise level, |
| | tailpipe exhaust HC rate, |
| | tailpipe exhaust NOₓ rate |

Table IV summarizes a third example engine-ATS framework. In Table IV, the engine control parameters and ATS control parameters are the same as in Table II and III. The performance has ten components: brake specific fuel consumption, engine exhaust NOₓ rate, engine exhaust HC rate, volume of engine smoke, engine noise level, engine exhaust gas temperature, engine exhaust flow rate, engine efficiency, engine power, tailpipe exhaust NOₓ rate and tailpipe exhaust HC rate.

TABLE IV
Third example engine-ATS framework.

| | |
|---|---|
| Engine control parameters | indicated mean effective pressure, |
| | exhaust gas recirculation rate, |
| | average intake air temperature, |
| | fuel rail pressure, |
| | start of first fuel injection, |
| | start of second fuel injection, |
| | average intake manifold pressure, |
| | total mass of fuel injection, |
| | percentage of mass injected in first injection |
| ATS control parameters | reductant injection rate, |
| | DOC intake temperature, |
| | SCR intake temperature, |
| Performance | engine efficiency, |
| | brake specific fuel consumption, |
| | engine exhaust NOₓ rate, |
| | engine exhaust HC rate, |
| | volume of engine smoke, |
| | engine noise level, |
| | engine exhaust gas temperature, |
| | engine exhaust flow rate, |
| | tailpipe exhaust NOₓ rate, |
| | tailpipe exhaust HC rate |

Table V summarizes a fourth example of an engine-ATS framework. In Table V, the engine control parameters and ATS control parameters are the same as in Table IV. The performance includes all the components seen in Table V. However, in Table V, the performance further includes the reductant injection rate. Thus, in this fourth example engine-ATS framework, the reductant injection rate is highlighted as a dependent ATS control parameter.

TABLE V
Fourth example engine-ATS framework.

| | |
|---|---|
| Engine control parameters | indicated mean effective pressure, |
| | exhaust gas recirculation rate, |
| | average intake air temperature, |
| | fuel rail pressure, |
| | start of first fuel injection, |
| | start of second fuel injection, |
| | average intake manifold pressure, |
| | total mass of fuel injection, |
| | percentage of mass injected in first injection |
| ATS control parameters | reductant injection rate, |
| | DOC intake temperature, |
| | SCR intake temperature, |
| Performance | engine efficiency, |
| | brake specific fuel consumption, |
| | engine exhaust NOₓ rate, |
| | engine exhaust HC rate, |
| | volume of engine smoke, |
| | engine noise level, |
| | engine exhaust gas temperature, |
| | engine exhaust flow rate, |
| | tailpipe exhaust NOₓ rate, |
| | tailpipe exhaust HC rate, |
| | reductant injection rate |

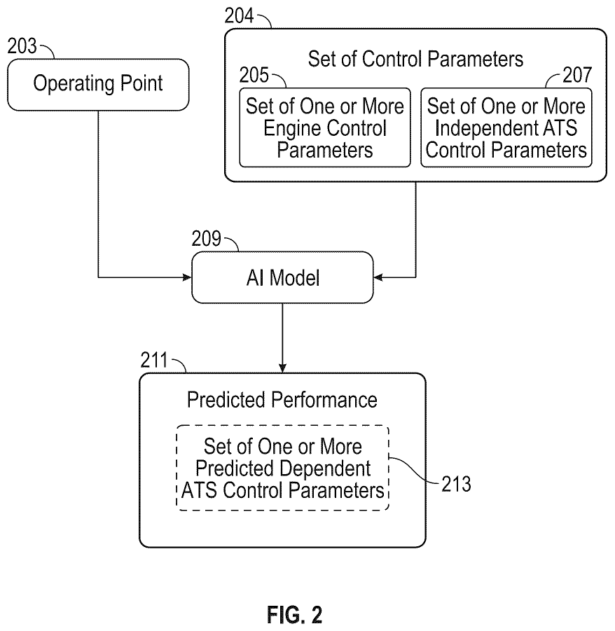

FIG. 2 depicts a system for predicting the performance of a motor assembly using artificial intelligence (AI). An operating point (203), denoted as O, a set of one or more engine control parameters (205), denoted as E, and a set of one or more independent ATS control parameters (207), denoted as A, are provided as inputs to an AI model (209). The set of one or more engine control parameters (205) and set of one or more independent ATS control parameters (207) form a set of control parameters (204). The AI model (209), denoted as M, returns, as output, a predicted performance (211), denoted as \hat{P}, for the performance of the motor assembly, so that \hat{P}=M(0, E, A). The predicted performance (211) may include a unique component or a plurality of components depending on a format of the performance. The predicted performance (211) includes one predicted component for each component of the performance. In the first example engine-ATS framework from Table I, the predicted performance (211) has a single component: a predicted tailpipe exhaust NOₓ rate. In the second engine-ATS example framework from Table II, the predicted performance (211) has five components: a predicted volume of smoke, a predicted engine efficiency, a predicted engine noise, a predicted tailpipe exhaust NOₓ rate and a predicted tailpipe exhaust HC rate. In scenarios where the performance includes dependent ATS control parameters, the predicted performance (211) includes a set of one or more predicted dependent ATS control parameters (213). Thus, in such embodiments, the dependent ATS control parameters are predicted by the AI model (209).

The AI model (209) may be defined in many ways. The AI model (209) may include, for example, a linear regression, a non-linear regression, a decision tree regressor, a random forest regressor, a Bayesian regressor, a support vector machine, or any combination thereof. In some embodiments, the AI model (209) includes a super learner model. A super learner model is built as an ensemble learner model combining a set of multiple machine learning models called base learner models. Examples of super learner models include bagging algorithms, boosting algorithms, and voting algorithms. In bagging algorithms, multiple instances of the same base learner model are trained on different subsets of training data. The final prediction may be defined as an average or a maximum voting score of the predictions from each instance. In boosting algorithms, base learner models are run sequentially, each base learner in the sequence correcting for errors made by the previous base learners in the sequence. Examples of boosting algorithms include adaboost, gradient boosting algorithms and catboost. Voting algorithms include running the base learner models separately using a whole training dataset and defining the output from the super learner model as the output that was obtained the most times from the different base learner models. In one or more embodiments, the base learner models are selected from a pool of 40 machine learning models, that may include decision tree regressors, random forest regressors, support vector machine models and regression models, and base learners of different types may be included in the super learner model. In one or more embodiments, the training of the super learner model is performed by using a Sequential Least-Squares Programming method. A more detailed description of some machine learning models and the super learner model is provided later in the instant disclosure. In particular, the pool of 40 machine learning models is provided in Table VI.

In some embodiments, the AI model (209) includes a neural network, such as a fully connected neural network, a convolutional neural network, a recurrent neural network (RNN), a long short term memory (LSTM) network, a gated recurrent unit (GRU), a transformers model, or any combination of fully connected, convolutional, recurrent, LSTM, GRU, normalization, pooling, dropout and regularization layers. The AI model (209) may include other components or structures outside of the ones described herein without departing from the scope of this disclosure.

In implementations where the predicted performance (211) has a unique component, the AI model (209) may include a single component. For instance, in the first example engine-ATS framework from Table II, the AI model (209) includes a single machine learning (ML) model that computes the predicted tailpipe exhaust NOₓ rate. In implementations where the predicted performance (211) has multiple components, the AI model (209) may include a single component or multiple components. In some implementations, the AI model (209) includes a single ML model that predicts all the components of the predicted performance (211). In such implementation, denoting p as the number of components of the predicted performance \hat{P}=(\hat{P}⁽¹⁾, . . . , \hat{P}^{(p)}), the AI model (209) includes one ML model, denoted as M₁, so that M(O,E,A)=M₁(O,E,A)=(\hat{P}⁽¹⁾, . . . , \hat{P}^{(p)}). In the second example engine-ATS framework from Table III, the predicted performance (211) has five components, namely, the predicted volume of smoke denoted as \hat{P}⁽¹⁾, the predicted engine efficiency denoted as \hat{P}⁽²⁾, the predicted engine noise denoted as \hat{P}⁽³⁾, the predicted tailpipe exhaust NOₓ rate denoted as \hat{P}⁽⁴⁾ and the predicted tailpipe exhaust HC denoted as \hat{P}⁽⁵⁾. The AI model (209) returns M(O,E,A)=M₁(O,E,A)=(\hat{P}⁽¹⁾, . . . , \hat{P}⁽⁵⁾).

In other implementations, the AI model (209) includes as many components as the number of components of the predicted performance (211). In such implementation, the AI model (209) includes p ML models, denoted as M₁, . . . , Mₚ, receiving O, E, A as inputs, and such that for all integer i=1, . . . , p, \hat{P}⁽ⁱ⁾=Mᵢ(O, E, A). In such scenarios, M(O, E, A)=(M₁(O, E, A), . . . , Mₚ(O, E, A))=(\hat{P}⁽¹⁾, . . . , \hat{P}^{(p)}). In the second example engine-ATS framework from Table III, the AI model (209) may include five ML models: a first ML model, M₁, computes the predicted volume of smoke \hat{P}⁽¹⁾=M₁(O,E,A); a second ML model, M₂, computes the predicted efficiency \hat{P}⁽²⁾=M₂(O, E, A); a third ML model, M₃, computes the predicted engine noise \hat{P}⁽³⁾=M₃(O, E, A); a fourth ML model, M₄, computes the predicted tailpipe exhaust NOₓ rate \hat{P}⁽⁴⁾=M₄(O, E, A); a fifth ML model, M₅, computes the predicted tailpipe exhaust HC rate \hat{P}⁽⁵⁾=M₅(O, E, A). In this specific example, M(O,E,A)=(M₁(O,E,A), M₂(O,E,A), M₃(O,E,A), M₄(O,E,A), M₅(O,E,A))=(\hat{P}⁽¹⁾, . . . , \hat{P}⁽⁵⁾).

In further implementations, the AI model (209) includes l>1 components with l<p and M(O, E, A)=(M₁(O, E, A), . . . , Mₗ(O, E, A))=(\hat{P}⁽¹⁾, . . . , \hat{P}^{(p)}). In such implementations, at least one component of the AI model (209) computes multiple components of the predicted performance (211). In the second example engine-ATS framework from Table III. the AI model (209) may include, for example, three ML models, M₁, M₂ and M₃. The first ML model computes the predicted volume of smoke and the predicted engine efficiency, so that (\hat{P}⁽¹⁾, \hat{P}⁽²⁾)=M₁(O, E, A). The second ML model, M₂, computes the predicted engine noise and the predicted tailpipe exhaust NOₓ rate, so that (\hat{P}⁽²⁾, \hat{P}⁽⁴⁾)=M₂(O,E, A). The third ML model, M₃, computes the predicted tailpipe exhaust HC rate, so that \hat{P}⁽⁵⁾=M₃(O, E, A). Advantageously, using multiple components provides flexibility of the design and training of the AI model (209). Each component of the AI model (209) may be designed and trained specifically for one or more specific components of the predicted performance (211).

In implementations in which the AI model (209) includes multiple components, each component of the AI model (209) may be configured in many ways, independently from the other components. For example, each component of the AI model (209) may include, independently from the other components of the AI model (209), a linear regression, a non-linear regression, a decision tree regressor, a random forest regressor, a Bayesian regressor, a support vector machine, or any combination thereof. In some embodiments, each component of the AI model (209) may include, independently from the other components of the AI model (209) a super learner model. In some implementations, every component of the AI model (209) is a distinct super learner model. In some embodiments, each component of the AI model (209) may include, independently from the other components of the AI model (209), a neural network, such as a fully connected neural network, a convolutional neural network, a recurrent neural network (RNN), a long short term memory (LSTM) network, a gated recurrent unit (GRU), a transformers model, or any combination of fully connected, convolutional, recurrent, LSTM, GRU, normalization, pooling, dropout and regularization layers. Each component of the AI model (209) may include other structures outside of the ones described herein without departing from the scope of this disclosure.

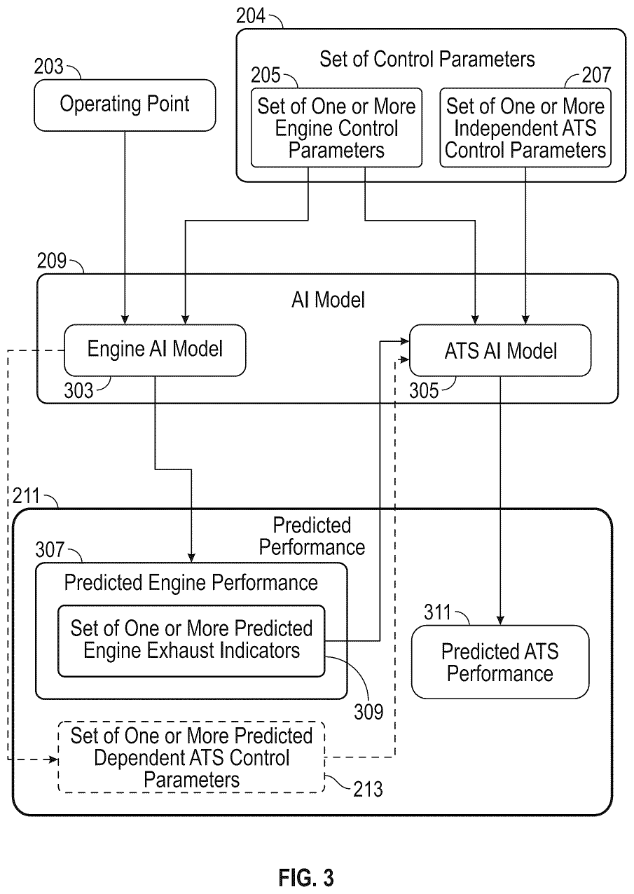

In some implementations, the AI model (209) includes multiple stages, where a given stage makes use of outputs from a previous stage. In such implementations, the AI model (209) includes multiple components, some of which are interconnected. FIG. 3 depicts an example implementation where the AI model (209) includes two stages. A first stage includes an engine AI model (303) and a second stage includes an ATS AI model (305). The performance includes an engine performance and an ATS performance. In response, the predicted performance (211) includes a predicted engine performance (307) and a predicted ATS performance (311). Each of the predicted engine performance (307) and predicted ATS performance (311) may include one component or multiple components of the predicted performance (211). The engine AI model (303) receives, as inputs, the operating point (203) and the set of one or more engine control parameters (205). The engine AI model (303) returns, as output, the predicted engine performance (307). Referring to the description of the AI model (209), the engine AI model (303) and ATS AI model (305) may each include one or more components, each component being a distinct ML model that predicts one or more components of the predicted performance (211).

In some practical applications, the engine performance describes properties specific to the engine (103), regardless of the ATS (109). The engine performance is a performance of the engine (103) regardless of whether the engine (103) is connected to the ATS (109). The engine performance may include one component or multiple components. Examples of components of the engine performance include brake specific fuel consumption, engine exhaust NOₓ rate, engine exhaust HC rate, volume of engine smoke, engine noise level, engine exhaust gas temperature, engine exhaust flow rate, engine efficiency and reductant injection rate. The predicted engine performance (307) includes as many components as the engine performance. Each component of the predicted engine performance (307) is a prediction for a distinct component of the engine performance. In the third example engine-ATS framework from Table IV, the engine performance is the set composed of brake specific fuel consumption, engine exhaust NOₓ rate, engine exhaust HC rate, volume of engine smoke, engine noise level, engine exhaust gas temperature, engine exhaust flow rate and engine efficiency. Accordingly, the predicted engine performance (307) includes a predicted brake specific fuel consumption, predicted engine exhaust NOₓ rate, predicted engine exhaust HC rate, predicted volume of engine smoke, predicted engine noise level, predicted engine exhaust gas temperature, predicted engine exhaust flow rate and predicted engine efficiency.

One or more components of the engine performance, called one or more engine exhaust indicators, include information that is used as input to the ATS (109). For instance, the engine exhaust NOₓ rate constitutes useful information for the ATS (109), since a goal of the ATS (109) is to process the engine exhaust NOₓ. The engine exhaust NOₓ rate may be used to parametrize the ATS (109). Accordingly, a set of one or more predicted engine exhaust indicators (309) is output by the engine AI model (303) as part of the predicted engine performance (307). For each given engine exhaust indicator included in the engine performance, the predicted engine performance (307) includes a predicted engine exhaust indicator predicting the given engine exhaust indicator. In the third example framework from Table IV, the engine exhaust indicators are the engine exhaust NOₓ rate, engine exhaust HC rate, engine exhaust gas temperature and engine exhaust flow rate. Accordingly, in this example, the one or more predicted engine exhaust indicators are a predicted engine exhaust NOₓ rate, predicted engine exhaust HC rate, predicted engine exhaust gas temperature and predicted engine exhaust flow rate. In implementations where the performance includes dependent ATS control parameters, the engine AI model (303) further outputs the set of one or more predicted dependent ATS control parameters (213).

The ATS AI model (305) receives, as inputs, the set of one or more predicted engine exhaust indicators (309), the set of one or more engine control parameters (205) and the set of one or more independent ATS control parameters (207). In some embodiments, the ATS AI model (305) further receives the set of one or more predicted dependent ATS control parameters (213). The ATS AI model (305) returns, as output, the predicted ATS performance (311). In some practical applications, the predicted ATS performance (311) is a prediction of a performance of the ATS (109), upon receiving an emission from the engine (103). The ATS performance may include one component or multiple components. Examples of components of the ATS performance include tailpipe exhaust NOₓ rate, tailpipe exhaust HC rate, tailpipe exhaust CO₂ rate and tailpipe particulate exhaust rate. The predicted ATS performance (311) includes one or more components. Each component of the predicted ATS performance (311) is a prediction for a distinct component of the ATS performance. In the third example engine-ATS framework from Table IV, the ATS performance is the set composed of tailpipe exhaust NOₓ rate and the tailpipe exhaust HC rate. In response, the ATS AI model (305) computes a predicted tailpipe exhaust NOₓ rate and a predicted tailpipe exhaust HC rate.

As a specific example considering the third engine-ATS framework from Table IV, the AI model (209) may include, in some embodiments, ten components. The first eight components form the engine AI model (303). Each of the first eight components, M₁, . . . , M₈, receives, as input, the operating point (203) and the set of one or more engine control parameters (205) as given in Table IV. Each of the first eight components, M₁, . . . , M₈ returns, as output, a prediction for a distinct component of the engine performance: \hat{P}⁽¹⁾=M₁(O, E)=predicted engine efficiency, \hat{P}⁽²⁾=M₂(O, E)=predicted brake specific fuel consumption, \hat{P}⁽³⁾=M₃(O, E)=predicted engine exhaust NOₓ rate, \hat{P}⁽⁴⁾=M₄(O, E)=predicted engine exhaust HC rate, \hat{P}⁽⁵⁾=M₅(O, E)=predicted volume of engine smoke, \hat{P}⁽⁶⁾=M₆(O, E)=predicted engine noise level, \hat{P}⁽⁷⁾=M₇(O, E)=predicted engine exhaust gas temperature and \hat{P}⁽⁸⁾=M₈(O, E)=predicted engine exhaust flow rate. The predicted engine exhaust indicators are defined by \hat{P}⁽³⁾, \hat{P}⁽⁴⁾, \hat{P}⁽⁷⁾ and \hat{P}⁽⁸⁾. The remaining two components of the AI model (209), M₉ and M₁₀, form the ATS AI model (305). Each of M₉ and M₁₀ receives, as inputs, the set of one or more engine control parameters (205), the set of one or more independent ATS control parameters (207) and the predicted engine exhaust indicators \hat{P}⁽⁴⁾, \hat{P}⁽⁵⁾, \hat{P}⁽⁸⁾ and \hat{P}⁽⁹⁾. The component M₁₀ returns, as output, the tailpipe exhaust NOₓ rate \hat{P}⁽⁹⁾=M₉(E, A, \hat{P}⁽³⁾, \hat{P}⁽⁴⁾, \hat{P}⁽⁷⁾, \hat{P}⁽⁸⁾)=M₉(E, A, M₃(O, E), M₄(O, E), M₇(O, E), M₈(O,E)). The component M₁₀ returns, as output, the tailpipe exhaust HC rate \hat{P}⁽¹⁰⁾=M₁₀ (E,A, \hat{P}⁽³⁾, \hat{P}⁽⁴⁾, \hat{P}⁽⁷⁾, \hat{P}⁽⁸⁾)=M₁₀ (E,A, M₃(O, E), M₄(O, E), M₇(O, E), M₈(O,E)). It is noted that even in this specific example, the performance can still be written as an output of the AI model (209) in its general form: \hat{P}=M(O, A, E).

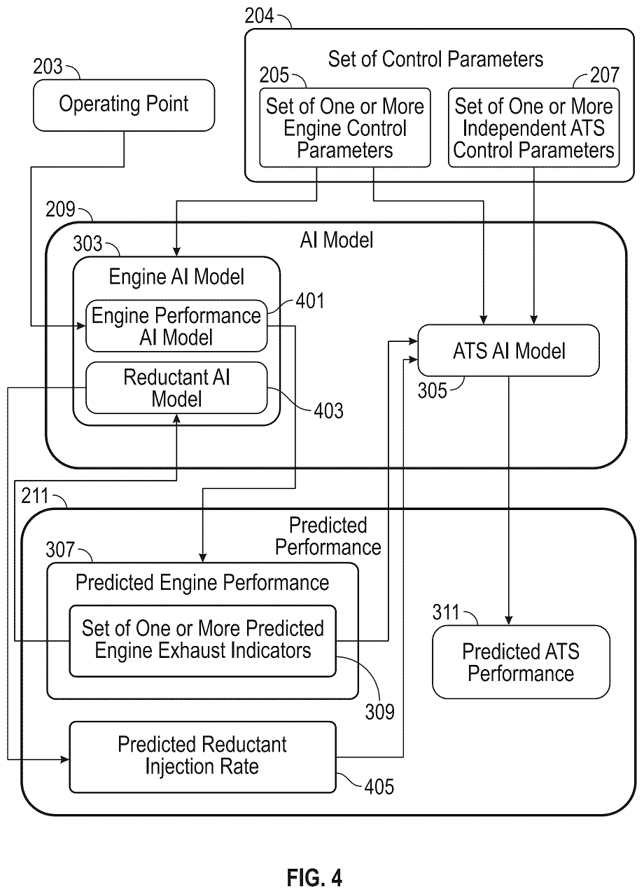

A stage of the AI model (209) may itself include multiple stages. FIG. 4 depicts an example of the AI model (209) with three stages. The engine AI model (303) includes two stages: a first stage, including an engine performance AI model (401) and a second stage that includes a reductant AI model (403). The ATS AI model (305) forms a third stage of the AI model (209). The ATS control parameters include one dependent ATS control parameter: the reductant injection rate. The reductant injection rate is a reductant injection rate consumed by the ATS to process the engine exhaust NOₓ. The engine performance AI model (401) receives, as inputs, the operating point (203) and the set of one or more engine control parameters (205). The engine performance AI model (401) returns, as output, the predicted engine performance (307). The predicted engine performance (307) includes the set of one or more predicted engine exhaust indicators (309).

The reductant AI model (403) receives, as inputs, the set of one or more predicted engine exhaust indicators (309) and the set of one or more engine control parameters (205). The reductant AI model (403) returns, as output, a predicted reductant injection rate (405). The predicted reductant injection rate (405) is a prediction for the reductant injection rate. The ATS AI model (305) receives, as inputs, the set of one or more predicted engine exhaust indicators (309), the set of one or more engine control parameters (205), the set of one or more independent ATS control parameters (207) and the predicted reductant injection rate (405). The ATS AI model (305) returns, as output, the predicted ATS performance (311). As a dependent ATS control parameter, the reductant injection rate is a part of the ATS control parameters. The ATS AI model (305) is trained to receive the dependent and independent ATS control parameters. Thus, the ATS AI model (305) requires a value for reductant injection rate as input. The reductant injection rate is predicted by the reductant AI model (403) as the predicted reductant injection rate (405). In FIG. 4, the AI model (209) is implemented such that ATS AI model (305) receives, as input, the predicted reductant injection rate (405) as a value for the reductant injection rate.

A specific example of an embodiment of the AI model (209) configured as in FIG. 4 is described herein. Considering the fourth engine-ATS framework from Table V, the AI model (209) may include eleven components. The first nine components form the engine AI model (303). In particular, the first eight components form the engine performance AI model (401). Each of the first eight components, M₁, . . . , M₈, receives, as input, the operating point (203) and the set of one or more engine control parameters (205) given in Table V. Each of the first eight components, M₁, . . . , M₈ returns, as output, a prediction for a distinct component of the engine performance: \hat{P}⁽¹⁾=M₁(O, E)=predicted engine efficiency, \hat{P}⁽²⁾=M₂(O, E)=predicted brake specific fuel consumption, \hat{P}⁽³⁾=M₃(O, E)=predicted engine exhaust NOₓ rate, \hat{P}⁽⁴⁾=M₄(O, E)=predicted engine exhaust HC rate, \hat{P}⁽⁵⁾=M₅(O, E)=predicted volume of engine smoke, \hat{P}⁽⁶⁾=M₆(O, E)=predicted engine noise level, \hat{P}⁽⁷⁾=M₇(O, E)=predicted engine exhaust gas temperature and \hat{P}⁽⁸⁾=M₈(O, E)=predicted engine exhaust flow rate. The predicted engine exhaust indicators are defined by \hat{P}⁽³⁾, \hat{P}⁽⁴⁾, \hat{P}⁽⁷⁾ and \hat{P}⁽⁸⁾. The eleventh component of the AI model (209), M₁₁, forms the reductant AI model (403). The component M₁₁ receives, as inputs, the set of one or more engine control parameters (205) and the predicted one or more engine exhaust indicators \hat{P}⁽³⁾, \hat{P}⁽⁴⁾, \hat{P}⁽⁷⁾ and \hat{P}⁽⁸⁾. The component M₁₁ returns, as output, the predicted reductant injection rate (405), denoted by Û=\hat{P}⁽¹¹⁾=M₁₁(E,A, \hat{P}⁽³⁾, \hat{P}⁽⁴⁾, M₉(E, A, \hat{P}⁽³⁾, \hat{P}⁽⁴⁾, \hat{P}⁽⁷⁾, \hat{P}⁽⁸⁾))=M₁₁(E,A, M₃(O,E), M₄(O,E), M₇(O,E), M₈(O,E)). The ninth and tenth components of the AI model (209), M₉ and M₁₀, form the ATS AI model (305). Each of M₉ and M₁₀ receives, as inputs, the set of one or more engine control parameters (205), the set of one or more independent ATS control parameters (207), the predicted one or more engine exhaust indicators \hat{P}⁽³⁾, \hat{P}⁽⁴⁾, \hat{P}⁽⁷⁾ and \hat{P}⁽⁸⁾and the predicted reductant injection rate U. The component M₉ returns, as output, the tailpipe exhaust NOₓ rate \hat{P}⁽⁹⁾=M₉(E,A, \hat{P}⁽³⁾, \hat{P}⁽⁴⁾, \hat{P}⁽⁷⁾, \hat{P}⁽⁸⁾, \hat{R}). The component M₁₀ returns, as output, the tailpipe exhaust HC rate \hat{P}⁽¹⁰⁾=M₁₀(E,A, \hat{P}⁽³⁾, \hat{P}⁽⁴⁾, \hat{P}⁽⁷⁾, \hat{P}⁽⁸⁾, Û). It is noted that even in this specific example, the performance can still be written as an output of the AI model (209) in its general form: \hat{P}=M(O, A, E).

Artificial intelligence models typically involve a training phase and a testing phase, both using previously acquired data. Supervised machine-learned models require data samples of input and associated output (i.e., target) pairs in order to learn a desired functional mapping. In the context of this disclosure, the data samples are extracted from operational data. Thus, the AI model (209) is trained using operational data. The operational data include, at least, values of operating points, values of engine control parameters, values of ATS control parameters, and corresponding values of the performance. As described below, the operational data may include other types of data, depending on the architecture of the AI model (209). One with ordinary skill in the art will readily appreciate that a full discussion of the training of every component of the AI model (209) is not possible nor required to describe the systems and methods in this disclosure. Therefore, a brief discussion is provided herein.

The AI model (209) includes one component or multiple components. Each component of the AI model (209) is trained, separately or jointly, and requires a dataset of data samples specific to that component. For instance, in some implementations, the AI model (209) includes a single ML model, M₁, configured to receive, as inputs, an operating point, a set of one or more engine control parameters and a set of one or more independent ATS control parameters and return, as output, a predicted performance \hat{P}=M₁(O, A, E). In such implementations, the input of a data sample is composed of an operating point, a set of one or more engine control parameters and a set of one or more independent ATS control parameters. The output of a data sample is composed of a performance P corresponding to the input. The performance P is composed of all the components of the performance P.

In other implementations, the AI model (209) includes two ML models, namely a first ML model, M₁, and a second ML model, M₂, that each receive, as inputs, an operating point, a set of one or more engine control parameters and a set of one or more independent ATS control parameters. The performance is composed of two components, namely, P⁽¹⁾ and P⁽²⁾. The first ML model returns, as output, a first prediction \hat{P}⁽¹⁾ for the first component of the performance, P⁽¹⁾. The second ML model returns, as output, a second prediction \hat{P}⁽²⁾ for the second component of the performance, P⁽²⁾. In such implementations, two datasets of data samples are needed for the purpose of training and testing the AI model (209): a first dataset of data samples for the training and testing of M₁ and a second dataset of data samples for the training and testing of M₂. An input of the first dataset is composed of an operating point, a set of one or more engine control parameters and a set of one or more independent ATS control parameters. The associated output is composed of a value of P⁽¹⁾ corresponding to the input. An input of the second dataset is composed of an operating point, a set of one or more engine control parameters and a set of one or more independent ATS control parameters. The associated output is composed of a value of P⁽²⁾ corresponding to the input.

In multi-stage implementations of the AI model (209), such as the implementations in FIGS. 3 and 4, the inputs of the data samples may include values other than an operating point, a set of one or more engine control parameters and a set of one or more independent ATS control parameters. Assuming that the ATS AI model (305) in FIG. 3 includes p ML models, each of the p ML models computes a prediction \hat{P}⁽ⁱ⁾ for a component P⁽ⁱ⁾ of a p-component performance P. In such implementation, p datasets of data samples are needed to train the ATS AI model (305). Each of the p datasets of data samples is used to train a distinct ML model among the p ML models. For each positive integer i≤p, an input of a data sample in the i^{th} dataset is composed of a set of one or more engine control parameters, a set of one or more independent ATS control parameters and a set of one or more engine exhaust indicators. The associated output is composed of a value of the i^{th} component of the performance P⁽ⁱ⁾. Therefore, in such implementations, the operational data further includes values of the one or more engine exhaust indicators to form the inputs of the p datasets of data samples. Furthermore, in implementations where the ATS control parameters include dependent parameters, the engine AI model (303) outputs the set of one or more predicted dependent ATS control parameters (213) that are used as input to the ATS AI model (305). In such scenarios, the operational data further includes values of dependent ATS control parameters to form the inputs of the p datasets of data samples.

In the context of training and testing the reductant AI model (403) in FIG. 4, one dataset of data samples may be used. An input of a data sample is composed of a set of one or more engine control parameters, a set of one or more ATS control parameters and a set of one or more engine exhaust indicators. The associated output is a value of a reductant injection rate required by the ATS to process the exhaust from the engine in accordance with the input. In the context of training and testing the ATS AI model (305) in FIG. 4, a distinct dataset of data samples is used to train and test each component of the ATS AI model (305). Assuming that the ATS AI model (305) in FIG. 4 includes p ML models, each of the p ML models computes a prediction \hat{P}⁽ⁱ⁾ for a component P⁽ⁱ⁾ of a p-component performance P. In such implementation, p datasets of data samples are needed to train the ATS AI model (305). Each of the p datasets of data samples is used to train a distinct ML model among the p ML models. For each positive integer i≤p, an input of a data sample in the i^{th} dataset of data samples is composed of a set of one or more engine control parameters, a set of one or more ATS control parameters, a set of one or more engine exhaust indicators and a value of a reductant injection rate. The associated output is composed of a value of the i^{th} component of the performance, P⁽ⁱ⁾. Therefore, in such implementations, the operational data further includes values of reductant injection rates to form the inputs of the p datasets of data samples.

The operational data can be acquired in many ways and a few examples are provided herein. In one or more embodiments, the operational data are taken from an operational database that was created in the past. In one or more embodiments, the operational data are acquired using experiments, run in a data acquisition facility. The data acquisition facility may include an experimental motor assembly that can be parametrized, a dynamometer that applies a load against the engine, and a throttle valve that regulates the amount of fuel and air that enters the engine. The data acquisition facility further includes test sensors, including test operating sensors and test performance sensors. Examples of operating sensors include the dynamo itself, that provides readings of the engine load and the engine speed. Examples of performance sensors include a fuel meter that captures the amount of fuel burnt by the engine, an exhaust gas analyzer that analyzes engine exhaust gases and tailpipe exhaust gases, a smoke analyzer and a microphone that records engine sound. Each experiment consists of operating the engine in accordance with an operating point, using a specific set of one or more engine control parameters and specific set of one or more ATS control parameters. The performance corresponding to the operating point, using a specific set of one or more engine control parameters and specific set of ATS control parameters is measured by the test sensors. In some implementations, the data acquisition facility further includes engine sensors and ATS sensors to verify that the engine control parameters and ATS control parameters are set properly.

In one or more embodiments, a dataset of data samples is split into a training dataset and a testing dataset. The data sample input and associated output pairs of the training dataset are called training data samples. The data sample input and associated output pairs of the testing dataset are called testing data samples. It is common practice to split the dataset in a way that the training dataset contains more data samples than the testing dataset. Because data splitting is a common practice when training and testing a machine-learned model, it is not described in detail in this disclosure. One with ordinary skill in the art will recognize that any data splitting technique may be applied to the dataset without departing from the scope of this disclosure. Each component of the AI model (209) is trained as a functional mapping that optimally matches the inputs of the training data samples to the associated outputs of the training data samples.

Once trained, a given component of the AI model (209) is validated by computing a metric for the testing data samples, in accordance with one or more embodiments. Denoting as m≥1 the number of testing data samples, the input of the i^{th} testing data sample is denoted as xᵢ, for i=1, . . . , m. The outputs of the data samples include one or more numerical components. The output of the i^{th} testing data sample may be arranged as a vector yᵢ, for i=1, . . . , m. The output of the given component of the AI model (209) receiving xᵢ as input also includes one or more numerical components, that may be arranged as a vector ŷᵢ, for i=1, . . . , m. In such scenarios, examples of metrics that may be used to validate the given component of the AI model (209) include any scoring or comparison metrics known in the art, including but not limited to: a mean absolute error (MAE), a mean squared error (MSE), a root mean square error (RMSE) and a coefficient of determination (R²), defined respectively as:

$$M A E = \frac{1}{m} {\sum }_{i = 1}^{i = m} \vert {\hat{y}}_{i} - {y}_{i} \vert , \qquad EQ . 1$$

$$M S E = \frac{1}{m} {\sum }_{i = 1}^{i = m} {\vert {\hat{y}}_{i} - {y}_{i} \vert}^{2} , \qquad EQ . 2$$

$$R M S E = \sqrt{\frac{1}{m} {\sum }_{i = 1}^{i = m} {\vert {\hat{y}}_{i} - {y}_{i} \vert}^{2}} , \qquad EQ . 3$$

$${R}^{2} = 1 - \frac{{\sum }_{i = 1}^{i = m} {\vert {\hat{y}}_{i} - {y}_{i} \vert}^{2}}{{\sum }_{i = 1}^{i = m} {\vert {y}_{i} - \overline{y} \vert}^{2}} . \qquad EQ . 4$$

### In EQ. 1-EQ. 4,

$$\overline{y} = \frac{1}{m} {\sum }_{i = 1}^{i = m} {y}_{i} .$$

The notation | | denotes a vectorial norm, such an l₂ norm. Note that the comparison functions in EQs. 1-4 can also be applied to the training data samples, by denoting m as the number of training data samples, yᵢ as the output of the i^{th} training data sample and ŷᵢ as the output of the component of the AI model (209) upon receiving the input of the i^{th} training data sample, xᵢ, as input, for i=1, . . . , m.

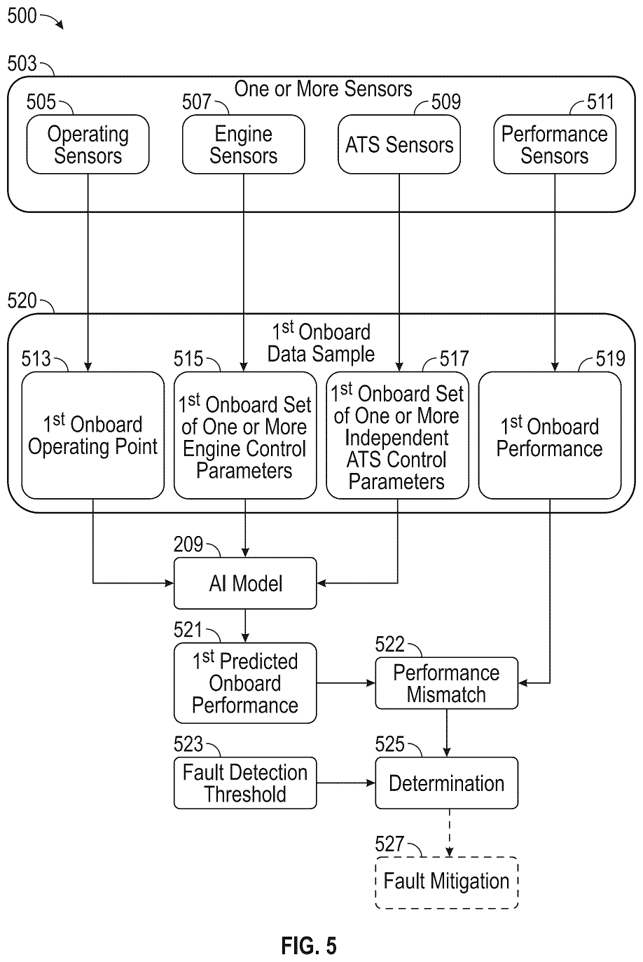

FIG. 5 depicts an example use of the AI model (209) under actual driving conditions: a fault detection system (500). In FIG. 5, the motor assembly (100) is mounted on a motor vehicle, operated by a driver. The motor vehicle includes one or more sensors (503) that measure onboard operational data while the motor vehicle is operated. The one or more sensors (503) include operating sensors (505), engine sensors (507), ATS sensors (509) and performance sensors (511). At a specific instant, the operating sensors (505) measure a first onboard operating point (513). At essentially the same instant, the engine sensors (507) measure a first onboard set of one or more engine control parameters (515). At the same instant, the ATS sensors (509) measure a first onboard set of one or more independent ATS control parameters (517). At the same instant, the performance sensors (511) measure a first onboard performance (519) for the motor assembly. The first onboard operating point (513), first onboard set of one or more engine control parameters (515), first onboard set of one or more independent ATS control parameters (517) and first onboard performance (519) form a first onboard data sample (520). In some embodiments, the operating sensors (505) include one or more of an engine load sensor, a throttle position sensor and an engine speed sensor, such as a magnetic inductive sensor or an optical sensor. In some embodiments, the engine sensors (507) include one or more of a mass air flow sensor measuring an amount of air entering the engine, a manifold absolute pressure sensor that measure a pressure in the intake manifold of the engine, an oxygen sensor, an intake air temperature sensor, a fuel pressure sensor that measures a fuel pressure in the fuel rail and a fuel injector timing sensor that measures a time of first and second injections. In some embodiments, the ATS sensors (509) include one or more of a thermometer measuring a temperature of the SCR system and a reductant injection rate sensor that measure an injection rate of the reductant in the SCR system. In some embodiments, the performance sensors (511) include one or more of an engine exhaust gas analyzer that analyzes engine exhaust gases, a tailpipe gas analyzer that analyzes tailpipe exhaust gases, a smoke analyzer that analyzes engine smoke and a microphone that records engine noise.

The first onboard operating point (513), first onboard set of one or more engine control parameters (515) and first onboard set of one or more independent ATS control parameters (517) are input to the AI model (209). The AI model (209) outputs a first predicted onboard performance (521). The first predicted onboard performance (521) is compared with the first onboard performance (519) by computing a performance mismatch (522). In some implementations, the performance mismatch (522) is an absolute value of a difference between the first predicted onboard performance (521) and the first onboard performance (519). It is generally understood that if the motor vehicle, the one or more sensors (503) and the AI model (209) are functioning properly, the performance mismatch (522) should remain relatively small. To evaluate whether the performance mismatch (522) is relatively small, a determination (525) is made whether the performance mismatch (522) is smaller than a pre-defined fault detection threshold (523). The fault detection threshold (523) can be defined in several ways. In one or more embodiments, the fault detection threshold (523) is defined arbitrarily. In other embodiments, the fault detection threshold (523) is defined based on a measured error computed during a testing phase of the AI model (209), such as the root mean squared error from EQ. 3. For example, the fault detection threshold (523) may be defined as a certain number of times the root mean squared error from EQ. 3. If the performance mismatch (522) is smaller than the fault detection threshold (523), the motor vehicle, the one or more sensors (503) and the AI model (209) are acknowledged to be functioning properly. If the performance mismatch (522) is greater than or equal to than the fault detection threshold (523), a fault is detected, and a fault mitigation (527) is conducted.

The fault mitigation (527) includes a fault alert informing that a fault has been detected. The fault alert may be of various types. In some implementations, the fault alert includes a sound notification inside the motor vehicle. In some implementations, the fault alert includes a light displayed on a dashboard of the motor vehicle. In some implementations, the fault alert includes sending a message to an electronic device, such as a cell phone of the driver, or a receiver of a motor vehicle manufacturer or a receiver of a repair facility. The fault may stem from many causes, such as a malfunctioning of the motor vehicle components, the one or more sensors (503) or the AI model (209). In some embodiments, the fault mitigation (527) includes repairing or replacing one or more components of the motor vehicle or the one or more sensors (503). In some embodiments, the fault mitigation (527) includes modifying the AI model (209).

The AI model (209) is hosted and run on a computer system. The computer system includes one or more computer processors. The computer system includes at least one computer, that includes at least one computer processor among the one or more computer processors. The AI model (209) is hosted and run on, at least, the computer. In one or more embodiments, the computer is located in a facility where the motor assembly is located. In other embodiments, the computer is located in a remote facility, away from the motor assembly. In such embodiments, the computer is called a remote computer. If the motor assembly is mounted on a motor vehicle, the AI model (209) may be still hosted and run on the remote computer, away from the motor vehicle, in the remote facility. In such scenarios, the remote computer receives the first onboard data sample (520) from the motor vehicle via a remote communication system. The AI model (209) is used to compute the first predicted onboard performance (521) on the remote computer. The determination (525) is performed in the remote facility. If a fault is detected, the fault mitigation (527) is planned, or conducted, or both, from the remote facility.

The computer system may include an onboard computer, installed in the motor vehicle itself. Advantageously, the AI model (209) may be hosted and run on the onboard computer. In such scenarios, no remote communication system is needed. In such scenarios, the AI model (209) is engineered such that the onboard computer is capable of hosting and running the AI model (209). In some embodiments, the onboard computer is configured to communicate with ECU. In some embodiments, the onboard computer hosting the AI model (209) is part of a plugin-kit. The plugin-kit may be installed on new motor vehicles or retrofitted on older motor vehicles. Under current technology at the time of writing this disclosure, the one or more sensors (503) are readily installed on modern cars. No new sensors need to be installed to accommodate the system in FIG. 5. In some embodiments, the computer system includes both the remote computer and the onboard computer, and the AI model (209) is hosted and run on both the remote computer and the onboard computer.

In one or more embodiments, the process of acquiring the first onboard data sample using the one or more sensors (503) is repeated multiple times. In such embodiments, a plurality of onboard data samples is acquired in a similar fashion to the first onboard data sample. The onboard data samples form onboard operational data. In one or more embodiments, the onboard operational data are used to build onboard training data samples at a plurality of distinct instants and fine-tune the AI model (209). Each onboard training data sample is acquired at a distinct instant while the motor vehicle is operating. Each onboard training data sample, acquired at a distinct instant, includes an onboard training input and an onboard training output. The onboard training input includes, at least, an onboard operating point acquired by the operating sensors (505), an onboard set of one or more engine control parameters acquired by the engine sensors (507) and an onboard set of one or more independent ATS control parameters acquired by the ATS sensors (509) at that distinct instant. The onboard training output includes an onboard performance acquired by the performance sensors (511) at that distinct instant. In implementations where the ATS control parameters include dependent ATS control parameters, the onboard training input further includes components from the onboard performance. In such scenarios, the components of the onboard performance that serve as dependent ATS control parameters are both part of the onboard training input and onboard training output.

The AI model (209) is fine-tuned using the onboard training data samples. Fine-tuning the AI model (209) using onboard training data samples while the motor vehicle is operated may be seen as presenting some advantages. Generally, the AI model (209) is trained using operational data from a generic motor assembly. As previously described, the operational data used for training the AI model (209) may be obtained from an operational data database or a set of experiments run in a data acquisition facility. The AI model (209) is then used for a specific motor assembly, fitted on a specific motor vehicle. Thus, the AI model (209) is used for a specific motor assembly for which it was not originally trained. By contrast, fine-tuning of the AI model (209) is performed using onboard training data samples captured from the specific motor assembly of the motor vehicle on which it is installed. Thus, fine-tuning the AI model (209) results in improved accuracy of the AI model (209) for the specific motor assembly on the specific vehicle on which it is installed. Furthermore, the performance of the motor assembly of a motor vehicle depends on driving conditions, such as a frequency of use of the motor vehicle, an age of the motor vehicle and driver's habits. Fine-tuning the AI model (209) allows the AI model (209) to adapt to such driving conditions. Furthermore, the driving conditions may change during the life of the motor vehicle. Generally, the performance of the motor assembly decreases with time, due to, for example, aging of component parts. In some embodiments, fine-tuning of the AI model (209) is performed periodically to capture changes of the driving conditions during the life of the motor vehicle.

In one or more embodiments, fine-tuning the AI model (209) is performed on an onboard computer that hosts the AI model (209). In such embodiments, the onboard computer includes a training algorithm to fine-tune the AI model (209). The AI model (209) is engineered such that the onboard computer has enough computational resources to fine-tune the AI model (209). In some embodiments, training the AI model (209) is too computationally intensive to be performed on the onboard computer, but fine-tuning the AI model (209) is computationally moderate enough to be performed on the onboard computer. An advantage of fine-tuning the AI model (209) onboard lies in preserving a compactness of the system formed by the motor assembly and the AI model (209), without the need for a remote communication system or external intervention.

As stated, a given operating point may be satisfied by multiple, and possibly infinitely many, combinations of the engine control parameters and the ATS control parameters. To operate the motor assembly, a unique combination of the engine control parameters and the ATS control parameters must be selected. Generally, a unique combination of the engine control parameters and the ATS control parameters is selected according to a selection criterion. Selecting the unique combination using a selection criterion is called “calibrating” the motor assembly for the given operating point. The engine control parameters and the ATS control parameters can be selected sequentially. Specifically, the engine control parameters are selected first, and then, the ATS control parameters are selected based on the selection of the engine control parameters. For instance, in some embodiments, the selection criterion for the engine control parameters is that the unique combination of the engine control parameters should optimize a certain quantity, based on, for example, one or more components of the engine performance. In other embodiments, the selection criterion for the engine control parameters is that the actual engine air-fuel ratio that stems from the engine control parameters should equal a known stochiometric engine air-fuel ratio. After the engine control parameters have been determined, the ATS control parameters are selected to process the exhaust materials from the engine operated using the determined engine control parameters.

In some cases, the selection of a unique combination of the engine control parameters, for a given operating point, is made by a team of specialists in the data acquisition facility, using the equipment in the data acquisition facility, such as the dynamometer. Often, the specialists use a trial-and-error process with a feedback loop. The trial-and-error process consists of operating the engine under a first set of one or more engine control parameters and measuring the quantity to be optimized. Then, the engine control parameters are modified to try and improve the quantity to be optimized. If the quantity to be optimized is improved, the trial and error is repeated. If the quantity to be optimized is not improved, the engine control parameters are modified in a different fashion and the trial-and-error process is repeated. In other embodiments, the specialists use a grid search method, in which several test sets of engine control parameters are tested. The engine is operated according to each test set of one or more engine control parameters and the quantity to be optimized is measured. The engine control parameters are then selected as the test set that yields the optimum quantity to be optimized among the test sets. In some implementations, an engine map is formed by repeating the selection process for multiple operating points that serve as entries to the engine map. Generally, forming an engine map requires numerous experiments and measurements using the dynamometer. Amounts of the exhaust engine materials are measured at each experiment and the ATS control parameters are then optimized, using another set of experiments, to process engine exhaust materials at the measured values.

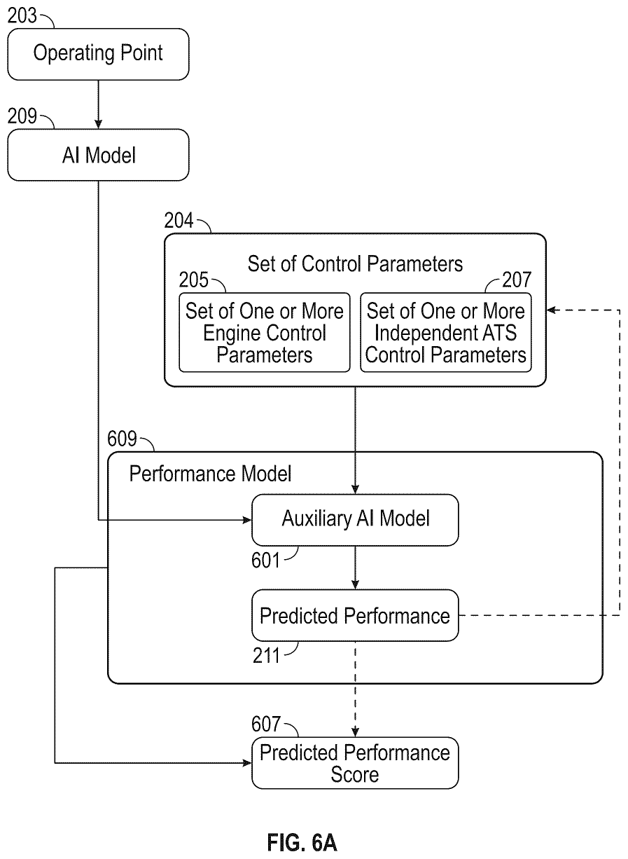

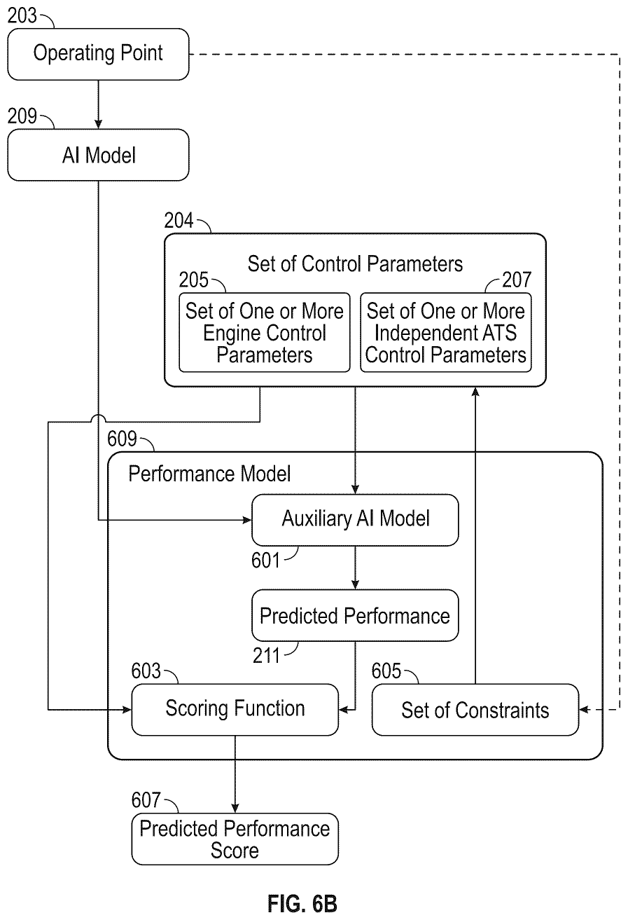

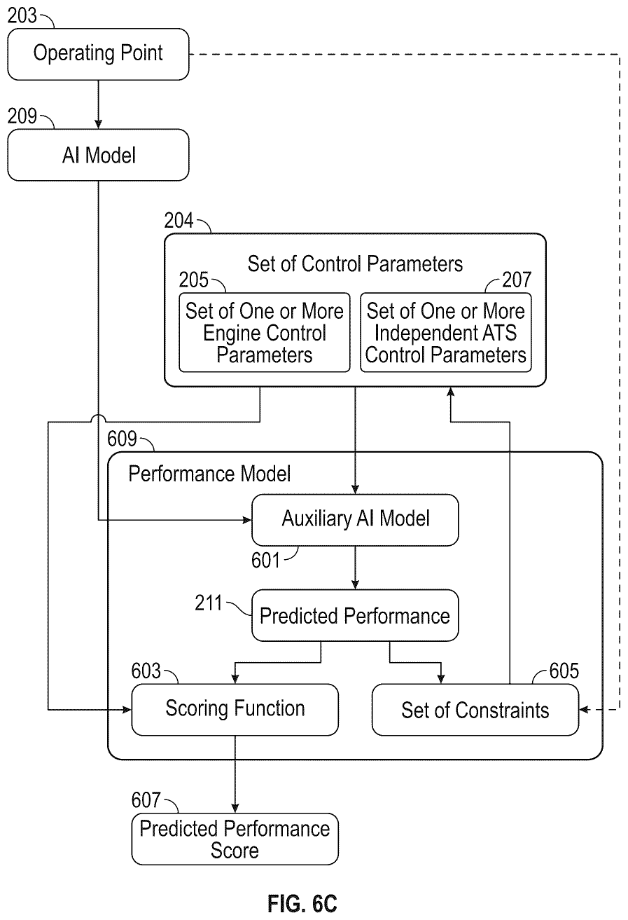

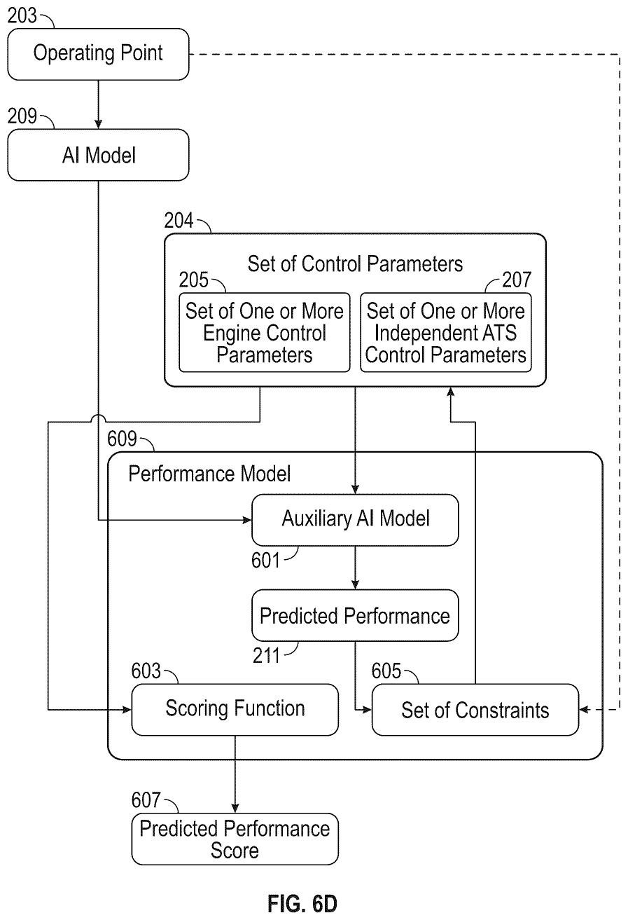

In this disclosure, the motor assembly (100) is calibrated automatically. Furthermore, in some embodiments described in this disclosure, the engine control parameters and the ATS control parameters are selected simultaneously, rather than sequentially. In other embodiments described in this disclosure, the engine control parameters and the ATS control parameters are selected sequentially. For a given operating points, the engine control parameters and ATS control parameters are selected as optimizing a predicted performance score of the motor assembly. FIG. 6A depicts an overview of a performance model (609). The performance model (609) receives, as inputs, a set of control parameters (204) composed of the set of one or more engine control parameters (205), denoted as E, and the set of one or more independent ATS control parameters (207), denoted as A. An auxiliary AI model (601) is formed based on the operating point (203), denoted as O, and the AI model (209), denoted as M. The auxiliary AI model (601) receives, as input, the set of control parameters (204). The auxiliary AI model (601) returns, as output, the predicted performance (211), denoted as M(O, E, A), output by the AI model (209) upon receiving, as input, the operating point (203) and the set of control parameters (204). The performance model (609) returns, as output, a predicted performance score (607), based on the predicted performance. Thus, the performance model (609) returns, as output, a predicted performance score (607), based on the AI model (209) receiving the operating point (203). Thus, the performance model (609) is configured based on the operating point (203). The predicted performance score (607) is a numerical value assessing the motor assembly. The predicted performance score (607) can be defined in many ways. Some implementations of the predicted performance score (607) are described later in this disclosure.

Although the predicted performance score (607) is determined based on the predicted performance (211), the predicted performance score (607) needs not depend on the predicted performance (211). It is the determination of the predicted performance score (607) that is based on the predicted performance (211). In some implementations, the predicted performance score (607) is based on the predicted performance (211). In other implementations, the predicted performance score (607) is not based on the predicted performance (211), but the set of control parameters (204) is restricted based on the predicted performance (211). In some implementations, the predicted performance score (607) is based on the predicted performance (211) and the set of control parameters (204) is restricted based on the predicted performance (211).

Specific embodiments of the performance model (609) are depicted in FIGS. 6B-6D. In FIG. 6B, the performance model (609) includes a scoring function (603), denoted as F, and a set of constraints (605). The scoring function (603) is used to compute the predicted performance score (607). The set of constraints (605) is used to restrict the set of control parameters (204). In FIG. 6B, the scoring function (603) is configured to receive, as input, the set of control parameters (204) and a performance of the motor assembly, denoted as P. The scoring function (603) is configured to return, as output, a performance score, thereby denoted as F(E, A, P). The performance score is a performance metric configured to assess the set of one or more engine control parameters (205) and the set of one or more independent ATS control parameters (207). The higher the performance score, the better the set of one or more engine control parameters (205) and the set of one or more independent ATS control parameters (207). Upon receiving, as input, the set of control parameters (204) and the predicted performance (211), the scoring function (603) returns, as output, the predicted performance score (607), thereby denoted as F(E, A, M(O, E, A)). Hence, the predicted performance score (607) is based on the AI model (209) receiving the operating point (203).

As previously described, the performance may include one or more components. The number of components of the performance is denoted as p. If p>1, the components of P are denoted as P⁽¹⁾, . . . , P^{(p)}. Thus, F(E, A, P)=F(E, A, P⁽¹⁾, . . . , P^{(p)}). As previously described, the performance may include maximizing components and minimizing components. Denoting e as the number of engine control parameters and a as the number of independent ATS control parameters, the scoring function (603) is a function of s=p+e+a variables. The engine control parameters and independent ATS control parameters may also include maximizing control parameters and minimizing control parameters. Minimizing a control parameter occurs when it is preferable to reduce the control parameter. For instance, in some embodiments, it is desirable to reduce the reductant injection rate or the exhaust gas recirculation rate. In such embodiments, the reductant injection rate is a control parameter to be minimized. Maximizing a control parameter occurs when it is preferable to be increase the control parameter. It follows that the scoring function (603) receives variables to be minimized (“minimizing variables”), variables to be maximized (“maximizing variables”), or both. The number of maximizing variables of scoring function (603) is denoted as s₁ and the number of minimizing variables of scoring function (603) is denoted as s₂. Three mutually exclusive scenarios may occur. In a first scenario, s₁>0 and s₂=0. In a second scenario, s₁=0 and s₂>0. In a third scenario, s₁>0 and s₂>0. If s₁>0 and s₂=0, the scoring function (603) is defined as being non-decreasing with respect to each of its s variables and increasing with respect to at least one of the s variables. If s₁=0 and s₂>0, the scoring function (603) is defined as being non-increasing with respect to each of its s variables and decreasing with respect to at least one of the s variables. If s₁>0 and s₂>0, the scoring function (603) is defined as being non-decreasing with respect to its s₁ maximizing variables and non-increasing with respect to its s₂ minimizing variables. Furthermore, if s₁>0 and s₂>0, the scoring function (603) is defined as satisfying at least one of the following properties a) and b): a) the scoring function (603) is increasing with respect to at least one of its s₁ maximizing variables; b) the scoring function (603) is decreasing with respect to at least one of its s₂ minimizing variables.

For completeness, four monotonicity conditions are included herein. Let i∈[1,s] be an integer and \vec{i}∈ [symbol] be the vector with the i^{th} component equal to 1, and, in case s>1, all of the other components equal to 0. A function ƒ: [symbol] → [symbol] is said to be increasing with respect to its i^{th} variable if, for all vector u∈ [symbol] and all real number ϵ>0, ƒ(u+ϵ\vec{i})>ƒ(u). A function ƒ: [symbol] → [symbol] is said to be non-decreasing with respect to its i^{th} variable if, for all vector u∈ [symbol] and all real number ϵ>0, ƒ(u+ϵ\vec{i})>ƒ(u). A function ƒ: [symbol] → [symbol] is said to be decreasing with respect to its i^{th} variable if, for all vector u∈ [symbol] and all real number ϵ>0, ƒ(u+ϵ\vec{i})<ƒ(u). A function ƒ: [symbol] → [symbol] is said to be non-increasing with respect to its i^{th} variable if, for all vector u∈ [symbol] and all real number ϵ>0, ƒ(u+ϵ\vec{i})≤ƒ(u).

The performance score F(E, A, P) needs not depend on all the variables of the scoring function (603). In other words, the scoring function (603) may be able to select some its inputs variables to form the output performance score. For illustration purposes, examples of a scoring function (603) are given herein. Using the third example engine-ATS framework from Table IV as a specific embodiment, the performance includes ten components, namely, P⁽¹⁾=engine efficiency, P⁽²⁾=brake specific fuel consumption, P⁽³⁾=engine exhaust NOₓ rate, P⁽⁴⁾=engine exhaust HC rate, P⁽⁵⁾=volume of engine smoke, P⁽⁶⁾=engine noise level, P⁽⁷⁾=engine exhaust gas temperature, P⁽⁸⁾=engine exhaust flow rate, P⁽⁹⁾=tailpipe exhaust NOₓ rate and P⁽¹⁰⁾=tailpipe exhaust HC rate. The performance includes one maximizing component, namely, the engine efficiency P⁽¹⁾ and nine minimizing components, namely, the brake specific fuel consumption P⁽²⁾, the engine exhaust NOₓ rate P⁽³⁾, the engine exhaust HC rate P⁽⁴⁾, the volume of engine smoke P⁽⁵⁾, the engine noise level P⁽⁶⁾, engine exhaust gas temperature P⁽⁷⁾, the engine exhaust flow rate P⁽⁸⁾, the tailpipe exhaust NOₓ rate P⁽⁹⁾ and the tailpipe exhaust HC rate P(10).

As a first example, the performance score may be defined as depending on the tailpipe exhaust NOₓ rate P⁽¹⁰⁾ only:

$$F ( E , A , P ) = 1 / {P}^{( 9 )} . \qquad EQ . 5$$

It is noted that the tailpipe exhaust NOₓ rate P⁽⁹⁾ is a minimizing component and F is decreasing with respect to P⁽⁹⁾ in EQ. 5. Furthermore, in EQ. 5, F is constant, and thus non-increasing and non-decreasing with respect to each of P⁽¹⁾, P⁽²⁾, P⁽³⁾, P⁽⁴⁾, P⁽⁵⁾, P⁽⁶⁾, P⁽⁷⁾, P⁽⁸⁾, P⁽¹⁰⁾ and the components of E and A. As a second example, the scoring function F may be defined as depending on the engine efficiency P⁽¹⁾ only:

$$F ( E , A , P ) = {P}^{( 1 )} . \qquad EQ . 6$$

It is noted that the engine efficiency P⁽¹⁾ is a maximizing component and F is increasing with respect to P⁽¹⁾ in EQ. 6. Furthermore, in EQ. 6, F is constant, and thus non-increasing and non-decreasing with respect to each of P⁽²⁾, P⁽³⁾, P⁽⁴⁾, P⁽⁵⁾, P⁽⁶⁾, P⁽⁷⁾, P⁽⁸⁾, P⁽⁹⁾, P⁽¹⁰⁾ and the components of E and A. As a third example, the scoring function F may be defined as depending on the tailpipe exhaust NOₓ rate P⁽⁹⁾ and tailpipe exhaust HC rate P⁽¹⁰⁾ only:

$$F ( E , A , P ) = \frac{{α}_{1}}{{P}^{( 9 )}} + \frac{{α}_{2}}{{P}^{( 10 )}} , \qquad EQ . 7$$

where α₁ and α₂ are two positive real numbers. In EQ. 7, the tailpipe exhaust NOₓ rate P⁽¹⁰⁾ and tailpipe exhaust HC rate P⁽¹¹⁾ are two minimizing components and the scoring function F is decreasing with respect to each of P⁽⁹⁾ and u P⁽¹⁰⁾. In EQ. 7, the scoring function F is constant, and thus non-increasing and non-decreasing with respect to each of P⁽¹⁾, P⁽²⁾, P⁽³⁾, P⁽⁴⁾, P⁽⁵⁾, P⁽⁶⁾, P⁽⁷⁾, P⁽⁸⁾ and the components of E and A.

As a fourth example, the scoring function F may be defined as depending on the engine efficiency P⁽¹⁾, the brake specific fuel consumption P⁽²⁾, the tailpipe exhaust NOₓ rate P⁽⁹⁾, the tailpipe exhaust HC rate P⁽¹⁰⁾ and the reductant injection rate U:

$$F ( E , A , P ) = {α}_{1} {P}^{( 1 )} + \frac{{α}_{2}}{{P}^{( 2 )}} + \frac{{α}_{3}}{{P}^{( 9 )}} + \frac{{α}_{4}}{{P}^{( 10 )}} + \frac{{α}_{5}}{U} , \qquad EQ . 8$$

where α₁, α₂, α₃, α₄ and α₅ are five positive real numbers. The engine efficiency P⁽¹⁾ is a maximizing component. The reductant injection rate U, brake specific fuel consumption P⁽²⁾, the tailpipe exhaust NOₓ rate P⁽¹⁰⁾ and tailpipe exhaust HC rate P⁽¹¹⁾ are four minimizing components. In EQ. 8, the scoring function F is increasing with respect to P⁽¹⁾ and decreasing with respect to each of U, P⁽²⁾, P⁽⁹⁾ and P⁽¹⁰⁾. In EQ. 8, the scoring function F is constant, and thus non-increasing and non-decreasing with respect to each of P⁽³⁾, P⁽⁴⁾, P⁽⁵⁾, P⁽⁶⁾, P⁽⁷⁾ and P⁽⁸⁾. It is noted that in third example engine-ATS framework from Table IV, the reductant injection rate U is an independent ATS control parameter. If the fourth example engine-ATS framework from Table V is used instead of the third example engine-ATS framework from Table IV, the reductant injection rate is an eleventh component of the performance, denoted as Û=P⁽¹¹⁾. Thus, the reductant injection rate is a dependent ATS control parameter in the fourth example engine-ATS framework from Table V. In such a scenario, a fifth example for the scoring function (603) may be defined in the same way as EQ. 8, as depending on the engine efficiency P⁽¹⁾, the brake specific fuel consumption P⁽²⁾, the tailpipe exhaust NOₓ rate P⁽⁹⁾, the tailpipe exhaust HC rate P⁽¹⁰⁾ and the reductant injection rate. However, the reductant injection rate is now p (11) and EQ. 8 becomes:

$$F ( E , A , P ) = {α}_{1} {P}^{( 1 )} + \frac{{α}_{2}}{{P}^{( 2 )}} + \frac{{α}_{3}}{{P}^{( 9 )}} + \frac{{α}_{4}}{{P}^{( 10 )}} + \frac{{α}_{5}}{\hat{U}} , \qquad EQ . 9$$

where α₁, α₂, α₃, α₄ and α₅ are five positive real numbers.

Returning to the third example engine-ATS framework from Table IV, a sixth example of a scoring function (603) that is increasing with respect to P⁽¹⁾ and decreasing with respect to each of P⁽²⁾, P⁽⁹⁾ and P⁽¹⁰⁾ is given by:

$$F ( E , A , P ) = \frac{{P}^{( 1 )}}{{α}_{1} {P}^{( 2 )} + {α}_{2} {P}^{( 9 )} + {α}_{3} {P}^{( 10 )}} , \qquad EQ . 10$$

where α₁, α₂ and α₃ are three positive real numbers. As a seventh example, the scoring function (603) may depend on all of the components of P:

$$F ( E , A , P ) = \frac{{α}_{1} {P}^{( 1 )}}{{α}_{2} {P}^{( 2 )} + {α}_{3} {P}^{( 3 )} + {α}_{4} {P}^{( 4 )} + {α}_{5} {P}^{( 5 )} + {α}_{6} {P}^{( 6 )} + {α}_{7} {P}^{( 7 )} + {α}_{8} {P}^{( 8 )} + {α}_{9} {P}^{( 9 )} + {α}_{10} {P}^{( 10 )}} , \qquad EQ . 11$$

where α₁, . . . , α₁₀ are ten positive numbers.

Generally, the engine control parameters E and independent ATS control parameters A cannot be chosen freely. Generally, the engine control parameters E and independent ATS control parameters A are restricted by the set of constraints (605). As physical quantities, the engine control parameters E and independent ATS control parameters A are usually, at least, limited by feasible ranges. For instance, in the third example engine-ATS framework from Table IV, it is understood that the average intake air temperature, in Kelvin, cannot physically be less than zero and the percentage of mass injected in the first injection cannot physically be greater than 100. Thus, denoting Tᵢₙₜ as the average intake air temperature, a first constraint may be defined as Tᵢₙₜ≥0. Denoted Fuel_mass_1 as the percentage of mass injected in the first injection, a second constraint may be defined as Fuel_mass_1≤100. Furthermore, some ranges of the engine control parameters E and independent ATS control parameters A are restricted by technical limitations. For example, in the third example engine-ATS framework from Table IV, it is understood that the average intake manifold pressure cannot be lower than a minimum limit pressure or higher than a maximum limit pressure that are tolerated by the manifold. Denoting Pint as the average intake manifold pressure,

$${P}_{int}^{min}$$

as the minimum limit pressure and

$${P}_{int}^{max}$$

as the maximum limit pressure, a third constraint may be defined as

$${P}_{int}^{min} \leq {P}_{int} \leq {P}_{int}^{max} .$$

The first, second and third constraints are independent from the operating point (203). In the embodiment of the performance model (609) presented in FIG. 6A, the set of constraints is independent from the operating point (203). However, in other embodiments, the set of constraints may depend on the operating point (203). Moreover, it is noted that the set of constraints (605) needs not restrict on all of the control parameters within the set of control parameters (204). In some embodiments, the set of constraints (605) restricts one or more, but not all of the control parameters within the set of control parameters (204).

In the embodiment of the performance model (609) described in FIG. 6B, the predicted performance score (607) is based on the predicted performance (211) by means of the auxiliary AI model (601). The set of constraints (605) is not based on the predicted performance (211). In some embodiments, some constraints within the set of constraints (605) are based on the predicted performance (211). For example, in some embodiments, the tailpipe exhaust NOₓ emission is limited by a regulation. Denoting tailpipe_NOₓ as the tailpipe exhaust NOₓ rate released by the motor assembly (100) and

$$N {O}_{x}^{max}$$

as the maximum allowed tailpipe exhaust NOₓ rate as per the regulation, a fourth constraint may be defined by tailpipe_

$$N O x \leq N {O}_{x}^{max} .$$

If the tailpipe exhaust NOₓ rate is the ninth component of the performance P, the fourth constraint reads

$${P}^{( 9 )} \leq N {O}_{x}^{max} .$$

The ninth component of the predicted performance (211) output by the first auxiliary AI model reads \hat{P}⁽⁹⁾=(M(O,E,A))⁽⁹⁾. In such scenarios, the fourth constraint

$$N O x \leq N {O}_{x}^{max}$$

may be replace by the approximate fourth constraint:

$${( M ( O , E , A ) )}^{( 9 )} \leq N {O}_{x}^{max} . \qquad EQ . 12$$

The approximate fourth constraint is based on the AI model (209). A second specific embodiment of the performance model (609) is illustrated in FIG. 6C to capture a dependency of the set of constraints (605) on the AI model (209). For concision, a full description of components and/or elements depicted in FIG. 6C is not provided anew for those components and/elements that have be previously described with reference to the preceding figures. In a similar fashion to the approximate fourth example constraint described in EQ. 12, the set of constraints (605) is based on the predicted performance (211) by means of the auxiliary AI model (601). In the embodiment of the performance model (609) described in FIG. 6C, both the predicted performance score (607) and the set of constraints (605) are based on the predicted performance (211). In some implementations, the set of constraints (605) further depends on the operating point (203), independently from the dependency of the set of constraints (605) on the predicted performance (211).

In a third specific embodiment of the performance model (609) presented in FIG. 6D, the set of constraints (605) is based on the predicted performance (211) but the predicted performance score (607) is not based on the predicted performance (211). Specific examples of a scoring function (603) and a set of constraints (605) consistent with FIG. 6C are described herein. Using the third example engine-ATS framework from Table IV as a specific example, an eighth example scoring function may be defined as

$$F ( E , A , P ) = \frac{1}{U} , \qquad EQ . 13$$

where the reductant injection rate R is an independent ATS control parameter. The set of constraints (605) may include the approximate fourth constraint from EQ. 12. In some implementations, the scoring function from EQ. 13 and approximate fourth constraint from EQ. 12 are interpreted as giving an advantage to motor assemblies with a small reductant injection rate while preserving the tailpipe exhaust NOₓ below the level imposed by the regulation.

The set of constraints (605) is written in a general form as:

$${g}_{0} ( E , A ) ∈ C , \qquad EQ . 14$$

where C is a constraint set in [symbol] , for some integer c called the constraint dimension, and gₒ is a constraint function from [symbol] × [symbol] to [symbol] , based on the operating point (203), where e denotes the number of engine control parameters and a denotes the number of independent ATS control parameters. It is noted that in some embodiments, no constraints are imposed on the set of control parameters (204). The set of constraints (605), as written in EQ. 14, allows for such scenarios, by setting, for example, C= [symbol] and gₒ(E, A)=0 for all (E, A)∈ [symbol] × [symbol] .

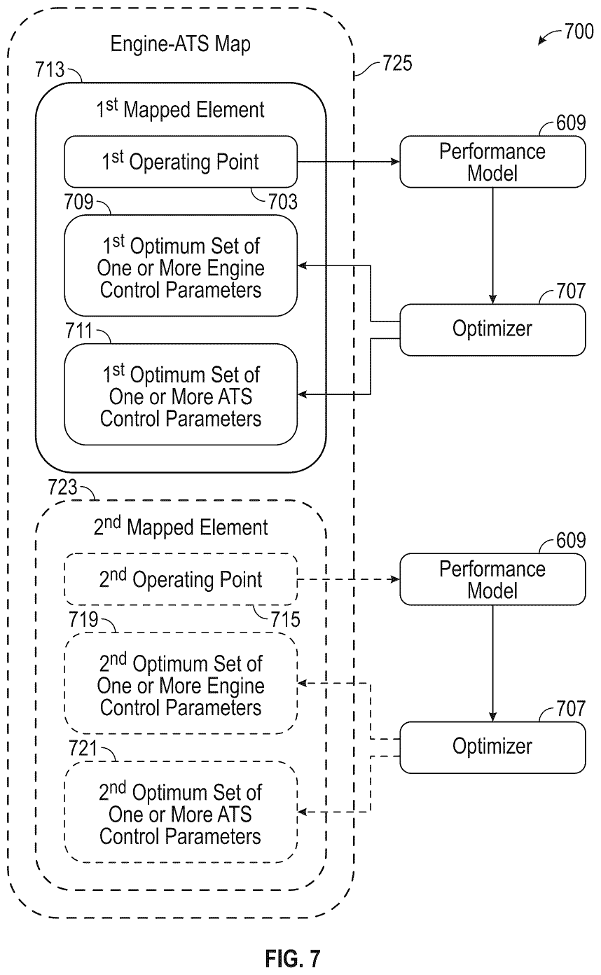

FIG. 7 depicts a calibration system (700), based on the AI model (209), for optimizing the engine control parameters and the ATS control parameters using the performance model (609). Advantageously, no experiments are needed to use the calibration system (700). A first operating point (703), denoted as 01, is received for the motor assembly. The performance model (609) is configured according to the first operating point (703). In other words, a first auxiliary AI model is formed based on the AI model (209) receiving the first operating point. The first auxiliary AI model returns a first predicted performance. The performance model (609) returns a first predicted performance score based on the first predicted performance. In some embodiments, a first set of constraints is formed and at least one of the first predicted performance score and the first set of constraints is based on the first predicted performance. The first set of constraints is written as:

$${g}_{{0}_{1}} ( E , A ) ∈ C . \qquad EQ . 15$$

The performance model (609) is optimized by an optimizer (707). The optimizer (707) can be defined in many ways. One with ordinary skill in the art will readily appreciate that a full discussion of every type of optimizer model applicable to optimizing the performance model (609) is not possible nor required to describe the optimizer (707). A few embodiments for the optimizer (707) are described herein. However, many variations of the optimizer (707) exist. Therefore, one with ordinary skill in the art will recognize that any variation of the optimizer (707) may be employed without departing from the scope of this disclosure.

As a first embodiment, the optimizer (707) is configured to determine optimum engine control parameters and optimum ATS control parameters simultaneously. In this first embodiment, the optimizer (707) is configured to form a first merit function, denoted as L₁, to be optimized. The first merit function associates the set of one or more engine control parameters (205), E, and the set of one or more independent ATS control parameters (207), A, to the first performance score, thereby denoted as L₁(E, A). A first optimum set of one or more engine control parameters (709) and a first optimum set of one or more independent ATS control parameters are computed as a set E and a set A, respectively, that optimize the first merit function subject to the first set of constraints. Specifically, the first optimum set of one or more engine control parameters (709) and first optimum set of one or more independent ATS control parameters are computed by seeking a set E and a set A, satisfying the first set of constraints, such that the performance score L₁(E, A), is as high as possible in a sense defined below.

The first optimum set of one or more engine control parameters (709), denoted as Ê₁, and the first optimum set of one or more independent ATS control parameters, denoted as Â₁, are determined by operating the optimizer (707). In the first embodiment, the optimizer (707) is configured to seek a solution

$$( {E}_{1}^{⋆} , {A}_{1}^{⋆} )$$

to the following maximization problem:

$$find ( {E}_{1}^{★} , {A}_{1}^{★} ) ∈ {ℝ}^{e} \times {ℝ}^{a} such that {g}_{{O}_{1}} ( {E}_{1}^{★} , {A}_{1}^{★} ) ∈ C and \qquad EQ . 16$$

$$for all ( E , A ) ∈ {ℝ}^{e} \times {ℝ}^{a} such that {g}_{{O}_{1}} ( E , A ) ∈ C , {L}_{1} ( {E}_{1}^{★} , {A}_{1}^{★} ) \geq {L}_{1} ( E , A ) .$$

It is noted that the maximization problem in EQ. 16 may be re-formulated as a minimization problem without departing from the scope of this disclosure. Finding parameters

$$( {E}_{1}^{⋆} , {A}_{1}^{⋆} )$$

that satisfy EQ. 16 is only possible in rare cases. For instance, finding

$$( {E}_{1}^{⋆} , {A}_{1}^{⋆} )$$

that satisfies EQ. 16 is possible in cases where the equation ∇_{E,A}L₁(E, A)=0 can be solved for (E, A), and it can be shown that at least one solution, denoted by

$$( {E}_{1}^{⋆} , {A}_{1}^{⋆} ) ,$$

satisfying

$${∇}_{E , A} {L}_{1} ( {E}_{1}^{★} , {A}_{1}^{★} ) = 0 ,$$

also satisfies EQ. 16. The notation ∇_{E,A}L₁ stands for the gradient of L₁ with respect to the variables (E, A). In such scenarios, the first optimum set of one or more engine control parameters (709) and first optimum set of one or more independent ATS control parameters, (Ê₁, Â₁), are set to

$$( {E}_{1}^{★} , {A}_{1}^{★} )$$

and the optimizer (707) is configured to compute ∇_{E,A}L₁(E, A), solve the equation ∇_{E,A}L₁(E, A)=0, and select

$$( {E}_{1}^{★} , {A}_{1}^{★} )$$

satisfying EQ. 16, among the solutions to the equation ∇_{E,A}L₁(E, A)=0.

Generally, the optimization problem in EQ. 16 is solved in an approximate sense and the optimizer (707) is configured to iterate an algorithm until a certain stopping criterion is met. Given initial control parameters (E, A)⁰∈ [symbol] × [symbol] satisfying the first set of constraints gₒ_{₁}((E, A)⁰)∈C, the optimizer (707) produces a recurrent sequence of control parameters (E, A)^{q}∈ [symbol] × [symbol] , indexed by an iteration number q≥1. The recurrent sequence (E, A)^{q} is produced as satisfying the first set of constraints gₒ_{₁}((E, A)^{q})∈C and such that (E, A)_{q} only depends, at most, on the values of the control parameters (E, A)^{s}, for s<q. In one or more embodiments, the initial control parameters (E, A)⁰ are defined randomly. In one or more embodiments, the optimizer (707) is defined such that the control parameters (E, A)^{q}, at each iteration q, only depend on the values at the previous iteration, (E, A)^{q-1}. Intuitively, the goal of the optimizer (707) is that the merit function L₁, applied to one of the terms of the sequence (E, A)^{q} at an iteration q*, namely, L₁((E, A)^{q}*) be as large as possible. Note that if the maximization problem in EQ. 16 were re-formulated as a minimization problem, the optimizer (707) would be configured to build the sequence (E, A)^{q} such that the merit function L₁, applied to one of the terms of the sequence (E, A)^{q}, be as small as possible. In one or more embodiments, the optimizer (707) is defined such that the sequence L₁((E, A)^{q}) is an increasing sequence and then, iterating the optimizer (707) always produces control parameters (E, A)^{q} associated with a larger iterated performance score, L₁((E, A)^{q}), than the previous iterated performance score, L₁((E, A)^{q-1}). The optimizer (707) runs for a certain number of iterations, Q≥1, called the maximum iteration number. In one or more embodiments, the maximum iteration number Q is pre-defined and the stopping criterion for the optimizer (707) is that the iteration number q reaches the pre-defined maximum iteration number Q. The stopping criterion for the optimizer (707) can be defined in many other ways. In some embodiments, the stopping criterion consists of noting that the distance |L₁((E, A)^{q})−L₁((E, A)^{q-1})| is less than a predefined convergence threshold for a certain q≥1. If the stopping criterion is met at a certain iteration, the optimizer (707) is said to have converged, and the iterative process stops.

Regardless of the definition of the stopping criterion, the maximum iteration number is reached when the stopping criterion is met, and may be denoted as Q. After the optimizer (707) has stopped, the optimum sets of engine and independent ATS control parameters (Ê₁, Â₁) can be defined in many ways. In some embodiments, the optimum sets of engine and independent ATS control parameters are defined as (Ê₁, Â₁)=(E, A)^{Q}, that is, the last value obtained by the optimizer (707) when the stopping criterion is met. In other embodiments, the optimum sets of engine and independent ATS control parameters are defined as (Ê₁, Â₁)=(E, A)^{q}*, for some integer q* such that 0≤q*≤Q, that minimizes the merit function in the following sense:

$$for all q such that 0 \leq q \leq Q , {L}_{1} ( {( E , A )}^{{q}^{★}} ) \geq {L}_{1} ( {( E , A )}^{q} ) . \qquad EQ . 17$$

Defining the sequence (E, A)^{q} can be done using various methods known in the art of solving constrained optimization problems. Examples of such methods include, but are not limited to, a simplex method, an interior point method, a Lagrange multipliers method, a branch and bound method, and a generalized reduced gradient (GRG) method. As an example, the generalized reduced gradient (GRG) method defines the sequence (E, A)^{q} as

$${( E , A )}^{q + 1} = {( E , A )}^{q} - α ( {∇}_{E , A} {L}_{1} ( {( E , A )}^{q} ) - {V}^{q} ) . \qquad EQ . 18$$

In EQ. 18, α is a step size and V^{q} is reduction vector that forces the update (E, A)^{q+1} to satisfy the first set of constraints gₒ_{₁}((E, A)^{q+1})∈C. The gradient ∇_{E,A}L₁((E, A)^{q}) indicates the direction of change for the control parameters values (E, A)^{q}, that results in the greatest change to the merit function L₁.

In other embodiments, the terms (E, A)^{q} are defined arbitrarily on a regular grid and the criterion from EQ. 18 is used to select optimum sets of engine and independent ATS control parameters. In such scenarios, the optimizer (707) is said to use a grid search algorithm. In other embodiments, the terms (E, A)^{q} are defined randomly on a regular grid and the criterion from EQ. 18 is used to select optimum sets of engine and independent ATS control parameters. In such scenarios, the optimizer (707) is said to use a random search algorithm. In other embodiments, each term (E, A)^{q+1} is constructed based on an analysis of the predicted performance scores at the previous two iterations, L₁((E, A)^{q}) and L₁((E, A)^{q-1}). In such scenarios, the optimizer (707) is said to use a feedback loop.

As stated, in some implementations, the ATS control parameters are composed of the independent control parameters. In such implementations, the first optimum set of one or more independent ATS control parameters forms a first optimum set of one or more ATS control parameters (711). In other implementations, the ATS control parameters further include dependent ATS control parameters. The dependent control parameters may be predicted by the AI model (209) upon receiving, as inputs, an operating point, a set of one or more engine control parameters and a set of one or more independent ATS control parameters. In such implementations, the optimizer (707) is further configured to compute a first optimum predicted performance for the motor assembly. The first optimum predicted performance is obtained as an output of the AI model (209) upon receiving, as inputs, the operating point (203), the first optimum set of one or more engine control parameters (709) and the first optimum set of one or more independent ATS control parameters. A first optimum set of one or more dependent ATS control parameters is then extracted from the first optimum predicted performance. The first optimum set of one or more independent ATS control parameters and the first optimum set of one or more dependent ATS control parameters form the first optimum set of one or more ATS control parameters (711).

In one or more embodiments, the motor assembly is operated under the first operating point (703). In response to the first operating point (703), the engine control parameters are adjusted based on the first optimum set of one or more engine control parameters (709). In response to the first operating point (703), the ATS control parameters are adjusted based on the first optimum set of one or more ATS control parameters (711). In some implementations, the engine control parameters are adjusted to be equal to the first optimum set of one or more engine control parameters (709). In some implementations, the ATS control parameters are adjusted to be equal to the first optimum set of one or more ATS control parameters (711). In some implementations, the adjustments to the engine control parameters and the ATS control parameters are made by an ECU. In some implementations, the first optimum set of one or more engine control parameters (709) and the first optimum set of one or more ATS control parameters (711) are computed in real-time upon receiving the first operating point (703). In such implementations, the real-time computation of the first optimum set of one or more engine control parameters (709) and the first optimum set of one or more ATS control parameters (711) may be performed by the onboard computer or by a remote computer located in a remote facility.

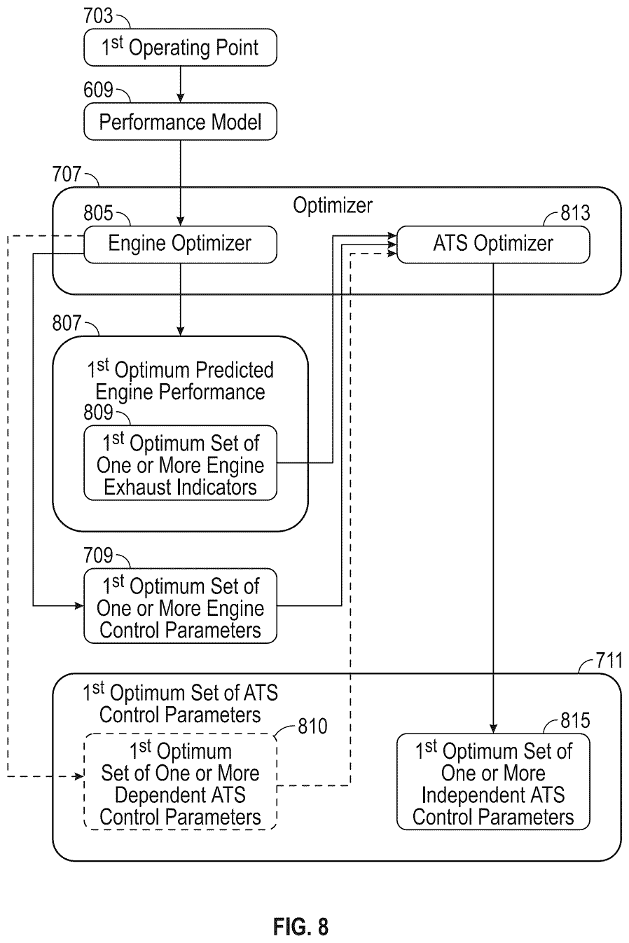

FIG. 8 depicts a second embodiment of the optimizer (707). In this second embodiment, the optimum engine control parameters and optimum ATS control parameters are determined sequentially. For brevity, a full description of components and/or elements depicted in FIG. 8 is not provided anew for those components and/or elements that have been previously described with reference to the preceding figures. In FIG. 8, the engine control parameters are optimized first, regardless of the ATS. Then, the ATS control parameters are optimized using results from the optimization of the engine control parameters. In FIG. 8, the AI model (209) includes the two stages as presented in FIG. 2. As such, the AI model (209) includes the engine AI model (303), denoted as M_{E}, and the ATS AI model (305), denoted as M_{A}. The engine AI model (303) may also include multiple stages, as presented in FIG. 4. The performance includes the engine performance, denoted as P_{E}, and the ATS performance, denoted as P_{A}, so that the performance P may be written as (P_{E}, P_{A}). The engine AI model (303) receives, as inputs, the operating point (203), denoted as O, and a set of one or more engine control parameters (205), denoted as E. The engine AI model (303) returns, as output, the predicted engine performance (307), denoted as P_{E}=M_{E} (O, E). The predicted engine performance (307) includes the set of one or more predicted engine exhaust indicators (309), denoted as Î. The ATS AI model (305) receives, as inputs, the set of one or more engine control parameters (205), the set of one or more independent ATS control parameters (207), denoted as A, and the set of one or more predicted engine exhaust indicators (309). The ATS AI model (305) returns, as output, the predicted ATS performance (311), denoted as \hat{P}_{A}=M_{A} (E, A, Î). In embodiments where the ATS control parameters include dependent ATS control parameters, denoted as D, the engine AI model further outputs a set of one or more predicted dependent ATS control parameters, denoted as \hat{D}. In such embodiments, the predicted ATS performance (311) is written as M_{A} (E, A, Î, \hat{D}).

The scoring function F can always be written as a sum of an engine scoring function F_{E} and an ATS scoring function F_{A} configured as follows. The engine scoring function receives the set of one or more engine control parameters (205) and the engine performance P_{E} as inputs. The engine scoring function F_{E} returns, as output, an engine performance score F_{E}(E, P_{E}). The ATS scoring function, receives, as inputs, the set of one or more engine control parameters (205), the set of one or more independent ATS control parameters (207), the engine performance and the ATS performance. The ATS scoring function returns, as output, an ATS performance score F_{A}(E, A, P_{E}, P_{A}), so that:

$$F ( E , A , P ) = {F}_{E} ( E , {P}_{E} ) + {F}_{A} ( E , A , {P}_{E} , {P}_{A} ) . \qquad EQ . 19$$

The engine scoring function F_{E} needs not depend on all the components of the variables E and P_{E}. The engine scoring function F_{E} may, in accordance with some embodiments, select out one or more components of the variables E and P_{E}. In a similar fashion, the ATS scoring function F_{A} needs not depend on all the components of the variables E, A, P_{E} and P_{A}. The scoring function F_{A} may, in accordance with some embodiments, select out one or more components of the variables E, A, P_{E} and P_{A}.

The variables of the engine performance P_{E} and ATS performance P_{A} may each include one or more minimizing components, one or more maximizing components, or both. The engine scoring function F_{E} is non-decreasing with respect to its maximizing variables, non-increasing with respect to its minimizing variables, and satisfying at least one of the following properties a) and b): a) the engine scoring function F_{E} is increasing with respect to at least one of its maximizing variables; b) the engine scoring function F_{E} is decreasing with respect to at least one of its minimizing variables. The ATS scoring function F_{A} is non-decreasing with respect to the maximizing variables included in A and P_{A}, non-increasing with respect to the minimizing variables included in A and P_{A} and satisfies at least one of the following properties a) and b): a) the ATS scoring function F_{A} is increasing with respect to at least one of the maximizing variables included in A and P_{A}; b) the ATS scoring function F_{A} is decreasing with respect to at least one of the minimizing variables included in A and P_{A}. No assumption needs to be made on the monotonicity of F_{A} with respect to E and P_{E}. In one or more embodiments, the ATS scoring function F_{A} only depends on the independent ATS control parameters and ATS performance P_{A}. In such embodiments, the scoring function F may be written as

$$F ( E , A , P ) = {F}_{E} ( E , {P}_{E} ) + {F}_{A} ( A , {P}_{A} ) . \qquad EQ . 20$$

A specific example of EQ. 20 is given by the fourth example scoring function from EQ. 8. The fourth example scoring function from EQ. 8 may be written as EQ. 20 with F_{E}(E, P_{E})=α₁P⁽¹⁾ and

$${F}_{A} ( A , {P}_{A} ) = \frac{{α}_{2}}{{P}^{( 2 )}} + \frac{{α}_{3}}{{P}^{( 9 )}} + \frac{{α}_{4}}{{P}^{( 10 )}} + \frac{{α}_{5}}{U} .$$

The first set of constraints can always be written as a set composed of a first set of engine constraints and a first set of ATS constraints:

$${g}_{{O}_{1}}^{E} ( E ) ∈ {C}_{E} and {g}_{{O}_{1}}^{A} ( E , A ) ∈ {C}_{A} , \qquad EQ . 21$$

where C_{E} is an engine constraint set in [symbol] , for some integer c_{E} called the engine constraint dimension, C_{A} is an ATS constraint set in [symbol] , for some integer c_{A} called the ATS constraint dimension,

$${g}_{{O}_{1}}^{E}$$

is a must engine constraint function from [symbol] to [symbol] and

$${g}_{{O}_{1}}^{A}$$

is a first ATS constraint function from [symbol] × [symbol] to [symbol] . In implementations where no constraints are imposed on the engine control parameters, EQ. 21 is still consistent with EQ. 15 by setting C_{E}= [symbol] , C_{A}=C,

$${g}_{{O}_{1}}^{A} = {g}_{{O}_{1}}$$

and defining

$${g}_{{O}_{1}}^{E} as {g}_{{O}_{1}}^{E} ( E ) = 0.$$

The second embodiment of the optimizer (707) operates in two steps. In a first step, the engine control parameters are optimized based on a first predicted engine performance score, thereby generating optimum engine control parameters. In a second step, the ATS control parameters are optimized based on a first predicted ATS performance score and the optimum engine control parameters. The first predicted engine performance score is defined as F_{E}(E, \hat{P}_{E}). Returning to FIG. 8, the optimizer (707) includes an engine optimizer (805), configured to form a first engine merit function, denoted as

$${L}_{1}^{E} .$$

The first engine merit function receives, as input, the set of one or more engine control parameters (705) and returns, as output, the first predicted engine performance score. The engine optimizer (805) is configured to determine the first optimum set of one or more engine control parameters (709), denoted as Ê₁, by seeking a solution

$${E}_{1}^{★}$$

to the following maximization problem:

$$find {E}_{1}^{★} ∈ {ℝ}^{e} such that {g}_{{O}_{1}}^{E} ( {E}_{1}^{★} ) ∈ {C}_{E} and \qquad EQ . 22$$

$$for all E ∈ {ℝ}^{e} such that {g}_{{O}_{1}}^{E} ( E ) ∈ {C}_{E} , {L}_{1}^{E} ( {E}_{1}^{★} ) \geq {L}_{1}^{E} ( E ) .$$

It is noted that the maximization problem in EQ. 22 may be re-formulated as a minimization problem without departing from the scope of this disclosure. The engine optimizer (805) operates in a similar fashion to the first embodiment of the optimizer (707). The engine optimizer (805) may include any method known in the art of constrained optimization, such as, for example, a simplex method, an interior point method, a Lagrange multipliers method, a branch and bound method, a generalized reduced gradient method, a grid search, a random search and a feedback loop. A first optimum predicted engine performance (807), denoted as

$${\hat{P}}_{1}^{E} ,$$

is defined by inputting, to the engine AI model (303), the first operating point (703) and the first optimum set of one or more engine control parameters (709):

$${\hat{P}}_{1}^{E} = {M}_{E} ( {O}_{1} , {\hat{E}}_{1} ) . \qquad EQ . 23$$

The first optimum predicted engine performance (807) includes a set of one or more predicted engine exhaust indicators, called a first optimum set of one or more engine exhaust indicators (809) and denoted as Î₁. In embodiments where the ATS control parameters include dependent ATS control parameters, the first optimum predicted engine performance (807) further includes the first optimum set of one or more dependent ATS control parameters (810), denoted as \hat{D}₁.

After the engine control parameters have been optimized, the independent ATS control parameters are optimized using the first optimum set of one or more engine control parameters (709), Ê₁, and the first optimum set of one or more engine exhaust indicators (809) Î₁. In that respect, the optimizer (707) further includes an ATS optimizer (813). The ATS optimizer (813) is configured to form a first ATS merit function, denoted as

$${L}_{1}^{A} .$$

The first ATS merit function receives, as inputs, the set of one or more independent ATS control parameters (207) and returns, as output, the first predicted ATS performance score defined as:

$${L}_{1}^{A} ( A ) = {F}_{A} ( {\hat{E}}_{1} , A , {\hat{P}}_{1}^{E} , {M}_{A} ( {\hat{E}}_{1} , A , {\hat{I}}_{1} ) ) . \qquad EQ . 24$$

In embodiments where the ATS control parameters include dependent ATS control parameters the first ATS merit function reads:

$${L}_{1}^{A} ( A ) = {F}_{A} ( {\hat{E}}_{1} , A , {\hat{P}}_{1}^{E} , {M}_{A} ( {\hat{E}}_{1} , A , {\hat{I}}_{1} , {\hat{D}}_{1} ) ) . \qquad EQ . 25$$

The ATS optimizer (813) is configured to determine the first optimum set of one or more independent ATS control parameters (815), denoted as Â₁, by seeking a solution

$${A}_{1}^{★}$$

to the following maximization problem:

$$find {A}_{1}^{★} ∈ {ℝ}^{a} such that {g}_{{O}_{1}}^{A} ( {\hat{E}}_{1} , {A}_{1}^{★} ) ∈ {C}_{A} and for all A ∈ {ℝ}^{a} such that {g}_{{O}_{1}}^{A} ( {\hat{E}}_{1} , A ) ∈ {C}_{A} , {L}_{1}^{A} ( {A}_{1}^{★} ) \geq {L}_{1}^{A} ( A ) . \qquad EQ . 26$$

It is noted that the maximization problem in EQ. 26 may be re-formulated as a minimization problem without departing from the scope of this disclosure.

In EQ. 26, it is noted that the constraint

$${g}_{{O}_{1}}^{A} ( {\hat{E}}_{1} , A ) ∈ {C}_{A}$$

is obtained by using the first optimum set of one or more engine control parameters (709), Ê₁, in the set of ATS constraint

$${g}_{1}^{A} ( E , A ) ∈ {C}_{A}$$

from EQ. 21. In ATS optimizer (813) operates in a similar fashion to the first embodiment of the optimizer (707). The ATS optimizer (813) may include any method known in the art of constrained optimization, such as, for example, a simplex method, an interior point method, a Lagrange multipliers method, a branch and bound method, a generalized reduced gradient method, a grid search, a random search and a feedback loop.

Returning to FIG. 7, the first operating point (703), the first optimum set of one or more engine control parameters (709) and the first optimum set of one or more ATS control parameters (711) may form a first mapped element (713), in accordance with one or more embodiments. The process of obtaining the first mapped element (713) may be repeated for a second operating point (715), denoted as O₂. As such, the performance model (609) is configured based on the second operating point (715). The performance model (609) is configured to return a second predicted performance score based on the AI model (209) receiving the second operating point (715). In the embodiments described in FIGS. 6B-6D, a second auxiliary AI model is formed by inputting the second operating point (715) to the AI model (209). The second auxiliary model returns a second predicted performance. In the embodiments described in FIGS. 6B-6D, a second set of constraints is formed. At least one of the second predicted performance score and the second set of constraints is based on the second predicted performance. A second optimum set of one or more engine control parameters (719) and a second optimum set of one or more ATS control parameters (721) are determined as optimizing the second predicted performance score. The second optimum set of one or more engine control parameters (719) and the second optimum set of one or more ATS control parameters (721) are determined in a similar manner to the first optimum set of one or more engine control parameters (709) and the first optimum set of one or more ATS control parameters (711). The second optimum set of one or more engine control parameters (719) and the second optimum set of one or more ATS control parameters (721) are determined using the optimizer (707). The second operating point (715), the second optimum set of one or more engine control parameters (719) and the second optimum set of one or more ATS control parameters (721) form a second mapped element (723).

Generally, the process of obtaining the first mapped element (713) may be conducted for N>1 operating points, denoted as Oₙ, for n∈[1, N]. As such, for each n∈[1, N], the performance model (609) may be configured based on the n^{th} operating point. The performance model (609) may be configured to return an n^{th} predicted performance score based on the AI model (209) receiving the n^{th} operating point. An n^{th} optimum set of one or more engine control parameters and an n^{th} optimum set of one or more ATS control parameters are determined as optimizing the n^{th} predicted performance score. The n^{th} optimum set of one or more engine control parameters and the n^{th} optimum set of one or more ATS control parameters are determined in a similar manner to the first optimum set of one or more engine control parameters (709) and the first optimum set of one or more ATS control parameters (711). The n^{th} optimum set of one or more engine control parameters and the n^{th}optimum set of one or more ATS control parameters are determined using the optimizer (707). The n^{th} operating point, the n^{th} optimum set of one or more engine control parameters and the n^{th} optimum set of one or more independent ATS control parameters form a n^{th} mapped element.

The resulting N>1 mapped elements, including, at least, the first mapped element (713), form an engine-ATS map (725). The N>1 operating points constitute the entries to the engine-ATS map (725). The N>1 optimum sets of engine control parameters and N>1 optimum sets of independent ATS control parameters constitute the values of the engine-ATS map (725). In some embodiments, the engine-ATS map (725) is uploaded to an ECU. Then, upon receiving an operating point from a user of the motor assembly, the ECU sets the engine control parameters and the independent ATS control parameters based on the operating point and the engine-ATS map (725). As stated in previous paragraphs of this disclosure, if the operating point corresponds exactly to an entry of the engine-ATS map (725), the ECU sets the engine control parameters and the independent ATS control parameters to the values indicated by the engine-ATS map (725) at the entry corresponding to the operating point. If the operating point does not correspond to an entry of the engine-ATS map (725), the ECU may interpolate several values of the engine-ATS map (725) in order to set the engine control parameters and the independent ATS control parameters. As stated in previous paragraphs of this disclosure, the AI model (209) may be fine-tuned during the life of a motor vehicle on which the motor assembly is installed. Fine-tuning the AI model (209) results in an updated AI model. The updated AI model may override the AI model (209) and as such, become the AI model (209). After the AI model (209) is fine-tuned, the calibration system (700) may be used anew to recompute some, or all of the mapped elements of the engine-ATS map (725). Recomputing some mapped elements of the engine-ATS map (725) results in an updated engine-ATS map. The updated engine-ATS map (725) overrides the engine-ATS map (725) and becomes the engine-ATS map (725).

In one or more embodiments, the AI model (209) is fine-tuned periodically and the engine-ATS map (725) is updated periodically. Advantageously, updating the engine-ATS map (725) periodically accounts for changes of the driving conditions described in previous paragraphs of this disclosure, such as the aging of the components of the motor vehicle and driving habits of a driver of the motor vehicle. Advantageously, updating the engine-ATS map (725) periodically may be seen as maintaining the performance score of the engine-ATS optimum throughout the life of the motor vehicle. In one or more embodiments, the AI model (209) is hosted, run and fine-tuned on the previously described onboard computer. In one or more embodiments, updates of the engine-ATS map (725), using the calibration system (700), are also carried out on the onboard computer, without the need for any external resources or communication system.

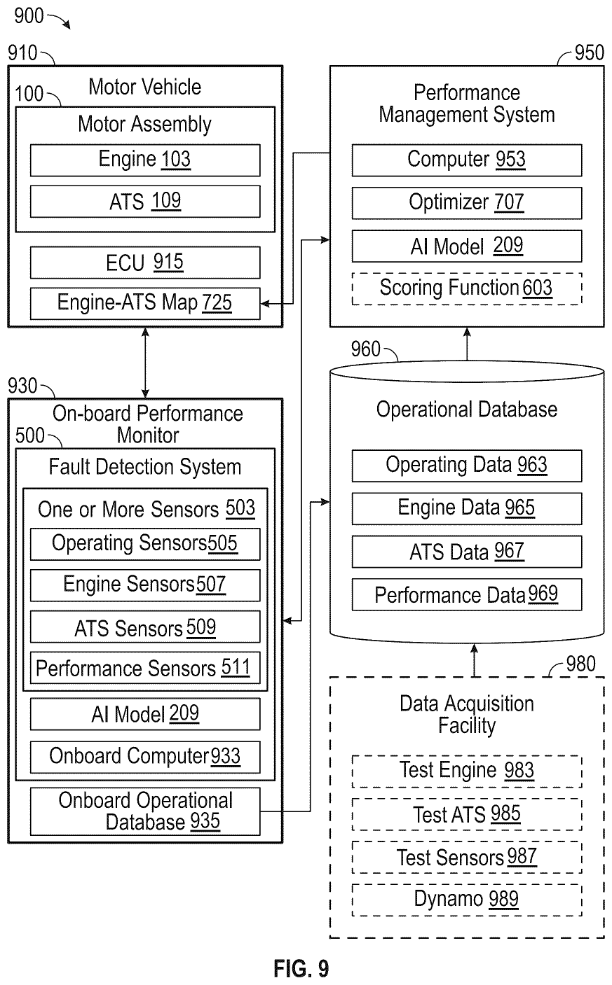

The block diagram in FIG. 9 depicts a system (900) for optimizing and monitoring the performance of a motor assembly. For brevity, a full description of components and/or elements depicted in FIG. 9 is not provided anew for those components and/or elements that have been previously described with reference to the preceding figures. The system (900) includes a motor vehicle (910), an onboard performance monitor (930), a performance management system (950) and an operational database (960). The motor vehicle (910) includes the engine (103) and the ATS (109), assembled as a motor assembly (100) as described in FIG. 1. The motor vehicle (910) includes an ECU (915) and an engine-ATS map (725). The ECU (915) selects engine control parameters and ATS control parameters based on the engine-ATS map (725). By setting the engine control parameters and ATS control parameters, the ECU (915) commands the engine (103) and the ATS (109) to operate according to an operating point requested by a driver of the motor vehicle (910).

The onboard performance monitor (930) includes the fault detection system (500) described in FIG. 5. The fault detection system (500) includes the one or more sensors (503), connected to the motor vehicle (910). The one or more sensors (503) include, as presented FIG. 5, the operating sensors (505), the engine sensors (507), the ATS sensors (509) and the performance sensors (511). The operating sensors (505), the engine sensors (507) and the ATS sensors (509) are configured to acquire, respectively, a first onboard operating point (513), a first onboard set of one or more engine control parameters (515) and a first onboard set of one or more independent ATS control parameters (517) at a certain instant during the motor vehicle's operation. The performance sensors (511) are configured to capture, at the same instant, a first onboard performance (519) of the motor assembly (100). The fault detection system (500) further includes the AI model (209), as described by the embodiments in FIGS. 2, 3 and 4, configured to compute an a first predicted onboard performance (521) using the first onboard operating point (513), first onboard set of one or more engine control parameters (515) and first onboard set of one or more independent ATS control parameters (517) as inputs. The AI model (209) is hosted and run on an onboard computer (933). The fault detection system (500) is configured to compare the first predicted onboard performance (521) and the first onboard performance (519). The fault detection system (500) to make a determination (525) whether a fault is suspected in the motor vehicle (910). The determination (525) is based on a pre-defined fault detection threshold (523).

As previously described, the one or more sensors (503) acquire onboard training data samples at a plurality of distinct instants while the motor vehicle (910) is being operated. Each onboard training data sample, acquired at a distinct instant, includes an onboard training input and an onboard training output. The onboard training input includes, at least, an onboard operating point acquired by the operating sensors (505), an onboard set of one or more engine control parameters acquired by the engine sensors (507) and an onboard set of one or more independent ATS control parameters acquired by the ATS sensors (509) at that distinct instant. The onboard training output includes an onboard performance acquired by the performance sensors (511) at that distinct instant. In implementations where the ATS control parameters include dependent ATS control parameters, the onboard training input further includes components from the onboard performance. In such scenarios, the components of the onboard performance that serve as dependent ATS control parameters are both part of the onboard training input and onboard training output. The onboard training data samples form an onboard operational database (935), stored on the onboard computer (933). The AI model (209) is fine-tuned, on the onboard computer (933), using the onboard training data samples from the onboard operational database (935).

The performance management system (950) includes a copy of the AI model (209). The AI model (209) is hosted and run on a computer (953). The AI model is further trained and tested on the computer (953), using data samples from the operational database (960). The performance management system (950) further includes the optimizer (707), described in FIGS. 7 and 8. The optimizer (707) is configured to compute optimum engine control parameters and optimum ATS control parameters that optimize a predicted performance score of the motor assembly (100) for each of N≥1 operating points. If N>1, the N operating points, optimum engine control parameters and optimum ATS control parameters form N>1 mapped elements that populate the engine-ATS map (725). The optimizer (707) runs on the computer (953). For each n≤N, the optimizer is configured to optimize a n^{th} predicted performance score based on the AI model (209) receiving the n^{th} operating point. The n^{th} predicted performance score is output by the performance model (609) configured according to the n^{th} operating point. Embodiments for the performance model (609) are depicted in FIGS. 6A-6D. In the embodiments in FIGS. 6B-6D, the performance model (609) includes the scoring function (603). Specific examples of the scoring function (603) are given by EQs. 5-11 and 13.

The performance management system (950) may be located in a remote facility or in the motor vehicle (910), or both. The computer system is, or includes, the set composed of the computer (953) and the onboard computer (933). In embodiments where the performance management system (950) is located in the motor vehicle (910), the computer (953) and the onboard computer (933) may be the same machine. In the remote facility, the computer (953) is a remote computer, that may be configured to release more computing power than the onboard computer (933). Thus, in some embodiments, the AI model (209) is pre-trained on the computer (953) and fine-tuned on the onboard computer (933). Fine-tuning the AI model (209) results in an updated AI model that overrides and becomes the AI model (209) on the onboard computer (933). In such embodiments, the updated, fine-tuned AI model is uploaded to the remote facility to also override and become the AI model (209) in the remote facility.

In one or more embodiments, the AI model (209) is fine-tuned periodically and the engine-ATS map (725) is updated periodically using the optimizer (707). Advantageously, updating the engine-ATS map (725) periodically accounts for changes of the driving conditions described in previous paragraphs of this disclosure, such as the aging of the components of the motor vehicle and driving habits of a driver of the motor vehicle. Fine-tuning the AI model (209) and updating the engine-ATS map (725) periodically may limit the degradation of the vehicle's performance during its lifetime.

The operational database (960) includes operating data (963), engine data (965), ATS data (967) and performance data (969), from which data samples are extracted to train and test the AI model (209). The operating data (963) include values of operating points. The engine data (965) include values of the one or more engine control parameters. The ATS data (967) include values of one or more ATS control parameters. The performance data (969) include values of the performance. In one or more embodiments, the data in the operational database (960) are acquired from experiments run in a data acquisition facility (980). As previously described, the data acquisition facility (980) includes a test engine (983), a test ATS (985), test sensors (987) and a dynamometer (989). The data acquisition facility (980) may include other components not displayed in FIG. 9, such as a throttle valve. In one or more embodiments, the onboard training data samples from the onboard operational database (935) are appended to the operational database (960) so that the number of data samples of the operational database (960) is increased for future use.

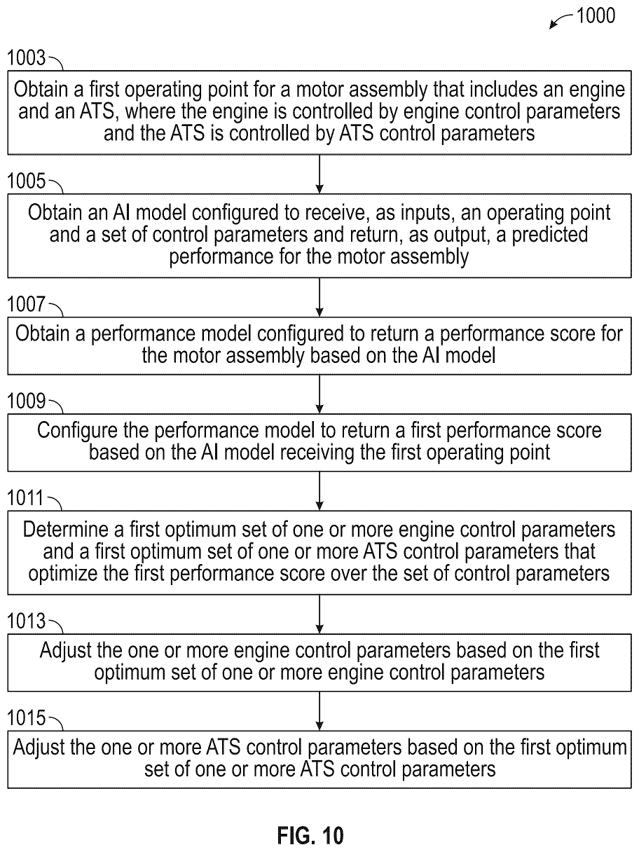

The flowchart in FIG. 10 depicts a method (1000) for adjusting engine control parameters and ATS control parameters based on artificial intelligence (AI). For brevity, a full description of components and/or elements depicted in FIG. 10 is not provided anew for those components and/or elements that have been previously described with reference to the preceding figures. In Step 1003, a first operating point is obtained for a motor assembly. The motor assembly includes an engine and an after-treatment system (ATS), such as the engine (103) and the ATS (109) in FIG. 1. The engine and ATS form a motor assembly, such as the motor assembly (100) in FIG. 1. The engine is controlled by one or more engine control parameters in response to an operating point. The ATS is controlled by one or more ATS control parameters in response to an exhaust from the engine. The one or more ATS control parameters include one or more independent ATS control parameters. Examples of components for an operating point and the first operating point include at most two of a throttle opening, an engine speed and an engine load. Examples of engine control parameters include, but are not limited to, an indicated mean effective pressure, an exhaust gas recirculation rate, an average intake air temperature, a fuel rail pressure, a start of first fuel injection, a start of second fuel injection, an average intake manifold pressure, a total mass of fuel injection and a percentage of mass injected in first injection. Examples of ATS control parameters include, but are not limited to, a reductant injection rate, and an intake temperature for each component of the ATS.

An AI model is obtained in Step 1005. The AI model is configured in a similar fashion to the AI model (209) in FIG. 2. In one or more embodiment, the AI model in Step 1005 includes a super learner model. The AI model is configured to receive, as input, an operating point, a set of one or more engine control parameters and a set of one or more independent ATS control parameters. The set of one or more engine control parameters and a set of one or more independent ATS control parameters form a set of control parameters. The AI model in Step 1003 is configured to return, as output, a predicted performance for the motor assembly. The predicted performance attempts to predict a performance of the motor assembly. The performance includes one or more components. In some embodiments, the performance includes one or more components in the set composed of: a brake specific fuel consumption, an engine exhaust NOₓ rate, an engine exhaust HC rate, a volume of engine smoke, an engine noise level, an engine exhaust gas temperature, an engine exhaust flow rate, an engine efficiency, an engine power, a reductant injection rate requirement, a tailpipe exhaust NOₓ rate and a tailpipe exhaust HC rate. The predicted performance includes one component for each of the one or more components of the performance. In some embodiments, some components of the performance, such as the reductant injection rate, are also ATS control parameters. The ATS control parameters that are also components of the performance depend on other engine or ATS control parameters. The ATS control parameters that are also components of the performance are called dependent ATS control parameters. By contrast, the ATS control parameters that are not components of the performance are called independent ATS control parameters. The dependent ATS control parameters and independent ATS control parameters form the ATS control parameters.

In one or more embodiments, the AI model in Step 1005 includes multiple stages, such as the configuration in FIG. 3. For instance, the AI model may include an engine AI model and an ATS engine model connected sequentially. In such embodiments, the performance includes an engine performance and an ATS performance. The engine performance may include one or more components, such as, for example, the brake specific fuel consumption, engine exhaust NOₓ rate, engine exhaust HC rate, volume of engine smoke, engine noise level, engine exhaust gas temperature, engine exhaust flow rate, engine efficiency and engine power. The engine performance includes a set of one or more engine exhaust indicators such as, for example, the brake specific fuel consumption, engine exhaust NOₓ rate, engine exhaust HC rate, engine exhaust gas temperature and engine exhaust flow rate. The predicted ATS performance includes one or more components, such as, for example, the tailpipe exhaust NOₓ rate and tailpipe exhaust HC rate. The predicted performance includes a predicted engine performance that attempts to predict the engine performance and a predicted ATS performance that attempts to predict the ATS performance. The engine AI model receives, as input, an operating point and a set of one or more engine control parameters and returns, as output, the predicted engine performance. The predicted performance includes a set of one or more predicted engine exhaust indicators that attempt to predict the one or more engine exhaust indicators. The ATS AI model receives, as inputs, the set of one or more engine control parameters, the set of one or more independent ATS control parameters, and the set of one or more predicted engine exhaust indicators. The ATS AI model returns, as output, the predicted ATS performance. In embodiments where the ATS control parameters include dependent ATS control parameters, the engine AI model further outputs a set of one or more predicted dependent ATS control parameters. The set of one or more predicted dependent ATS control parameters is sent as an additional output to the ATS AI model.

In further embodiments, the engine AI model includes two stages as described in FIG. 4. In such embodiments, the engine AI model includes an engine performance AI model and a reductant AI model. The engine performance AI model returns the predicted engine performance that includes set of one or more predicted engine exhaust indicators. The reductant AI model receives, as input, the set of one or more engine control parameters, the set of one or more predicted engine exhaust indicators and the set of one or more independent ATS control parameters. The reductant AI model returns a predicted reductant injection rate. The ATS AI model receives, as input, the set of one or more engine control parameters, the set of one or more predicted engine exhaust indicators, the set of one or more independent ATS control parameters and the predicted reductant injection rate. The ATS AI model returns, as output, the predicted ATS performance.

It is noted that the AI model in Step 1005 may include one or more components, depending on the format of the performance. In implementations where the performance includes multiple components, the AI model in Step 1005 may include a single machine learning (ML) model that determines all the components of the predicted performance, or multiple ML models, each ML model attempting to determine one or more of the components of the predicted performance. In some implementations, the AI model in Step 1003 includes as many ML models as the number of components of the performance, each ML model computing one distinct component of the predicted performance.

A performance model is obtained in Step 1007. Examples of the performance model include the performance model (609) from FIGS. 6A-6D. The performance model is configured to return a predicted performance score for the motor assembly, based on the AI model from step 1005. The performance model receives, as input, the set of control parameters. An auxiliary AI model is formed by fixing an operating point. The auxiliary AI model receives, as input, the set of control parameters and returns, as output, the predicted performance output by the AI model from Step 1005 upon receiving, as input, the operating point and the set of control parameters. The performance model in Step 1007 is based on the predicted performance. The predicted performance score is determined based on the predicted performance. The performance model in Step 1007 can be configured for any operating point, based on the AI model receiving the operating point. In some embodiments, the performance model includes a scoring function and a set of constraints. The scoring function is configured to receive, as input, the set of control parameters. The scoring function returns a performance score. The scoring function can be defined in many ways, such as, for instance, the examples given by EQ. 5-11 and EQ. 13. The set of constraints restricts the control parameters. At least one of the predicted performance score and the predicted performance score is based on the predicted performance. In implementations where the predicted performance score is based on the predicted performance, the scoring function further receives the predicted performance as input and returns, as output, the predicted performance score. In implementations where the predicted performance score is not based on the predicted performance, the predicted performance score is the performance score.

In Step 1009, the performance model is configured based on the first operating point from Step 1003. A first auxiliary AI model is formed by inputting the first operating point to the AI model from Step 1005. The first auxiliary AI model receives the set of control parameters as input and returns a first predicted performance as output. Thus, the first predicted performance is based on the first operating point. The performance model is configured to output a first performance score based on the first predicted performance. Using the embodiments of the performance model from FIGS. 6B-6D, the scoring function returns a first predicted performance score as output. A first set of constraints for the control parameters is formed from the set of constraints. At least one of the first predicted performance score and the first set of constraints is based on the first predicted performance. For instance, in EQs. 5-11, the performance score is based on the performance. Thus, if a scoring function from EQs. 5-11 is used, the first predicted performance score is based on the first predicted performance. In EQ. 12, the approximate fourth constraint makes use of the first predicted performance. Thus, in implementations where the first set of constraints includes the approximate fourth constraint from EQ. 12, the first set of constraints is based on the first predicted performance.

In Step 1011, the performance model is optimized for the first operating point. In one or more embodiments, the optimization of the performance model is carried out using an optimizer. The optimizer may be defined in many ways, such as the embodiments described for the optimizer (707) in FIG. 7. In some implementations, the optimizer is configured to form a first merit function that receives the set of control parameters as inputs and returns the first performance score as output. The optimizer is configured to seek to maximize the first merit function subject to the first set of constraints, as described by EQ. 16. An optimum set of one or more engine control parameters and an optimum set of one or more independent ATS control parameters are determined as solutions to the optimizer. Examples of maximization methods for solving the optimization problem in EQ. 16 include, but are not limited to, a simplex method, an interior point method, a Lagrange multipliers method, a branch and bound method, a generalized reduced gradient (GRG) method, a grid search, a random search and a feedback loop. If the ATS control parameters do not include dependent ATS control parameters, the optimum set of one or more independent ATS control parameters form the optimum set of one or more ATS control parameters. If the ATS control parameters include dependent ATS control parameters, an optimum predicted performance is computed by inputting the optimum set of one or more engine control parameters and the optimum set of one or more independent ATS control parameters to the AI model. An optimum set of one or more dependent ATS control parameters is then extracted from the optimum predicted performance. The optimum set of one or more independent ATS control parameters and optimum set of one or more dependent ATS control parameters form an optimum set of one or more ATS control parameters.

As described in FIG. 8, a second embodiment of the optimizer may be constructed in implementations where the AI model includes an engine AI model and an ATS AI model connected sequentially, such as the AI model in FIG. 3. In this second embodiment, the performance includes an engine performance and an ATS performance. The predicted performance includes a predicted engine performance output by the engine AI model and a predicted ATS performance output by the ATS AI model. The scoring function is written as the sum of an engine scoring function that returns an engine performance score and an ATS scoring function that returns an ATS performance score, as described by EQ. 19. When the performance model is configured based on the first operating point, the engine scoring function returns a first predicted engine performance score and the ATS scoring function returns a first predicted ATS performance score. The first set of constraints is written as a first set of engine constraints and first a set of ATS constraints as defined in EQ. 21. The optimizer includes an engine optimizer and an ATS optimizer. The engine optimizer is configured to form an engine merit function that receives the set of control parameters and returns the first predicted engine performance score. The engine optimizer is configured to find the optimum set of one or more engine control parameters that maximize the first predicted engine performance score subject to the first set of engine constraints, as described by EQ. 22.

A first optimum predicted engine performance is defined by inputting, to the engine AI model, the first operating point and first optimum set of one or more engine control parameters, as described by EQ. 23. The first optimum predicted engine performance includes a set of one or more predicted engine exhaust indicators, called a first optimum set of one or more engine exhaust indicators. In embodiments where the ATS control parameters include dependent ATS control parameters, the first optimum predicted engine performance includes the first optimum set of one or more dependent ATS control parameters. Then, the ATS optimizer is configured to form an ATS merit function. The ATS merit function receives, as input, the set of one or more independent ATS control parameters. The ATS merit function returns, as output, the first ATS performance score assuming that the engine control parameters are equal to the first optimum set of one or more engine control parameters and the one or more engine exhaust indicators are equal to the first optimum set of one or more engine exhaust indicators, as written in EQ. 24. In embodiments where the ATS control parameters include dependent ATS control parameters, the first predicted ATS performance score is computed, by the ATS merit function, assuming that the ATS dependent control parameters are equal to the first optimum set of one or more dependent ATS control parameters. The first set of one or more independent ATS control parameters is then determined by maximizing the ATS merit function subject to the first set of ATS constraints, as defined in EQ. 26. In a similar fashion to the first embodiment of the optimizer, the engine optimizer and ATS optimizer may involve any method known in the art of constrained optimization, such as, for example, a simplex method, an interior point method, a Lagrange multipliers method, a branch and bound method, a generalized reduced gradient method, a grid search, a random search and a feedback loop.

In Step 1013, the motor assembly is operated and one or more engine control parameters are adjusted based on the first optimum set of one or more engine control parameters. In some implementations, the one or more engine control parameters are adjusted to be equal to the first optimum set of one or more engine control parameters. In Step 1015, the one or more ATS control parameters are adjusted based on the first optimum set of one or more ATS control parameters. In some implementations, the one or more ATS control parameters are adjusted to be equal to the first optimum set of one or more ATS control parameters.

It is noted that Step 1011 may be repeated for a number N>1 of operating points, denoted as Oₙ, for n∈[1, N]. For each n∈[1, N], the performance model is sequentially configured to return an n^{th} performance score based on the AI model receiving the n^{th} operating point. For each n∈[1, N], the n^{th} performance score is optimized, thereby producing a n^{th} optimum set of one or more engine control parameters and an n^{th} optimum set of one or more ATS control parameters. In some implementations, configuring the performance model to return the n^{th} performance score includes forming an n^{th} set of constraints. In such implementations, the n^{th} optimum set of one or more engine control parameters and an n^{th} optimum set of one or more ATS control parameters may be determined by an optimizer that seeks to maximize the n^{th} performance score based on the n^{th} set of constraints. Then, an engine-ATS map is constructed. The ATS-engine map includes N mapped elements that can be indexed by an integer n such that 1≤n≤N. For each integer n such that 1≤n≤N, the n^{th} mapped element includes the n^{th} operating point, the n^{th} optimum set of one or more engine control parameters and the n^{th} optimum set of one or more ATS control parameters. Examples of mapped elements include the first mapped elements (713) and the second mapped element (723) in FIG. 7. The n^{th} mapped element associates the n^{th} optimum set of one or more engine control parameters and the n^{th} optimum set of one or more ATS control parameters to the to the n^{th} operating point. Thus, the engine-ATS map associates, for each integer n such that 1≤n≤N, the n^{th} operating point with the n^{th} optimum set of one or more engine control parameters and the n^{th} optimum set of one or more ATS control parameters. In one or more embodiments, the one or more engine control parameters and one or more ATS control parameters are adjusted based on the engine-ATS map in Steps 1013 and 1015.

In one or more embodiments, the AI model is fine-tuned, during the life of a motor vehicle on which the motor assembly is installed. Fine-tuning the AI model is performed using onboard training examples acquired by one or more sensors mounted on the motor vehicle. Fine-tuning the AI model results in an updated AI model. Some, or all of the mapped elements from the engine-ATS map may be constructed again using the updated AI model instead of the AI model, thereby producing an updated engine-ATS map. In one or more embodiments, the AI model is fine-tuned periodically and the engine-ATS map is updated periodically. In some embodiments, fine-tuning the AI model and updating the engine-ATS map periodically during the life of the motor vehicle is interpreted as maintaining the performance of the motor vehicle throughout its lifetime.

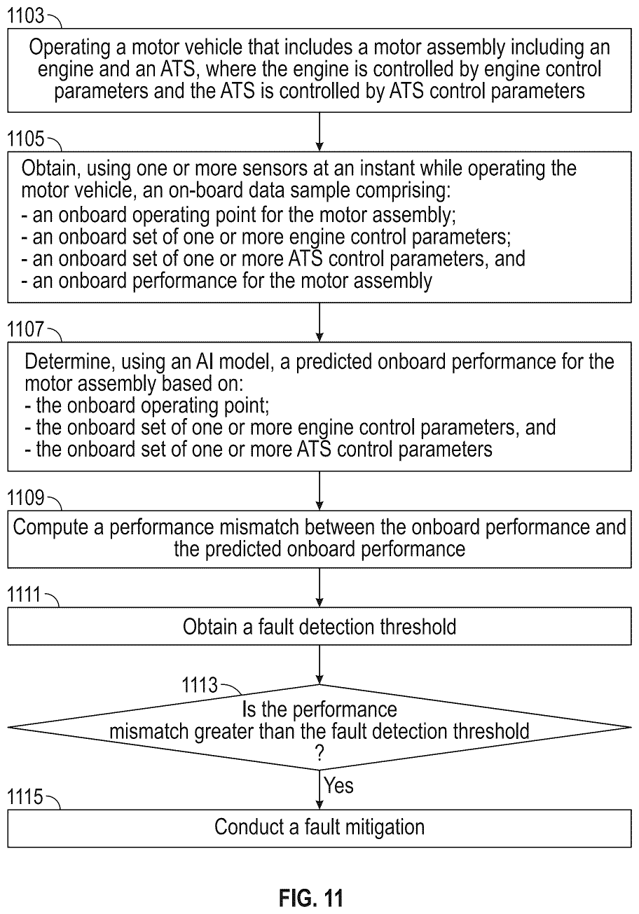

The flow chart in FIG. 11 depicts a method for detecting faults of a motor vehicle. For brevity, a full description of components and/or elements depicted in FIG. 11 is not provided anew for those components and/or elements that have been previously described with reference to the preceding figures. The method in FIG. 11 includes elements borrowed from the fault detection system (500) in FIG. 5. The motor vehicle includes a motor assembly, such as the motor assembly (100) in FIG. 1. The motor assembly includes an engine and an after-treatment system (ATS), such as the engine (103) and the ATS (109) in FIG. 1. The engine is controlled by one or more engine control parameters and the ATS is controlled by one or more ATS control parameters. The one or more ATS control parameters include one or more independent ATS control parameters. The motor vehicle further includes one or more sensors, such as the one or more sensors (503) in FIG. 5. Step 1103 includes operating the motor vehicle. In Step 1105, an onboard data sample is captured by the one or more sensors, in a similar fashion to the first onboard data sample (520) in FIG. 5. The onboard data sample includes an onboard operating point, an onboard set of one or more engine control parameters, and an onboard set of one or more independent ATS control parameters and an onboard performance for the motor assembly.

In Step 1107, a predicted onboard performance is computed as an output of an artificial intelligence (AI) model upon receiving, as input, the onboard operating point, the onboard set of one or more engine control parameters, and the onboard set of one or more independent ATS control parameters. A notable example of the AI model in Step 1107 is the AI model (209) in FIG. 2. In some embodiments, the AI model is implemented as in FIGS. 3 and 4. In Step 1109, a performance mismatch is computed between the onboard performance and the predicted onboard performance. In some implementations, the performance mismatch is an absolute value of a difference between the onboard performance and the predicted onboard performance. In Step 1111, a fault detection threshold is obtained, in a similar fashion to the fault detection threshold (523) in FIG. 5. As such, the fault detection threshold may be defined in several ways. In one or more embodiments, the fault detection threshold is defined arbitrarily. In other embodiments, the fault detection threshold is defined based on a measured error computed during a testing phase of the AI model from Step 1107, such as the root mean squared error from EQ. 3.

In Step 1113, a determination is made whether the performance mismatch is greater than the performance threshold. If the performance mismatch is smaller than the fault detection threshold, the motor vehicle, the one or more sensors and the AI model are acknowledged to be functioning properly. If the performance mismatch is greater than or equal to than the fault detection threshold, a fault is detected and a fault mitigation is conducted in Step 1115. The fault mitigation includes a fault alert informing that a fault has been detected. The fault alert may be of various types. In some implementations, the fault alert includes a sound notification inside the motor vehicle. In some implementations, the fault alert includes a light displayed on a dashboard of the motor vehicle. In some implementations, the fault alert includes sending a message to an electronic device, such as a cell phone of the driver, or a receiver of a motor vehicle manufacturer or a receiver of a repair facility. The fault may stem from many causes, such as a malfunctioning of the motor vehicle components, one or more sensors or AI model. In some embodiments, the fault mitigation further includes repairing or replacing one or more components of the motor vehicle or the one or more sensors. In some embodiments, the fault mitigation further includes modifying the AI model from Step 1107.

As previously described, the AI model in this disclosure, represented by the AI model (209) in FIGS. 2-9, may be configured in many ways and include one or more ML models. Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A brief discussion and summary of various machine-learning model types is provided herein. However, one with ordinary skill in the art will recognize that a full discussion of every type of machine-learning model applicable to the methods and systems disclosed herein is not possible nor required to describe the super learner generation system and use of the resulting super learner model. Consequently, the following discussion of machine-learning models is provided by way of introduction to the art of machine-learning and does not impose a limitation on the present disclosure.

A notable example of a machine-learning model type that may be included in the AI model (209) is a decision tree. Decisions trees often act as components, or sub-models, to other types of machine-learning models such as random forests and gradient boosted machines. A decision tree is composed of nodes. A decision is made at each node such that data present at the node are segmented. Typically, at each node, the data at said node, are split into two parts, or segmented bimodally, however, multimodal segmentation is possible. The segmented data can be considered another node and may be further segmented. As such, a decision tree represents a sequence of segmentation rules. The segmentation rule (or decision) at each node is determined by an evaluation process. The evaluation process usually involves calculating which segmentation scheme results in the greatest homogeneity or reduction in variance in the segmented data. However, a detailed description of this evaluation process, or other potential segmentation scheme selection methods, is omitted for brevity and does not limit the scope of the present disclosure.

Further, if at a node in a decision tree, the data are no longer to be segmented, that node is said to be a “leaf node.” Commonly, values of data found within a leaf node are aggregated, or further modeled, such as by a linear model, so that a leaf node represents a class or an aggregated value (e.g., an average). A decision tree can be configured in a variety of ways, such as, but not limited to, choosing the segmentation scheme evaluation process, limiting the number of segmentations, and limiting the number of leaf nodes. Generally, when the number of segmentations or leaf nodes in a decision tree is limited, the decision tree is said to be a “weak learner.”

Commonly, gradient boosted machine models are constructed using decision trees. Hereafter, a gradient boosted machine model using decision trees is referred to as a gradient boosted trees model. In most implementations, the decision trees from which a gradient boosted trees model is composed are weak learners. In a gradient boosted trees model, the decision trees are ensembled in series, wherein each decision tree makes a weighted adjustment to the output of the preceding decision trees in the series. The process of ensembling decision trees in series, and making weighted adjustments, to form a gradient boosted trees model is best illustrated by considering the training process of a gradient boosted trees model.

Training a gradient boosted trees model consists of the selection of segmentation rules for each node in each decision tree; that is, training each decision tree. Once trained, a decision tree is capable of processing data. For example, a decision tree may receive a data input (e.g., an operating point, an input set of one or more engine control parameters and an input set of one or more independent ATS control parameters). The data input is sequentially transferred to nodes within the decision tree according to the segmentation rules of the decision tree. Once the data input is transferred to a leaf node, the decision tree outputs the assigned class or aggregate value (e.g., a predicted performance component) of the associated leaf node.

Generally, training a gradient boosted model firstly consists of making a simple prediction (SP) for the target data (e.g., a performance component). The simple prediction (SP) may be the average of the target values of a training dataset. The simple prediction (SP) is subtracted from the targets to form a first residuals. The first decision tree in the series is created and trained, wherein the first decision tree attempts to predict the first residuals forming first residual predictions. The first residual predictions from the first decision tree are scaled by a scaling parameter. In the context of gradient boosted trees the scaling parameter is known as the “learning rate” (n). The learning rate is one of the hyperparameters governing the behavior of the gradient boosted trees model. The learning rate (n) may be fixed for all decision trees or may be variable or adaptive. The first residual predictions of the first decision tree are multiplied by the learning rate (n) and added to the simple prediction (SP) to form a first predictions. The first predictions are subtracted from the targets to form a second residuals. A second decision tree is created and trained using the data inputs and the second residuals as targets such that it produces second residual predictions. The second residual predictions are multiplied by the learning rate (n) and are added to the first predictions forming second predictions. This process is repeated recursively until a termination criterion is achieved.

Many termination criteria exist and are not all enumerated here for brevity. Common termination criteria are terminating training when a pre-defined number of decision trees has been reached, or when improvement in the residuals is no longer observed.

Once trained, a gradient boosted trees model may make predictions using input data. To do so, the input data is passed to each decision tree, which will form a plurality of residual predictions. The plurality of residual predictions is multiplied by the learning rate (n), summed across every decision tree, and added to the simple prediction (SP) formed during training to produce the gradient boosted trees predictions.

One with ordinary skill in the art will appreciate that many adaptions may be made to gradient boosted trees models and that these adaptions do not exceed the scope of this disclosure. Some adaptions may be algorithmic optimizations, efficient handling of sparse data, use of out-of-core computing, and parallelization for distributed computing. Commonly, when such adaptions are applied to a gradient boosted trees model, the model is known in the literature as XGBoost.

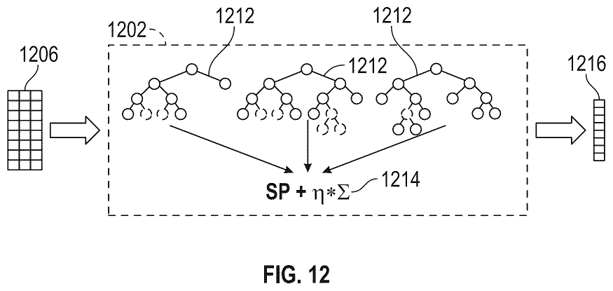

FIG. 12 depicts, generally, the flow of data through a trained gradient boosted trees model (1202) in accordance with one or more embodiments. The boosted trees model (1202) receives an input (1206). Depending on the purpose of the gradient boosted tree, the input (1206) may include one or more of an input set of one or more independent ATS control parameters, an input set of one or more engine exhaust indicators and a pair composed of an operating point and an input set of one or more engine control parameters. The input (1206) is passed to the gradient boosted trees model (1202) composed of a plurality of decision trees (1212). As such, the input (1206) is processed by each decision tree (1212) and the output of each decision tree is collected, multiplied by the learning rate (n), summed, and added to the simple prediction (SP) established during training forming an ensemble (1214). The result of the ensemble (1214) is returned as the gradient boosted trees model prediction (1216). In the context of the current disclosure, the gradient boosted trees model prediction (1216) includes one or more components of the predicted performance (211).

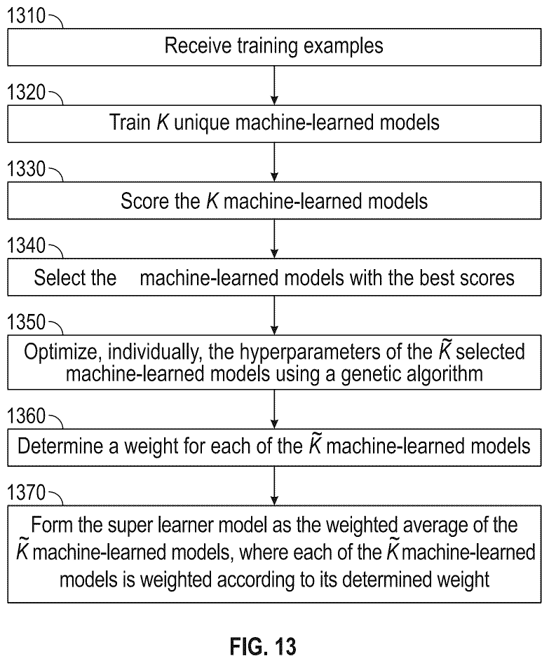

With an introduction to machine-learning and some machine-learned model types presented, the processes of forming the super learner model is described in FIG. 13, in accordance with one or more embodiments. Training data samples are received in Step 1310. The training data samples constitute the dataset of data samples, or a subset of the dataset of data samples. Each data sample from the dataset of data samples includes an input and an associated output (or target). Depending on a purpose of the super learner, an input may include one or more of an input set of one or more independent ATS control parameters, an input set of one or more engine exhaust indicators and a pair composed of an operating point and an input set of one or more engine control parameters. Depending on a purpose of the super learner, an associated output may include a performance component or multiple performance components. An input of a training data sample is called a training input. An associated output of a training data sample is called a training output. In one or more embodiments, the dataset of data samples is split into various sets for training, scoring, and generalization error estimation purposes. Examples of such sets include a training set, containing the training data samples, a validation set, containing validation data samples, and a testing set, containing testing data samples. Because data splitting is a common practice when training, evaluating, and testing a machine-learned model, it is not explicitly depicted in FIG. 13. One with ordinary skill in the art will recognize that any data splitting technique may be applied to the dataset of data samples without departing from the scope of this disclosure. Thus, it is understood that training, evaluation, and optimization of any machine-learned models discussed below may be according to one or more pre-defined partitions of dataset of data samples.

In Step 1320, K unique machine-learned models are trained independently using the training data samples, where K is an integer greater than or equal to 1. Each machine-learned model outputs a predicted value, such as for example, a predicted value for one or more performance components. In one or more embodiments, the K machine-learned models are trained using a cross-validation scheme applied to the training dataset. In one or more embodiments, 40 machine-learned models are trained, where the type, sub-type, and shorthand name of each model is represented in Table VI.

TABLE VI
The type, subtype, model, and shorthand model name of 40 machine-
learned models trained to form the super learner in accordance
with one or more embodiments of the instant disclosure.

| | | S | | Model |
|---|---|---|---|---|
| Type | Sub-type | No | Model | name |
| Linear models | Classical | 1 | LinearRegression | LR |
| | | 2 | Ridge | RR |
| | | 3 | RidgeCV | RCVR |
| | | 4 | SGDRegressor | SGDR |
| | Regressors | 5 | ElasticNet | ENR |
| | with variable | 6 | ElasticNetCV | ENCVR |
| | selection | 7 | Lars | LaR |
| | | 8 | LarsCV | LaCVR |
| | | 9 | Lasso | LasR |
| | | 10 | LassoCV | LasCVR |
| | | 11 | LassoLars | LLR |
| | | 12 | LassoLarsIC | LLICR |
| | | 13 | LassoLarsCV | LLCVR |
| | | 14 | OrthogonalMatchingPursuit | OMPR |
| | | 15 | OrthogonalMatchingPursuitCV | OMPCVR |
| | Bayesian | 16 | BayesianRidge | BRR |
| | regressors | | | |
| | Outlier-robust | 17 | RANSACRegressor | RANR |
| | regressors | 18 | HuberRegressor | HR |
| | Generalized | 19 | PoissonRegressor | PR |
| | linear models | 20 | GammaRegressor | GR |
| | (GLM) for | 21 | TweedieRegressor | TR |
| | regression | | | |
| | Miscellaneous | 22 | PassiveAggressiveRegressor | PAR |
| Kernel Ridge | Kernel Ridge | 23 | KernelRidge | KRR |
| models | Regression | | | |
| Gaussian Processes | Gaussian | 24 | GaussianProcessRegressor | GPR |
| | Processes | | | |
| Nearest Neighbors | Nearest | 25 | KNeighborsRegressor | KNR |
| | Neighbors | | | |
| Neural network | Neural network | 26 | MLPRegressor | MLPR |
| models | models | | | |
| Support Vector | Support Vector | 27 | SVR | SVR |
| Machines | Machines | 28 | LinearSVR | LSVR |
| | | 29 | NuSVR | NSVR |
| Decision Trees | Classical | 30 | DecisionTreeRegressor | DTR |
| | | 31 | ExtraTreeRegressor | ETR |
| | Ensemble | 32 | ExtraTreesRegressor | ETsR |
| | Methods | 33 | RandomForestRegressor | RFR |
| | | 34 | AdaBoostRegressor | ABR |
| | | 35 | BaggingRegressor | BRR |
| | | 36 | GradientBoostingRegressor | GBR |
| | | 37 | HistGradientBoostingRegressor | HGBR |
| | External | 38 | XGBRegressor | XGBR |
| | | 39 | LGBMRegressor | LGBMR |
| | | 40 | CatBoostRegressor | CBR |

Continuing with FIG. 13, once trained, the K machine-learned models are scored in Step 1330. A machine-learned model's score represents the ability of the model to accurately predict a training output given a training input. Thus, the score of the model is computed by comparing the training outputs with predicted outputs computed by the machine-learned model upon receiving the training input. Any scoring or comparison function known in the art may be used, including but not limited to the mean absolute error (MAE), mean square error (MSE), root mean square error (RMSE) and coefficient of determination (R²), defined in EQs. 1-4.

Once scored, the K top scoring machine-learned models are selected for further use in Step 1340, where M is an integer and 1≤\tilde{K}≤K. In Step 1350, the hyperparameters of each of the \tilde{K} selected machine-learned models are optimized. The hyperparameters of the \tilde{K} models are optimized independently from each other. In one or more embodiments, the hyperparameter optimization is guided by an evaluation score determined using a cross-validation scheme over a training dataset. In other embodiments, the hyperparameter optimization is guided by an evaluation score over a validation set. In accordance with one or more embodiments, the hyperparameter optimization is performed using a genetic algorithm. It is noted that the order of Steps 1340 and 1350 may be readily interchanged without departing from the scope of this disclosure. That is, in some embodiments, the hyperparameters of all K machine-learned models are optimized (or tuned) and then the top \tilde{K} performing models are selected. However, the embodiment depicted in FIG. 13 is generally preferred as hyperparameter optimization can be a computationally expensive task such that it is beneficial to only optimized the hyperparameters of \tilde{K} machine-learned models where \tilde{K}≤K.

After hyperparameter optimization the \tilde{K} selected models are combined to form the super learner model. The combination is performed according to a weighted average. Specifically, if ψ represents one of the \tilde{K} selected machine-learned models, then the super learner model (307), Ψ_{SL}, is given by

$${Ψ}_{SL} = {\sum }_{k = 1}^{\tilde{K}} {w}_{k} {ψ}_{k} , {w}_{k} \geq 0 , \qquad EQ . 27$$

where wₖ represents the weight associated with the k^{th} machine-learned model. To ensure that the \tilde{K} selected machine-learned models are combined according to a proper weighted average, EQ. 27 is subject to the following constraint,

$${\sum }_{k = 1}^{\tilde{K}} {w}_{k} = 1. \qquad EQ . 28$$

Thus, to form the super learner model, for each of the \tilde{K} selected machine-learned models, a weight wₖ must be determined. In Step 1360, a weight is determined for each of the \tilde{K} machine-learned models. In one or more embodiments, the weights are determined using a Sequential Least-Squares Programming method (SLSQP) to include the equality constraint of EQ. 28. Specifically, the SLSQP method determines the weights for the super learner model, Ψ_{SL}, that result in the highest performing (i.e., scoring) model when evaluated on a validation set and/or test set of the dataset of data samples. Once the weights of the super learner model have been determined according to Step 1360, the super learner model is formed as the weighted average of the \tilde{K} selected machine-learned models (EQ. 27) as depicted in Step 1370.

While the various steps in FIG. 13 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Another notable example of an AI model that may be included in the AI model (209) is a neural network (NN), such as a convolutional neural network (CNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

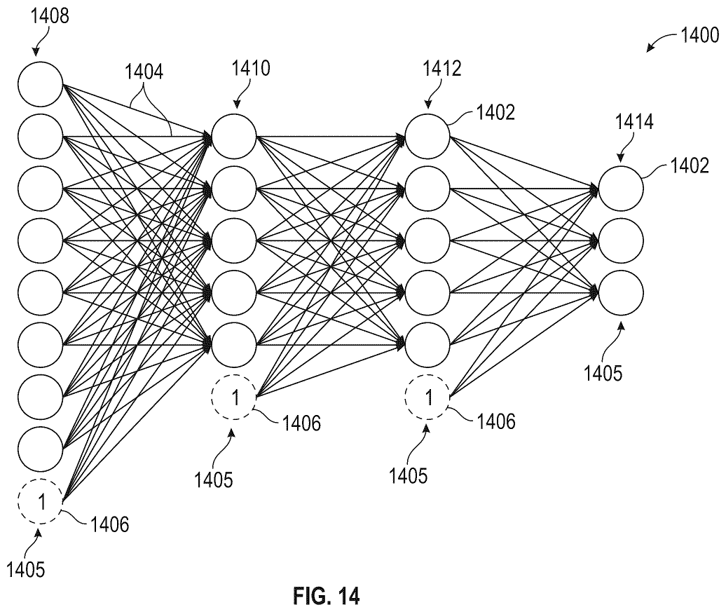

A diagram of a neural network is shown in FIG. 14. At a high level, a neural network (1400) may be graphically depicted as being composed of nodes (1402), where here any circle represents a node, and edges (1404), shown here as directed lines. The nodes (1402) may be grouped to form layers (1405). FIG. 14 displays four layers (1408, 1410, 1412, 1414) of nodes (1402) where the nodes (1402) are grouped into columns, however, the grouping need not be as shown in FIG. 14. The edges (1404) connect the nodes (1402). Edges (1404) may connect, or not connect, to any node(s) (1402) regardless of which layer (1405) the node(s) (1402) is in. That is, the nodes (1402) may be sparsely and residually connected. A neural network (1400) will have at least two layers (1405), where the first layer (1408) is considered the “input layer” and the last layer (1414) is the “output layer.” Any intermediate layer (1410, 1412) is usually described as a “hidden layer.” A neural network (1400) may have zero or more hidden layers (1410, 1412) and a neural network (1400) with at least one hidden layer (1410, 1412) may be described as a “deep” neural network or as a “deep learning method.” In general, a neural network (1400) may have more than one node (1402) in the output layer (1414). In this case the neural network (1400) may be referred to as a “multi-target” or “multi-output” network.

Nodes (1402) and edges (1404) carry additional associations. Namely, every edge is associated with a numerical value. The edge numerical values, or even the edges (1404) themselves, are often referred to as “weights” or “parameters.” While training a neural network (1400), numerical values are assigned to each edge (1404). Additionally, every node (1402) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) \qquad EQ . 29$$

where i is an index that spans the set of “incoming” nodes (1402) and edges (1404) and ƒ is a user-defined function. Incoming nodes (1402) are those that, when the neural network (1400) is viewed or depicted as a directed graph (as in FIG. 14), have directed arrows that point to the node (1402) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0, x), however, many additional functions are commonly employed. Every node (1402) in a neural network (1400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (1400) receives an input, the input is propagated through the network according to the activation functions and incoming node (1402) values and edge (1404) values to compute a value for each node (1402). That is, the numerical value for each node (1402) may change for each received input. Occasionally, nodes (1402) are assigned fixed numerical values, such as the value of 1, that are not affected by the input or altered according to edge (1404) values and activation functions. Fixed nodes (1402) are often referred to as “biases” or “bias nodes” (1406), displayed in FIG. 14 with a dashed circle.

In some implementations, the neural network (1400) may contain specialized layers (1405), such as a normalization layer, or additional connection procedures, like concatenation. One skilled in the art will appreciate that these alterations do not exceed the scope of this disclosure.

As noted, the training procedure for the neural network (1400) comprises assigning values to the edges (1404). To begin training the edges (1404) are assigned initial values. These values may be assigned randomly, assigned according to a prescribed distribution, assigned manually, or by some other assignment mechanism. Once edge (1404) values have been initialized, the neural network (1400) may act as a function, such that it may receive inputs and produce an output. As such, at least one input is propagated through the neural network (1400) to produce an output. Training data is provided to the neural network (1400). Generally, training data consists of pairs of inputs and associated targets. The targets represent the “ground truth,” or the otherwise desired output, upon processing the inputs. In the context of this disclosure, the AI model includes one or more components, some of which may include a neural network. For instance, the AI model may include a neural network configured to receive, as input, an operating point, a set of one or more engine control parameters and a set of one or more independent ATS control parameters and return, as output, a predicted tailpipe exhaust NOₓ rate. In this scenario, an example input for the neural network is a first operating point, a first set of one or more engine control parameters and a first set of one or more independent ATS control parameters. An associated output, or target, is a value of the tailpipe exhaust NOₓ rate released by an motor assembly while operating under the first operating point, the first set of one or more engine control parameters and the first set of one or more independent ATS control parameters. During training, the neural network (1400) processes at least one input from the training data and produces at least one output. Each neural network (1400) output is compared to its associated input data target. The comparison of the neural network (1400) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (1400) output and the associated target. The loss function may also be constructed to impose additional constraints on the values assumed by the edges (1404), for example, by adding a penalty term, which may be physics-based, or a regularization term. Generally, the goal of a training procedure is to alter the edge (1404) values to promote similarity between the neural network (1400) output and associated target over the training data. Thus, the loss function is used to guide changes made to the edge (1404) values, typically through a process called “backpropagation.”

While a full review of the backpropagation process exceeds the scope of this disclosure, a brief summary is provided. Backpropagation consists of computing the gradient of the loss function over the edge (1404) values. The gradient indicates the direction of change in the edge (1404) values that results in the greatest change to the loss function. Because the gradient is local to the current edge (1404) values, the edge (1404) values are typically updated by a “step” in the direction indicated by the gradient. The step size is often referred to as the “learning rate” and need not remain fixed during the training process. Additionally, the step size and direction may be informed by previously seen edge (1404) values or previously computed gradients. Such methods for determining the step direction are usually referred to as “momentum” based methods.

Once the edge (1404) values have been updated, or altered from their initial values, through a backpropagation step, the neural network (1400) will likely produce different outputs. Thus, the procedure of propagating at least one input through the neural network (1400), comparing the neural network (1400) output with the associated target with a loss function, computing the gradient of the loss function with respect to the edge (1404) values, and updating the edge (1404) values with a step guided by the gradient, is repeated until a termination criterion is reached. Common termination criteria are: reaching a fixed number of edge (1404) updates, otherwise known as an iteration counter; a diminishing learning rate; noting no appreciable change in the loss function between iterations; reaching a specified assessment metric as evaluated on the data or a separate hold-out data set. Once the termination criterion is satisfied, and the edge (1404) values are no longer intended to be altered, the neural network (1400) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (1400), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (1400) to produce a final output. Note, that in this context, the neural network (1400) is still considered part of the CNN. Like unto a neural network (1400), a CNN is trained, after initialization of the filter weights, and the edge (1404) values of the internal neural network (1400), if present, with the backpropagation process in accordance with a loss function.

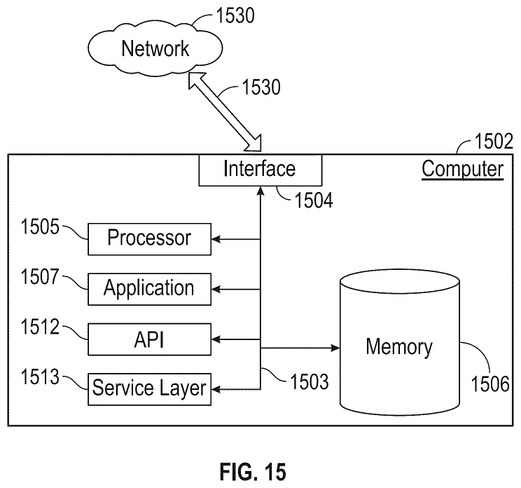

As stated, the computations mentioned in this disclosure may be performed by a computer, such as the onboard computer (933) or the computer (953) in FIG. 9. In that regard, FIG. 15 depicts a block diagram of a computer (1502) used to provide computational functionalities associated with described algorithms, methods, functions, processes, flows, and procedures as described in this disclosure, according to one or more embodiments. The illustrated computer (1502) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1502) may include a computer that includes an input device, such as a keypad, keyboard, touch screen, or other device that can accept user information, and an output device that conveys information associated with the operation of the computer (1502), including digital data, visual, or audio information (or a combination of information), or a GUI.

The computer (1502) can serve in a role as a client, network component, a server, a database or other persistency, or any other component (or a combination of roles) of a computer system for performing the subject matter described in the instant disclosure. In some implementations, one or more components of the computer (1502) may be configured to operate within environments, including cloud-computing-based, local, global, or other environments (or a combination of environments).

At a high level, the computer (1502) is an electronic computing device operable to receive, transmit, process, store, or manage data and information associated with the described subject matter. According to some implementations, the computer (1502) may also include or be communicably coupled with an application server, e-mail server, web server, caching server, streaming data server, business intelligence (BI) server, or other server (or a combination of servers).

The computer (1502) can receive requests over network (1530) from a client application (for example, executing on another computer (1502) and responding to the received requests by processing the said requests in an appropriate software application. In addition, requests may also be sent to the computer (1502) from internal users (for example, from a command console or by other appropriate access method), external or third-parties, other automated applications, as well as any other appropriate entities, individuals, systems, or computers.

Each of the components of the computer (1502) can communicate using a system bus (1503). In some implementations, any or all of the components of the computer (1502), both hardware or software (or a combination of hardware and software), may interface with each other or the interface (1504) (or a combination of both) over the system bus (1503) using an application programming interface (API) (1512) or a service layer (1513) (or a combination of the API (1512) and service layer (1513). The API (1512) may include specifications for routines, data structures, and object classes. The API (1512) may be either computer-language independent or dependent and refer to a complete interface, a single function, or even a set of APIs. The service layer (1513) provides software services to the computer (1502) or other components (whether or not illustrated) that are communicably coupled to the computer (1502). The functionality of the computer (1502) may be accessible for all service consumers using this service layer. Software services, such as those provided by the service layer (1513), provide reusable, defined business functionalities through a defined interface. For example, the interface may be software written in JAVA, C++, or other suitable language providing data in extensible markup language (XML) format or another suitable format. While illustrated as an integrated component of the computer (1502), alternative implementations may illustrate the API (1512) or the service layer (1513) as stand-alone components in relation to other components of the computer (1502) or other components (whether or not illustrated) that are communicably coupled to the computer (1502). Moreover, any or all parts of the API (1512) or the service layer (1513) may be implemented as child or sub-modules of another software module, enterprise application, or hardware module without departing from the scope of this disclosure.

The computer (1502) includes an interface (1504). Although illustrated as a single interface (1504) in FIG. 15, two or more interfaces (1504) may be used according to particular needs, desires, or particular implementations of the computer (1502). The interface (1504) is used by the computer (1502) for communicating with other systems in a distributed environment that are connected to the network (1530). Generally, the interface (1504) includes logic encoded in software or hardware (or a combination of software and hardware) and operable to communicate with the network (1530). More specifically, the interface (1504) may include software supporting one or more communication protocols associated with communications such that the network (1530) or interface's hardware is operable to communicate physical signals within and outside of the illustrated computer (1502).

The computer (1502) includes at least one computer processor (1505). Although illustrated as a single computer processor (1505) in FIG. 15, two or more processors may be used according to particular needs, desires, or particular implementations of the computer (1502). Generally, the computer processor (1505) executes instructions and manipulates data to perform the operations of the computer (1502) and any algorithms, methods, functions, processes, flows, and procedures as described in the instant disclosure.

The computer (1502) also includes a memory (1506) that holds data for the computer (1502) or other components (or a combination of both) that can be connected to the network (1530). The memory may be a non-transitory computer readable medium. For example, memory (1506) can be a database storing data consistent with this disclosure. Although illustrated as a single memory (1506) in FIG. 15, two or more memories may be used according to particular needs, desires, or particular implementations of the computer (1502) and the described functionality. While memory (1506) is illustrated as an integral component of the computer (1502), in alternative implementations, memory (1506) can be external to the computer (1502).

The application (1507) is an algorithmic software engine providing functionality according to particular needs, desires, or particular implementations of the computer (1502), particularly with respect to functionality described in this disclosure. For example, application (1507) can serve as one or more components, modules, applications, etc. Further, although illustrated as a single application (1507), the application (1507) may be implemented as multiple applications (1507) on the computer (1502). In addition, although illustrated as integral to the computer (1502), in alternative implementations, the application (1507) can be external to the computer (1502).

There may be any number of computers such as the computer (1502) associated with, or external to, a computer system containing computer (1502), wherein each computer (1502) communicates over network (1530). Further, the term “client,” “user,” and other appropriate terminology may be used interchangeably as appropriate without departing from the scope of this disclosure. Moreover, this disclosure contemplates that many users may use one computer (1502), or that one user may use multiple computers such as the computer (1502).

The following examples are merely illustrative and should not be interpreted as limiting the scope of the present disclosure.

### Examples

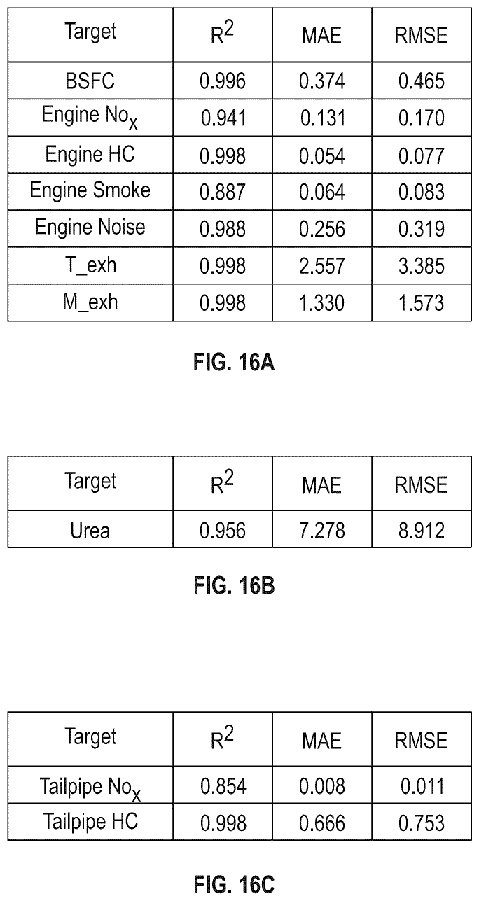

FIG. 16A-16C depict results of assessment metrics assessing the training of a specific implementation of the AI model (209) built upon a specific motor assembly (100). In FIGS. 16A-16C, the AI model (209) is implemented as described in FIG. 4. In FIGS. 16A-16C, the AI model (209) includes the engine performance AI model (4) 1), the reductant AI model (403) and the ATS AI model (305). The engine control parameters are the indicated mean effective pressure (in bar), exhaust gas recirculation rate (in percent), average intake air temperature (in Celsius), fuel rail pressure (in bar), start of first fuel injection (in crank angle degrees), start of second fuel injection (in crank angle degrees), average intake manifold pressure (in kilo Pascal), total mass of fuel injection (in g/cycle), percentage of mass injected in first injection (in percent). The engine performance is composed of the brake specific fuel consumption (BSFC, in grams per kilo Watt Hour (g/kWh)), engine exhaust NOₓ rate (Engine NOₓ, in g/kWh), engine exhaust HC rate (Engine HC, in g/kWh), engine smoke (in filter smoke number), engine noise (in decibels), engine exhaust gas temperature (T_exh, in Kelvin) and engine exhaust flow rate (M_exh, in kilogram per hour). The engine performance AI model (401) includes seven engine ML models, each engine ML model predicting, separately, a distinct component of the engine performance. Each engine ML model is a super learner according to FIG. 13. Each engine ML model receives all of the engine control parameters as input. A first engine ML model returns a predicted brake specific fuel consumption as output. A second engine ML model returns a predicted engine exhaust NOx as output. A third engine ML model returns a predicted engine exhaust HC as output. A fourth engine ML model returns a predicted engine smoke as output. A fifth engine ML model returns a predicted engine noise as output. A sixth engine ML model returns a predicted engine exhaust gas temperature as output. A seventh engine ML model returns a predicted engine exhaust flow rate as output. FIG. 16A depicts a first tabular dataset. Each item in a first column of the first tabular dataset contains the name of a target for each of the seven engine ML models. A second, third and fourth columns contain evaluation metric scores computed for a test dataset for each of the seven engine ML models. The second column contains a coefficient of determination, R², according to EQ. 4. The third column contains a mean absolute error, MAE, according to EQ. 1. The fourth column contains a root mean squared, RMSE, according to EQ. 3.

In the specific example of FIGS. 16A-16C, the reductant used by the engine-ATS system is urea. The reductant AI model (403) includes one urea ML model, configured as a super learner according to FIG. 13. The reductant AI model (403) receives, as inputs, the one or more engine control parameters and the set of one or more engine exhaust indicators. The one or more engine exhaust indicators are three of the components of the engine performance, namely, the engine exhaust NOx, engine exhaust gas temperature and engine exhaust flow rate. The reductant AI model (403) returns, as output, a urea injection rate (urea, in kg/h) required by the ATS to process the exhaust from the engine. FIG. 16B depicts a second tabular dataset. The first column of the second tabular dataset contains the name of a target for the urea ML model. A second, third and fourth columns contain evaluation metric scores computed for a test dataset for the urea ML model. The second column contains a coefficient of determination, R², according to EQ. 4. The third column contains a mean absolute error, MAE, according to EQ. 1. The fourth column contains a root mean squared, RMSE, according to EQ. 3.

The ATS control parameters are a urea injection rate (in kg/h) and an intake temperature of selective catalyst reduction (in K). The ATS performance is composed of the tailpipe exhaust NOx rate (Tailpipe NOₓ, in g/kWh) and the tailpipe exhaust HC rate (Tailpipe HC, in g/kWh). The ATS AI model (305) includes two ATS performance ML models that each separately predict a distinct component of the ATS performance. Each ATS performance ML model is a super learner according to FIG. 13. Each ATS performance ML model receives, as inputs, the engine control parameters, the independent ATS control parameters, and the one or more engine exhaust indicators: engine exhaust NOₓ, engine exhaust gas temperature and engine exhaust flow rate. The first ATS performance ML model returns a predicted tailpipe exhaust NOₓ (Tailpipe NOₓ, in kg/kWh) as output. The second ATS performance ML model returns a predicted tailpipe exhaust (Tailpipe HC, in kg/kWh), as output. FIG. 16C depicts a third tabular dataset. Each item in a first column of the third tabular dataset contains the name of a target for each of the two ATS performance ML models. A second, third and fourth columns contain evaluation metric scores computed for a test dataset for each of the two ATS performance ML models. The second column contains a coefficient of determination, R², according to EQ. 4. The third column contains a mean absolute error, MAE, according to EQ. 1. The fourth column contains a root mean squared, RMSE, according to EQ. 3.

It is noted that the urea injection rate is used as an independent ATS control parameter for training the ATS AI model (305). When the AI model (209) is deployed to make inferences, the urea injection rate is a dependent ATS control parameter. The predicted urea injection rate, computed by the urea ML model, is used as an input to the ATS AI model (3)5) instead of the urea injection rate. Similarly, the ATS AI model (305) receives, as some of its inputs, the one or more engine exhaust indicators, namely, the engine exhaust NOₓ, engine exhaust gas temperature and engine exhaust flow rate. When the AI model (209) is deployed to make inferences, the ATS AI model (305) receives as some of its inputs, a set of one or more predicted engine exhaust indicators as computed by the engine performance AI model (4)1), instead of the one or more engine exhaust indicators. The set of one or more predicted engine exhaust indicators are the predicted engine exhaust NOₓ, predicted engine exhaust gas temperature and predicted engine exhaust flow rate computed by the engine performance AI model (401). Similarly, for training, the urea ML model receives, as some of its inputs, the one or more engine exhaust indicators. When the AI model (209) is deployed to make inferences, the urea ML model receives the set of one or more predicted engine exhaust indicators as computed by the engine AI model (303), instead of the one or more engine exhaust indicators.

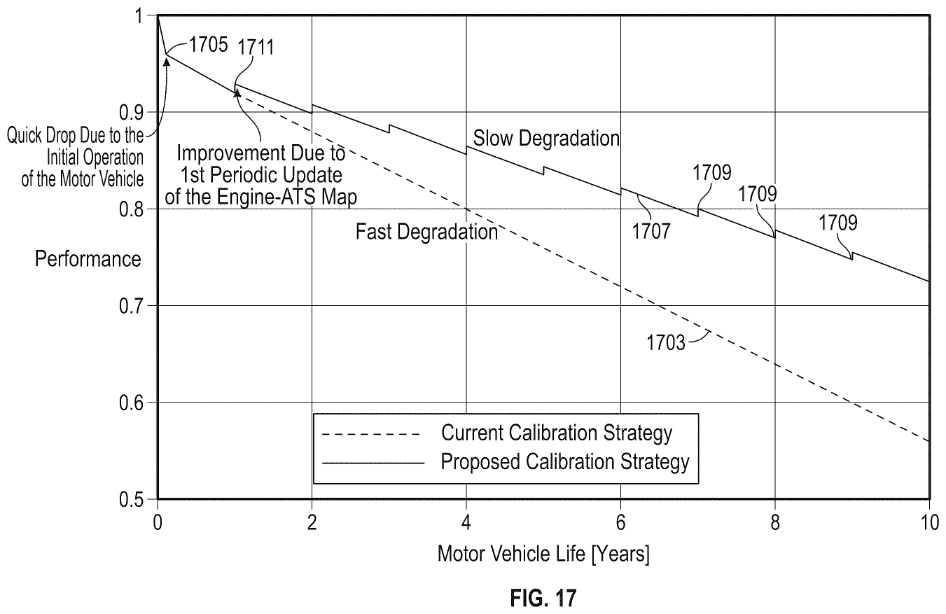

FIG. 17 depicts a graph comparing a hypothetical performance of a motor assembly installed in a motor vehicle, operated using an engine-ATS map, under two scenarios. In a first scenario, the engine-ATS map is determined using a conventional calibration method. In a second scenario, the engine-ATS map is determined using the calibration system (700) and method presented in FIGS. 7 and 10. In FIG. 17, the performance is a sum of the engine efficiency and an inverse of the tailpipe exhaust NOₓ rate obtained as the engine operates under a constant, single operating point. The abscissa of the graph is a measure of an age of a motor vehicle. The ordinate of the graph is the performance of the motor assembly. A first curve (1703) represents a hypothetical evolution of the performance along the life of the motor vehicle according to the first scenario. Using a conventional calibration method, the engine-ATS map is not updated during the life of the motor vehicle. As a result, the performance decreases continually, in a unique linear pattern during the life of the motor vehicle. Notice that a first angular point (1705) represents a discrepancy between a theoretical performance computed before the motor vehicle is in service and an actual performance, measured from the motor vehicle as soon as it is put into service.

A second curve (1707) represents a hypothetical evolution of the performance along the life of the vehicle according to the second scenario. In this specific example, the AI model (209) is fine-tuned periodically, twice a year, using onboard training data samples acquired while the motor vehicle is operated. The onboard training examples account for changes in the driving conditions during the life of the motor vehicle. Thus, twice a year, the AI model (209) is updated and overridden. Every time the AI model (209) is updated, the engine-ATS map is also updated using the calibration system (700) or the method (1000). Since the calibration system (700) and the method (1000) are designed to optimize the performance of the motor assembly (100), the performance of the motor assembly improves every-time the engine-ATS map is updated (i.e.: twice a year). Periodic improvements of the performance can be observed as spikes on the second curve (1707), at which the performance instantly goes up. Examples of such spikes include the spikes (1709). For instance, the first spike (1711) illustrates a first improvement of the performance due to the first engine-ATS map update. Although the performance of the motor assembly decreases along time as seen on both the first curve (1703) and the second curve (1707), the performance decreases at a lower rate on the second curve (1707) than on the first curve (1703). Determining the engine-ATS map periodically using the calibration system (700) or the method (1000) results in an improved performance during the life of the motor vehicle.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A method, comprising:
obtaining a first operating point for a motor assembly comprising:
an engine controlled by one or more engine control parameters in response to an operating point, and
an after-treatment system (ATS) controlled by one or more ATS control parameters in response to an exhaust from the engine, wherein the one or more ATS control parameters comprise one or more independent ATS control parameters;
obtaining an artificial intelligence (AI) model configured to:
receive, as inputs:
an operating point, and
a set of control parameters, comprising:
a set of one or more engine control parameters, and
a set of one or more independent ATS control parameters, and
return, as output, a predicted performance for the motor assembly;
obtaining a performance model configured to return a predicted performance score for the motor assembly based on the AI model;
configuring the performance model to return a first predicted performance score based on the AI model receiving the first operating point;
determining a first optimum set of one or more engine control parameters and a first optimum set of one or more ATS control parameters that optimize the first predicted performance score over the set of control parameters;
adjusting the one or more engine control parameters based on the first optimum set of one or more engine control parameters, and
adjusting the one or more ATS control parameters based on the first optimum set of one or more ATS control parameters.

2. The method of claim 1, wherein:
the performance model is configured to receive a set of control parameters;
the performance model comprises a set of constraints for the set of control parameters;
configuring the performance model to return the first predicted performance score comprises obtaining a first set of constraints based on the set of constraints, wherein at least one of the first predicted performance score and the first set of constraints is based on the AI model receiving the first operating point;
the first optimum set of one or more ATS control parameters comprises a first optimum set of one or more independent ATS control parameters, and
determining the first optimum set of one or more engine control parameters and the first optimum set of one or more independent ATS control parameters comprises running an optimizer configured to seek to maximize the first predicted performance score subject to the first set of constraints.

3. The method of claim 2, wherein:
the one or more ATS control parameters further comprise one or more dependent ATS control parameters;
the predicted performance further comprises a set of one or more dependent ATS control parameters;
the first optimum set of one or more ATS control parameters further comprises a first optimum set of one or more dependent ATS control parameters, and
determining the first optimum set of one or more dependent ATS control parameters comprises:
computing a first optimum predicted performance output by the AI model upon receiving, as input:
the first operating point, and
an optimum set of control parameters, comprising:
the first optimum set of one or more engine control parameters, and
the first optimum set of one or more independent ATS control parameters, and
selecting, from the first optimum predicted performance, the first optimum set of one or more dependent ATS control parameters.

4. The method of claim 1, further comprising:
obtaining a second operating point for the motor assembly;
configuring the performance model to return a second predicted performance score based on the AI model receiving the second operating point;
determining a second optimum set of one or more engine control parameters and a second optimum set of one or more ATS control parameters that optimize the second predicted performance score over the set of control parameters, and
constructing an engine-ATS map comprising, at least:
a first mapped element that associates the first operating point with the first optimum set of one or more engine control parameters and the first optimum set of one or more ATS control parameters, and
a second mapped element that associates the second operating point with the second optimum set of one or more engine control parameters and the second optimum set of one or more ATS control parameters,
wherein adjusting the one or more engine control parameters and the one or more ATS control parameters is based on the engine-ATS map.

5. The method of claim 4, further comprising:
operating a motor vehicle comprising the motor assembly;
acquiring onboard operational data while operating the motor vehicle, using one or more sensors disposed on the motor vehicle;
constructing, using the onboard operational data, onboard training data samples for the motor assembly;
fine-tuning the AI model using the onboard training data samples, thereby generating an updated AI model;
obtaining an updated performance model configured to return an updated predicted performance score for the motor assembly based on the updated AI model;
configuring the updated performance model to return an updated second predicted performance score based on the AI model receiving the second operating point;
determining an updated optimum set of one or more engine control parameters and an updated optimum set of one or more ATS control parameters that optimize the updated second predicted performance score, and
constructing an updated engine-ATS map comprising, at least, an updated mapped element that associates the second operating point with the updated optimum set of one or more engine control parameters and the updated optimum set of one or more ATS control parameters.

6. The method of claim 1, wherein:
the predicted performance comprises a predicted engine performance and a predicted ATS performance, the predicted engine performance comprising a set of one or more predicted engine exhaust indicators, and
the AI model comprises:
an engine AI model, configured to:
receive, as inputs, the operating point and the set of one or more engine control parameters, and
return, as output, the predicted engine performance comprising a set of one or more predicted engine exhaust indicators, and
an ATS AI model, configured to:
receive, as inputs:
the set of one or more engine control parameters;
the set of one or more independent ATS control parameters, and
the set of one or more predicted engine exhaust indicators, and
return, as output, the predicted ATS performance.

7. The method of claim 1, wherein:
the operating point comprises one or more of:
a demand from a user, comprising at most two of:
a throttle position;
an engine load, and
an engine speed, and
an environmental context, comprising one or more of:
an outside air temperature;
an outside air pressure, and
a humidity;
the one or more engine control parameters comprise one or more of:
a fuel rail pressure;
a start of first fuel injection, and
a total mass of fuel injection;
the one or more ATS control parameters comprise one or more of:
a reductant injection rate, and
an intake temperature of selective catalyst reduction, and
the predicted performance is based on one or more of:
an engine exhaust nitrous oxide rate;
a volume of engine smoke;
an engine noise level;
an engine efficiency;
a tailpipe exhaust nitrous oxide rate, and
a tailpipe exhaust hydrocarbon rate.

8. The method of claim 1, wherein:
the AI model comprises a super learner model, and
obtaining the AI model comprises:
obtaining operational data for the motor assembly;
forming a plurality of training data samples from the operational data;
training a plurality of machine-learned models using the plurality of training data samples;
scoring the machine-learned models, wherein upon scoring, each of the machine-learned models has a model score;
selecting a subset of the plurality of machine-learned models, wherein each of the machine-learned models in the subset has a better model score than the machine-learned models outside of the subset;
tuning hyperparameters of each of the machine-learned models in the subset;
determining a weight for each machine-learned model in the subset; and
forming the super learner model as a weighted average of each machine-learned model in the subset, wherein each machine-learned model in the subset is weighted in the weighted average according to its weight.

9. A method, comprising:
operating a motor vehicle comprising a motor assembly, comprising:
an engine controlled by one or more engine control parameters in response to an operating point, and
an after-treatment system (ATS) controlled by one or more ATS control parameters in response to an exhaust from the engine, wherein the one or more ATS control parameters comprise one or more independent ATS control parameters;
obtaining, at an instant while operating the motor vehicle, using one or more sensors
disposed on the motor vehicle, an onboard data sample comprising:
an onboard operating point for the motor assembly;
an onboard set of one or more engine control parameters for the engine;
an onboard set of one or more independent ATS control parameters for the ATS, and
an onboard performance for the motor assembly;
determining, using an artificial intelligence (AI) model, a predicted onboard performance for the motor assembly based on:
the onboard operating point;
the onboard set of one or more engine control parameters, and
the onboard set of one or more independent ATS control parameters;
computing a performance mismatch between the onboard performance and the predicted onboard performance;
obtaining a fault detection threshold;
making a determination whether the performance mismatch is greater than the fault detection threshold, and
conducting a fault mitigation in response to the determination that the performance mismatch is greater than the fault detection threshold, the fault mitigation comprising sending an alert that a fault has been detected.

10. The method of claim 9, wherein:
the operating point comprises one or more of:
a demand from a user, comprising at most two of:
a throttle position;
an engine load, and
an engine speed, and
an environmental context, comprising one or more of:
an outside air temperature;
an outside air pressure, and
a humidity;
the one or more engine control parameters comprise one or more of:
a fuel rail pressure;
a start of first fuel injection, and
a total mass of fuel injection;
the one or more ATS control parameters comprise one or more of:
a reductant injection rate, and
an intake temperature of selective catalyst reduction, and
the predicted onboard performance is based on one or more of:
an engine exhaust nitrous oxide rate;
a volume of engine smoke;
an engine noise level;
an engine efficiency;
a tailpipe exhaust nitrous oxide rate, and
a tailpipe exhaust hydrocarbon rate.

11. The method of claim 9, wherein:
the AI model comprises a super learner model, and
obtaining the AI model comprises:
obtaining operational data for the motor assembly;
forming a plurality of training data samples from the operational data;
training a plurality of machine-learned models using the plurality of training data samples;
scoring the machine-learned models, wherein upon scoring each of the machine-learned models has a model score;
selecting a subset of the plurality of machine-learned models, wherein each of the machine-learned models in the subset has a better model score than the machine-learned models outside of the subset;
tuning hyperparameters of each of the machine-learned models in the subset;
determining a weight for each machine-learned model in the subset; and
forming the super learner model as a weighted average of each machine-learned model in the subset, wherein each machine-learned model in the subset is weighted in the weighted average according to its weight.

12. A system, comprising:
a motor assembly, comprising:
an engine controlled by one or more engine control parameters in response to an operating point, and
an after-treatment system (ATS) controlled by one or more ATS control parameters in response to an exhaust from the engine, wherein the one or more ATS control parameters comprise one or more independent ATS control parameters;
a computer system comprising one or more computer processors, configured to:
receive an artificial intelligence (AI) model configured to:
receive, as inputs:
an operating point, and
a set of control parameters, comprising:
a set of one or more engine control parameters, and
a set of one or more independent ATS control parameters, and
return, as output, a predicted performance for the motor assembly;
receive a performance model configured to return a predicted performance score for the motor assembly based on the AI model;
receive a first operating point for the motor assembly;
configure the performance model to return a first predicted performance score based on the AI model receiving the first operating point, and
determine a first optimum set of one or more engine control parameters and a first optimum set of one or more ATS control parameters that optimize the first predicted performance score over the set of control parameters, and
an electronic control unit (ECU) configured to:
adjust the one or more engine control parameters based on the first optimum set of one or more engine control parameters, and
adjust the one or more ATS control parameters based on the first optimum set of one or more ATS control parameters.

13. The system of claim 12, wherein:
the performance model is configured to receive a set of control parameters;
the performance model comprises a set of constraints for the set of control parameters;
configuring the performance model to return the first predicted performance score comprises obtaining a first set of constraints based on the set of constraints, wherein at least one of the first predicted performance score and the first set of constraints is based on the AI model receiving the first operating point;
the first optimum set of one or more ATS control parameters comprises a first optimum set of one or more independent ATS control parameters, and
determining the first optimum set of one or more engine control parameters and the first optimum set of one or more independent ATS control parameters comprises running an optimizer configured to seek to maximize the first predicted performance score subject to the first set of constraints.

14. The system of claim 13, wherein:
the one or more ATS control parameters further comprise one or more dependent ATS control parameters;
the predicted performance further comprises a set of one or more dependent ATS control parameters;
the first optimum set of one or more ATS control parameters comprises a first optimum set of one or more dependent ATS control parameters, and
determining the first optimum set of one or more dependent ATS control parameters comprises:
computing a first optimum predicted performance output by the AI model upon receiving, as input:
the first operating point, and
an optimum set of control parameters, comprising:
the first optimum set of one or more engine control parameters, and
the first optimum set of one or more independent ATS control parameters, and
selecting, from the first optimum predicted performance, the first optimum set of one or more dependent ATS control parameters.

15. The system of claim 12, wherein the computer system is further configured to:
receive a second operating point for the motor assembly;
configure the performance model to return a second predicted performance score based on the AI model receiving the second operating point;
determine a second optimum set of one or more engine control parameters and a second optimum set of one or more ATS control parameters that optimize the second predicted performance score over the set of control parameters, and
construct an engine-ATS map comprising, at least:
a first mapped element that associates the first operating point with the first optimum set of one or more engine control parameters and the first optimum set of one or more ATS control parameters, and
a second mapped element that associates the second operating point with the second optimum set of one or more engine control parameters and the second optimum set of one or more ATS control parameters,
wherein adjusting the one or more engine control parameters and the one or more ATS control parameters is based on the engine-ATS map.

16. The system of claim 15,
further comprising one or more sensors disposed on a motor vehicle comprising the motor assembly, the one or more sensors configured to acquire onboard operational data,
wherein the computer system is further configured to:
receive the onboard operational data from the one or more sensors;
construct, using the onboard operational data, onboard training data samples for the motor assembly;
fine-tune the AI model using the onboard training data samples, thereby generating an updated AI model;
form an updated performance model configured to return an updated predicted performance score for the motor assembly based on the updated AI model;
configure the updated performance model to return an updated second predicted performance score based on the AI model receiving the second operating point;
determine an updated optimum set of one or more engine control parameters and an updated optimum set of one or more ATS control parameters that optimize the updated second predicted performance score, and
construct an updated engine-ATS map comprising, at least, an updated mapped element that associates the second operating point with the updated optimum set of one or more engine control parameters and the updated optimum set of one or more ATS control parameters.

17. The system of claim 16, wherein:
the onboard operational data comprise an onboard data sample acquired at an instant while operating the motor vehicle, the onboard data sample comprising:
an onboard operating point for the motor assembly;
an onboard set of one or more engine control parameters for the engine;
an onboard set of one or more independent ATS control parameters for the ATS, and
an onboard performance for the motor assembly;
the computer system is further configured to:
determining, using the AI model, a predicted onboard performance for the motor assembly based on:
the onboard operating point;
the onboard set of one or more engine control parameters, and
the onboard set of one or more independent ATS control parameters;
compute a performance mismatch between the onboard performance and the predicted onboard performance;
receive a fault detection threshold;
make a determination whether the performance mismatch is greater than the fault detection threshold, and
send a command to conduct a fault mitigation in response in response to the determination that the performance mismatch is greater than the fault detection threshold, the fault mitigation comprising sending an alert that a fault has been detected, and
the computer system comprises an onboard computer installed in the motor vehicle, the onboard computer comprising at least one of the one or more computer processors, configured to, at least, perform one or more of:
running the AI model;
fine-tuning the AI model;
constructing the engine-ATS map, and
updating the engine-ATS map.

18. The system of claim 12, wherein:
the predicted performance comprises a predicted engine performance and a predicted ATS performance, the predicted engine performance comprising a set of one or more predicted engine exhaust indicators, and
the AI model comprises:
an engine AI model, configured to:
receive, as inputs, the operating point and the set of one or more engine control parameters, and
return, as output, the predicted engine performance comprising a set of one or more predicted engine exhaust indicators, and
an ATS AI model, configured to:
receive, as inputs:
the set of one or more engine control parameters;
the set of one or more independent ATS control parameters, and
the set of one or more predicted engine exhaust indicators, and
return, as output, the predicted ATS performance.

19. The system of claim 12, wherein:
the operating point comprises one or more of:
a demand from a user, comprising at most two of:
a throttle position;
an engine load, and
an engine speed, and
an environmental context, comprising one or more of:
an outside air temperature;
an outside air pressure, and
a humidity;
the one or more engine control parameters comprise one or more of:
a fuel rail pressure;
a start of first fuel injection, and
a total mass of fuel injection;
the one or more ATS control parameters comprise one or more of:
a reductant injection rate, and
an intake temperature of selective catalyst reduction, and
the predicted performance is based on one or more of:
an engine exhaust nitrous oxide rate;
a volume of engine smoke;
an engine noise level;
an engine efficiency;
a tailpipe exhaust nitrous oxide rate, and
a tailpipe exhaust hydrocarbon rate.

20. The system of claim 12, wherein:
the AI model comprises a super learner model, and
the computer system is further configured to train the AI model, the training comprising:
obtaining operational data for the motor assembly;
forming a plurality of training data samples from the operational data;
training a plurality of machine-learned models using the plurality of training data samples;
scoring the machine-learned models, wherein upon scoring, each of the machine-learned models has a model score;
selecting a subset of the plurality of machine-learned models, wherein each of the machine-learned models in the subset has a better model score than the machine-learned models outside of the subset;
tuning hyperparameters of each of the machine-learned models in the subset;
determining a weight for each machine-learned model in the subset; and
forming the super learner model as a weighted average of each machine-learned model in the subset, wherein each machine-learned model in the subset is weighted in the weighted average according to its weight.
